(19) United States
(12) Patent Application Publication
(10) Pub. No.: US 2019/0327974 A1
(43) Pub. Date: Oct. 31, 2019

(54) SYNERGISTS FOR IMPROVED PESTICIDES

(71) Applicants: THE AUSTRALIAN NATIONAL UNIVERSITY, Canberra (AU); YEDA RESEARCH AND DEVELOPMENT CO. LTD., Rehovot (IL); THE REGENTS OF THE UNIVERSITY OF CALIFORNIA, Oakland, CA (US)

(72) Inventors: Colin JACKSON, Canberra (AU); Nir LONDON, Rehovot (IL); Galen CORREY, O'Connor (AU); Janelle SAN JUAN, O'Connor (AU)

(73) Assignees: THE AUSTRALIAN NATIONAL UNIVERSITY, Canberra (AU); YEDA RESEARCH AND DEVELOPMENT CO. LTD., Rehovot (IL); THE REGENTS OF THE UNIVERSITY OF CALIFORNIA, Oakland, CA (US)

(21) Appl. No.: 16/476,559

(22) PCT Filed: Jan. 9, 2018
(86) PCT No.: PCT/IL2018/050032

§ 371 Date: Jul. 9, 2019

Related U.S. Application Data
(60) Provisional application No. 62/443,825, filed on Jan. 9, 2017.

(51) Int. Cl. A01N 55/08; A01N 57/10

(52) U.S. Cl. CPC A01N 55/08; A01N 57/10

(57) ABSTRACT

This invention is directed to synergists for organophosphate (OP), carbamate (CM) and/or pyrethroid/synthetic pesticides (SP). This invention is further directed to a composition comprising organophosphate, carbamate, and/or pyrethroid/synthetic pyrethroid, and at least one boronic acid derivative. This invention further provides methods for killing insect pests.

### FIELD OF THE INVENTION

This invention is directed to synergists for organophosphate (OP), carbamate (CM) and/or pyrethroid/synthetic pesticides (SP). This invention is further directed to a composition comprising organophosphate, carbamate, and/or pyrethroid/synthetic pyrethroid, and at least one boronic acid derivative. This invention further provides methods for killing insect pests.

### BACKGROUND OF THE INVENTION

As the world population increases, agricultural productivity is essential for sustaining food security. Insecticides play an integral role in protecting crops and livestock, as well as in the control of insect-borne diseases. They allow control of agricultural pests and disease vectors and are vital for global food security and health. They are especially important in developing countries, where insect vectors are responsible for nearly 20% of all infectious diseases. Insecticide infused nets and residual spraying of dwellings are amongst the most effective means to control the spread of these diseases. However, the widespread use of insecticides has imposed an evolutionary selection pressure on insect populations and has effectively selected for individuals that are resistant to the toxic effects of insecticides. Insecticide resistance is widespread and is an urgent global problem. Since the 1940s the number of insect species with reported insecticide resistance has been rapidly increasing, and recently passed 580 species. Such resistance renders insecticides ineffective, and leads to increased usage with significant consequences to non-target species and harm to agricultural workers.

Organophosphates (OPs), carbamates (CMs) and synthetic pyrethroids (SPs) are some of the most widely used classes of pesticides, but their efficacy has declined due to the evolution of insecticide resistance. Resistance is often mediated by carboxylesterase enzymes (CBEs) that either sequester or hydrolyze the pesticides before they can inhibit their target. OPs and CMs inhibit the enzyme acetylcholinesterase (AChE) at cholinergic neuromuscular junctions, by phosphorylating/carbamylating the active site serine nucleophile. This leads to interminable nerve signal transduction and death. SPs disrupt nerve function by preventing closure of voltage-sensitive sodium channels which leads to organism paralysis. CBE-mediated resistance to OPs, CMs and SPs has been documented in several insect species, with the most common mechanism of resistance involving carboxylesterases (CBEs). CBEs can either be overexpressed to sequester pesticides, or mutated to gain a new pesticide-hydrolase function; both mechanisms allow CBEs to intercept pesticides before they reach their target, AChE. Inhibiting CBEs could therefore restore the effectiveness of OPs for which resistance has evolved, and inhibitors of insect CBEs may be used as synergists for OP/CM or SP pesticides. Synergists would overcome the mechanism of resistance thereby rescuing the toxic effects of these pesticides.

Insect carboxylesterases from the αEsterase gene cluster, such as αE7 (also known as E3) from the Australian sheep blowfly Lucilia cuprina (LcαE7), play an important physiological role in lipid metabolism and are implicated in the detoxification of organophosphate (OP) insecticides. The sheep blowfly Lucilia cuprina is an ectoparasite which costs Australian industry more than $280 million annually. It has become a model system for the study of insecticide resistance: resistance was first documented in 1966, which was found to predominantly result from a Gly137Asp mutation in the gene encoding the αE7 carboxylesterase. This resistance allele now dominates contemporary blowfly populations, and the equivalent mutation has been observed in a range of other OP-resistant fly species. The emergence of CBE-mediated resistance to OP insecticides has greatly reduced the effectiveness of chemical control. Recent work has shown that the wild type (WT) αE7 protein also has some protective effect against OPs through its ability to sequester the pesticides. The X-ray crystal structure of the CBE responsible for OP resistance, αE7, has shed some light on the molecular mechanism of resistance. Structural homology with AChE underlies the high affinity OP binding by αE7 (Cα root-mean-square deviation of 1.2 Å). Both enzymes adopt the α/β-hydrolase fold and share the typical Ser-His-Glu catalytic triad and oxyanion hole in the active site. Interestingly, although wild-type αE7 has some protective effect on flies exposed to OPs by sequestration, a mutation (Gly137Asp) has been identified as conferring “catalytic” OP detoxification. This mutation introduces a new general base into active site of the enzyme, allowing it to activate a water molecule for dephosphorylation of the catalytic serine. The success of the Gly137Asp mutation means that it now dominates contemporary blowfly populations.

Recent attempts to overcome insecticide resistance have focused on the development of new insecticides with novel modes of action. Although many of these new targets show promise, there are a finite number of biochemical targets and new targets are not immune from the problems of target site insensitivity and metabolic resistance. Synergists have been used in the past, to enhance the efficacy of insecticides by inhibition of enzymes involved in insecticide detoxification; a prominent example of one of the few established insecticide synergists is piperonyl butoxide, a non-specific inhibitor of cytochrome P450s, which is used to enhance the activity of carbamates and pyrethroids. The idea of synergists can be taken further, to specifically target enzymes that have evolved to confer metabolic resistance, thereby restoring the efficacy of the insecticide to pre-resistance levels. Thus, CBEs such as αE7, being a relatively well-understood detoxification system, are ideal targets for the design of inhibitors to abolish insecticide resistance (FIGS. 1A-1C). Insect CBEs, such as αE7, are therefore potential targets for the design of inhibitors that will work synergistically with insecticides to abolish resistance and increase potency, thereby reducing the amount of toxic pesticides required for effective insect pest control (FIGS. 1A-1C). While traditional approaches combat resistance via development of new insecticides, often targeting new proteins, targeting CBEs will allow the continued (and reduced) use of inexpensive and already approved insecticides. Specific and potent covalent inhibitors of αE7 may act as synergists for OP insecticides, assisting efforts to control this important agricultural pest.

### REFERENCES

Ecobichon, D. J. Pesticide use in developing countries. Toxicology 160, 27-33 (2001).
Cooper, J. & Dobson, H. The benefits of pesticides to mankind and the environment. Crop Prot. 26, 1337-1348 (2007).
World Health Organization. Pesticides and their application for the control of vectors and pests of public health importance. World Heal. Organ. 1, 1-104 (2006).
Global pesticide resistance in arthropods. (Cabi International, 2008). doi: 10.1079/9781845933531.0000
Grube, A., Donaldson, D., Timothy Kiely, A. & Wu, L. Pesticides Industry Sales and Usage: 2006 and 2007 Market Estimates. U.S. Environ. Prot. Agency 41 (2011). at <http://nepis.epa.gov/Adobe/PDF/3000659P.pdf>
Dvir, H., Silman, I., Harel, M., Rosenberry, T. L. & Sussman, J. L. Acetylcholinesterase: from 3D structure to function. Chem. Biol. Interact. 187, 10-22 (2010).
Fukuto, T. R. Mechanism of action of organophosphorus and carbamate onsecticides. Environ. Health Perspect. 87, 245-254 (1990).
Tafuri, J. & Roberts, J. Organophosphate poisoning. Ann. Emerg. Med. 16, 193-202 (1987).
Roberts, D. M. & Aaron, C. K. Management of acute organophosphorus pesticide poisoning. BMJ 334, 629-34 (2007).
Soderlund D M, Bloomquist J R. Neurotoxic actions of pyrethroid insecticides Annu Rev Entomol.; 34:77-96 (1989).
Hemingway, J. & Ranson, H. Insecticide resistance in insect vectors of human disease. Annu. Rev. Entomol. 43, 371-391 (2000).
Devonshire, A. L. & Field, L. M. Gene amplification and insecticide resistance. Annu. Rev. Entomol. (1991).
Field, L. M. & Devonshire, A. L. Evidence that the E4 and FE4 esterase genes responsible for insecticide resistance in the aphid Myzus persicae (Sulzer) are part of a gene family. Biochem. J. 330 (Pt 1, 169-73 (1998).
Mouches, C. et al. Amplification of an esterase gene is responsible for insecticide resistance in a California culex mosquito. Science 233, 295-297 (1986).
Raymond, M., Chevillon, C., Guillemaud, T., Lenormand, T. & Pasteur, N. An overview of the evolution of overproduced esterases in the mosquito Culex pipiens. Philos. Trans. R. Soc. Lond. B. Biol. Sci. 353, 1707-11 (1998).
Vaughan, A., HAWKES, N. & HEMINGWAY, J. Co-amplification explains linkage disequilibrium of two mosquito esterase genes in insecticide-resistant Culex quinquefasciatus. Biochem. J. 325, 359 LP-365 (1997).
Newcomb, R. D. et al. A single amino acid substitution converts a carboxylesterase to an organophosphorus hydrolase and confers insecticide resistance on a blowfly. Proc. Natl. Acad. Sci. U.S.A. 94, 7464-7468 (1997).
Devonshire, A. L. et al. Kinetic efficiency of mutant carboxylesterases implicated in organophosphate insecticide resistance. Pestic. Biochem. Physiol. 76, 1-13 (2003).
Newcomb, R. D., Gleeson, D. M., Yong, C. G., Russell, R. J. & Oakeshott, J. G. Multiple mutations and gene duplications conferring organophosphorus insecticide resistance have been selected at the Rop-1 locus of the sheep blowfly, Lucilia cuprina. J. Mol. Evol. 60, 207-20 (2005).
Claudianos, C., Russell, R. J. & Oakeshott, J. G. The same amino acid substitution in orthologous esterases confers organophosphate resistance on the house fly and a blowfly. Insect Biochem. Mol. Biol. 29, 675-686 (1999).
Sackett, D., Holmes, P., Abbott, K., Jephcott, S. & Barber, M. Assessing the economic cost of endemic disease on the profitability of Australian beef cattle and sheep producers. Meat and Livestock Australia Limited 364, (2006).
Levot, G. W. Resistance and the control of sheep ectoparasites. Int. J. Parasitol. 25, 1355-1362 (1995).
Sandeman, R. M. et al. Control of the sheep blowfly in Australia and New Zealand—are we there yet? Int. J. Parasitol. 44, 879-891 (2014).
Hughes, P. B. & Devonshire, A. L. The biochemical basis of resistance to organophosphorus insecticides in the sheep blowfly, Lucilia cuprina. Pestic. Biochem. Physiol. 18, 289-297 (1982).
Arnold, J. T. a. & Whitten, M. J. The genetic basis for organophosphorus resistance in the Australian sheep blowfly, Lucilia cuprina (Wiedemann) (Diptera, Calliphoridae). Bull. Entomol. Res. 66, 561 (1976).
Jackson, C. J. et al. Structure and function of an insect α-carboxylesterase (αEsterase7) associated with insecticide resistance. Proc. Natl. Acad. Sci. U.S.A. 110, 10177-82 (2013).
Mabbitt, P. D. et al. Conformational disorganization within the active site of a recently evolved organophosphate hydrolase limits its catalytic efficiency. Biochemistry acs. biochem. 5b01322 (2016). doi:10.1021/acs.biochem.5b01322
McKenzie, J. a. Dieldrin and diazinon resistance in populations of the Australian sheep blowfly, Lucilia cuprina, from sheep-grazing areas and rubbish tips. Aust. J. Biol. Sci. 37, 367-374 (1984).
Russell, R. J. et al. The evolution of new enzyme function: lessons from xenobiotic metabolizing bacteria versus insecticide-resistant insects. Evol. Appl. 4, 225-48 (2011).
Smyth, K. A., Boyce, T. M., Russell, R. J. & Oakeshott, J. G. MCE activities and malathion resistances in field populations of the Australian sheep blowfly (Lucilia cuprina). Heredity (Edinb). 84, 63-72 (2000).

### SUMMARY OF THE INVENTION

In various embodiments, this invention provides a pesticide composition for killing insect pests comprising a synergistically effective combination of at least one of: organophosphate (OP), carbamate (CM), and synthetic pyrethroid (SP); and at least one boronic acid derivative or salt thereof.

In other embodiments, the boronic acid derivative is represented by the structure of formula I:

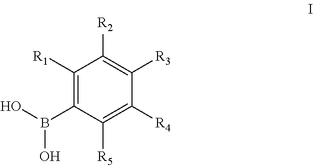

wherein
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;
or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂;
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

In various embodiments, this invention is directed to a method for killing insect pests, the method comprising contacting a population of insect pests with an effective amount of the composition of this invention.

In various embodiments, this invention provides a method for killing insect pests on a plant or animal, the method comprises contacting the plant or animal with the composition of this invention, wherein the composition has a synergistic effect on insecticidal activity.

In various embodiments, this invention provides a method of killing pests comprising inhibiting carboxylesterase (CBE)—mediated organophosphate (OP), carbamate (CM), and/or pyrethroid/synthetic pyrethroid (SP) resistance in a pest, said method comprises contacting a boronic acid derivative or salt thereof with said pest in combination with OP, CM and/or SP pesticide. In other embodiments the CBE is a wild-type-CBE, a homologue of CBE or mutated CBE. In other embodiments the CBE is wild-type or mutant versions of αE7 CBE or homologue thereof. In other embodiments the CBE is LcαE7, wild-type LcαE7, mutated LcαE7, a homologue thereof, or any combination thereof.

In various embodiments, this invention provides a method of potentiation an OP, a CM and/or an SP pesticide comprising contacting a boronic acid derivative or a salt thereof with a pest, before, after or simultaneously with contacting said OP, CM and/or SP pesticide with said pest.

In other embodiments, the pest is blowfly (e.g., Calliphora stygia, Lucilia cuprina), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof.

In other embodiments, the boronic acid derivative is an aryl boronic acid or salt thereof, wherein said aryl is optionally substituted by between 1-5 substituents, wherein each substituent is independently: H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), O—CH₂Ph, —C(O)NH₂, —C(O)N(R)₂, —C(O)NHR, —NHC(O)R, C₁-C₅ linear or branched thioalkoxy, C₁-C₅ linear or branched haloalkoxy (e.g., OCF₃), C₁-C₅ linear or branched alkoxyalkyl, aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, aryl, —CH₂CN, NH₂, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and wherein

R is C₁-C₅ linear or branched alkyl, C₁-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring (e.g. morpholine).

In other embodiments, the boronic acid derivative is represented by the structure of formula I:

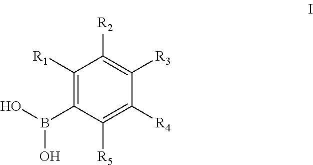

wherein
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;
or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂;
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

In other embodiments, the boronic acid derivative is selected from:

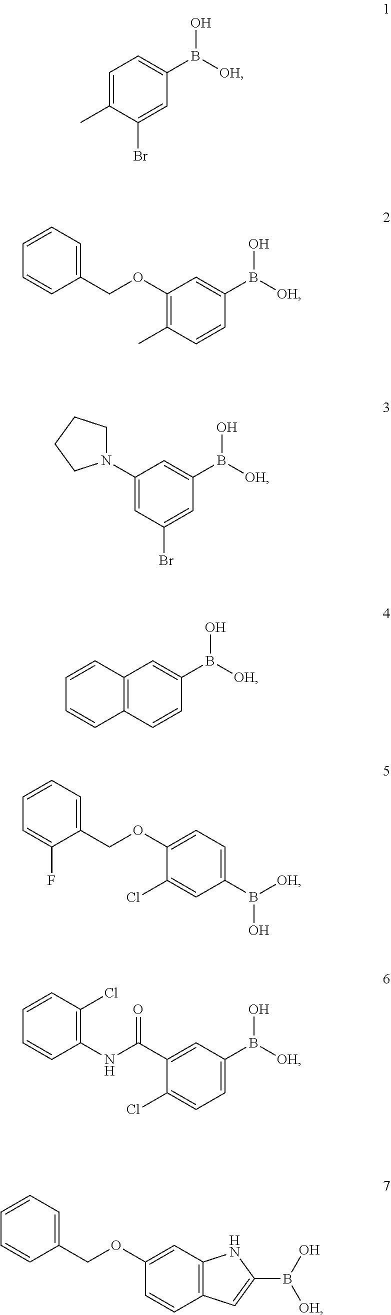

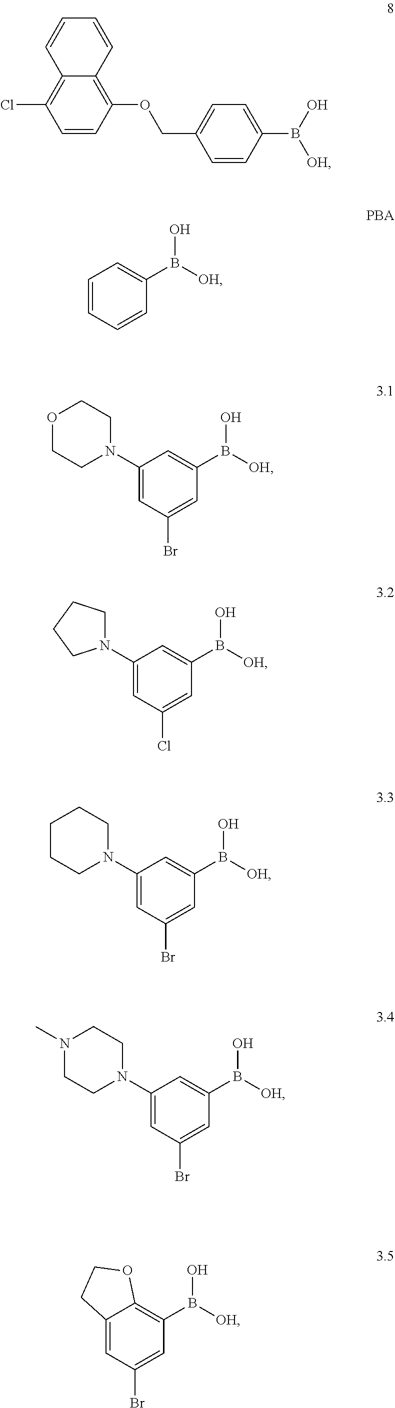

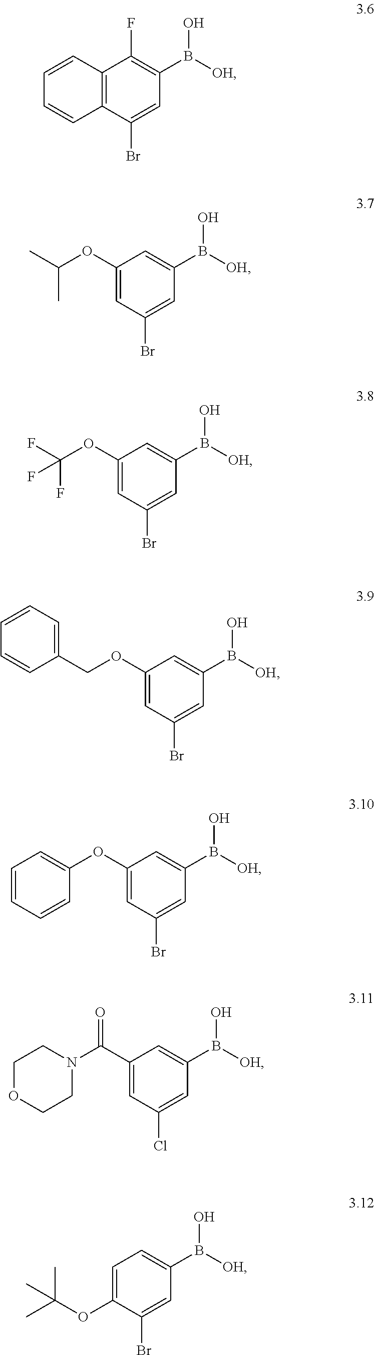

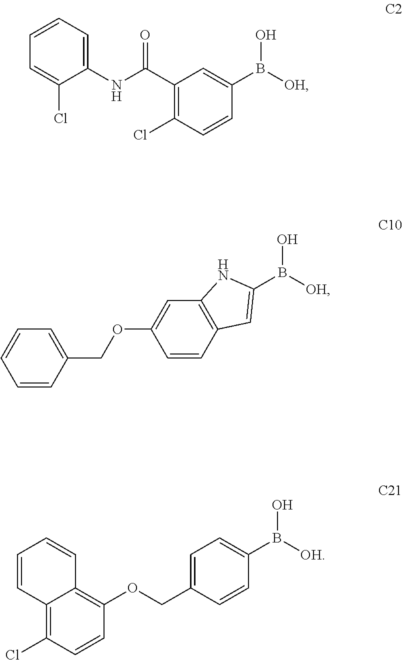 [SMILES: O=C(Nc1ccccc1Cl)c1cc(B(O)O)ccc1Cl ; OB(O)c1cc2ccc(OCc3ccccc3)cc2[nH]1 ; OB(O)c1ccc(COc2ccc(Cl)c3ccccc23)cc1]

In other embodiments, the method is not toxic to animals and/or humans. In other embodiments, the pest is OP, CM, and/or SP pesticide resistant. In other embodiments, the OP is acephate, aspon, azinphos-methyl, azamethiphos, carbofuran carbophenothion chlorfenvinphos, chlorpyrifos, Chlorpyrifos-ethyl (CPE), coumaphos crotoxyphos, crufomate, demeton, diazinon, dichlorvos, dicrotophos, dimethoate, dioxathion, disulfoton, diethyl-4-methylumbelliferyl phosphate, ethyl 4-nitrophenyl phenylphosphonothioate, ethio, ethoprop, famphur, fenamiphos, fenitrothion, fensulfothion, fenthion, fonofos, isofenfos, malathion, methamidophos, methidathion, methyl parathion, mevinphos, monocrotophos, naled, oxydemeton-methyl, parathion, phorate, phosalone, phosmet, phosphamidon, temephos, tetraethyl pyrophosphate, terbufos, tetrachlorvinphos, trichlorfon or any combination thereof. In other embodiments, the OP is diazinon, malathion or Chlorpyrifos-ethyl (CPE).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1C present an overview of synergists for organophosphate insecticides. (FIG. 1A) Organophosphate insecticides inhibit acetylcholinesterase and prevent the hydrolysis of acetylcholine. (FIG. 1B) CBEs like αE7 rescue acetylcholinesterase activity by binding and hydrolyzing organophosphate insecticides. (FIG. 1C) An inhibitor that outcompetes organophosphates for binding to CBE could act as a synergist to restore insecticide activity.

FIGS. 2A-2J present the covalent docking predicts of boronic acid inhibitors 1-5 bound to wild-type LcαE7 vs. their crystal structure. FIGS. 2A, 2B, 2C, 2D, 2E refer to compounds 1-5 respectively (dark sticks) form covalent adducts with the catalytic serine of LcαE7 (Ser218). The omitted mF_{O}-DF_{C} difference electron density is shown (mesh contoured at 3σ). The docking predictions overlaid onto the corresponding co-crystal structures. Active site residues are shown as light sticks. FIGS. 2F, 2G, 2H, 2I, 2J refer to surface representation of LcαE7 binding pocket with compounds 1-5 respectively shown with a space-filling representation (white spheres).

FIG. 3 depicts that boronic acid inhibitors synergize with the organophosphate insecticides diazinon and malathion. Treatment consisted of diazinon (Dz) or malathion (Mal) only, or Dz/Mal supplemented with boronic acid compound at a set concentration of 1 mg/ml. Data is presented mean±95% confidence interval for three (Dz) or two (Mal) replicate experiments, with each experiment utilizing 50 larvae at each Dz/Mal concentration.

FIG. 4 shows how boronic acid compounds can adopt two configurations when coordinated to a serine nucleophile. The trigonal planar adduct has a single hydroxyl coordinated, while coordination of a second hydroxyl results in a negatively charged tetrahedral adduct.

FIG. 5 presents that boronic acid compounds had no effect on Lucilia cuprina pupation in the absence of the organophosphates diazinon or malathion. The number of pupae recovered in the absence of boronic acids was compared to the number recovered in the presence of boronic acids at 1 mg per assay for both laboratory and field strains. Data is presented mean±error for 3 replicate experiments.

FIG. 6 presents sequencing of the αE7 gene in susceptible (laboratory) and resistant (field) isolates. The susceptible stain only carries the wildtype αE7 gene, while the resistant strain carries an equivalent number of copies of the wild-type αE7 (Gly137) and the Glyl37Asp variant of αE7. Chromatograms and corresponding nucleotides are shown for the relevant region of the αE7 gene.

FIG. 7 presents dose-response curves for the inhibition of wildtype αE7. Inhibition of the hydrolysis of 4-nitrophenyl was determined for phenylboronic acid (PBA) and compounds 1-5 and 3.1-3.12. Three (technical) replicate measurements of enzyme activity were performed for each concentration of boronic acid. The concentration of boronic acid required to inhibit 50% of activity (IC₅₀) was determined by fitting a sigmoidal sigmoidal dose-response curve to plots of percentage inhibition. The curve was constrained to 0 (bottom) and 100% (top) inhibition with a variable Hill slope. IC₅₀ values are quoted with the 95% confidence interval.

FIG. 8 presents dose-response curves for the inhibition of Glyl37Asp αE7. Inhibition of the hydrolysis of 4-nitrophenyl was determined for phenyl boronic acid (PBA) and compounds 1-5 and 3.1-3.12. Three (technical) replicate measurements of enzyme activity were performed for each concentration of boronic acid. The concentration of boronic acid required to inhibit 50% of activity (IC₅₀) was determined by fitting a sigmoidal dose-response curve to plots of percentage inhibition. The curve was constrained to 0 (bottom) and 100% (top) inhibition with a variable Hill slope. IC₅₀ values are quoted with the 95% confidence interval.

FIG. 9: presents dose-response curves for the inhibition of Electrophorus electricus acetylcholinesterase. Inhibition of the hydrolysis of acetylthiocholine was determined for phenyl boronic acid (PBA) and compounds 1-5. Three (technical) replicate measurements of enzyme activity were performed for each concentration of boronic acid. Compounds were tested to their solubility limits, only 3 showed >50% inhibition. The IC₅₀ value was determined as before, and is quoted with the 95% confidence interval.

FIG. 10 presents Kinetic parameters for activity assays. Wildtype and Gly137Asp αE7 were assayed with 4-nitrophenol butyrate (4-NPB), and Electrophorus electricus acetylcholinesterase (Ee AChE) was assayed with acetylthiocholine (ATCh). Parameters were determined by fitting the Michaelis-Menton equation to plots of enzyme velocity at eight substrate concentrations using non-linear regression. Six (technical) replicate measurements of enzyme activity were performed for each concentration of substrate. The Michalis constant (K_{M}) is presented±standard error.

FIGS. 11A-11D present that second generation boronic acids are potent inhibitors of Glyl37Asp LcαE7. FIG. 11A: Chemical structures of compound 3 analogues. FIG. 11B: Co-crystal structure of compound 3.10 (dark grey sticks) with Gly137Asp LcαE7 (PDB code 5TYM). The omit mF_{O}-DF_{C} difference electron density is shown (mesh contoured at 3 σ). Active site residues are shown as light grey sticks. FIG. 11C: Surface representation of Gly137Asp LcαE7 binding pocket with compound 3.10 shown with a space-filling representation (light grey spheres).

FIG. 11D: Rearrangement of the active site upon inhibitor binding Glyl37Asp LcαE7. Alignment of the co-crystal structure of compound 3.10 (dark/light grey sticks) with the apo Glyl37Asp LcαE7 crystal structure (light grey sticks, PDB code 5C8V). Hydrogen bonds are shown as dashed black lines. All hydrogen bonds are 2.8 Å except for the Gly136 N to boronic acid OH which is 3.4 Å. The water molecule mediating a hydrogen bond between the Asp137 sidechain and the boronic acid is shown as a black sphere with 2mF_{O}-DF_{C} electron density (mesh contoured at 1 σ).

FIG. 12 presents that boronic acids adopt both tetrahedral and trigonal planar geometries when coordinated to the catalytic serine of LcαE7. Geometry was assigned with reference to the positive (green mesh) and negative (red mesh) peaks in the mF_{O}-DF_{C} difference electron density maps (shown contoured at +3 σ) with either the tetrahedral or trigonal planar species modelled. The ligand and selected active site residues are shown as white sticks, with 2mF_{O}-DF_{C} electron density (blue mesh) contoured at 1 σ around the ligand and Ser218. 3* denotes the LcαE7 structure containing the two surface mutations (Asp83Ala, Lys530Glu) required for crystallisation.

FIG. 13 depicts that boronic acids show little cell toxicity. Compounds 1-5 as well as 3.9 and 3.10 were incubated for 48 h with two different human cell lines HB-2 and MDA-MB-231 at 7 concentrations up to 100 μM. Cell viability was measured after 48 h using Cell Titer Glo assay. Except for compounds 2 and 5 which showed low toxicity against HB-2, none of the compounds significantly killed cells even at the highest concentration.

FIGS. 14A-14B present the structural basis for selectivity against AChE. FIG. 14A. Superposition of the structures of human AChE (grey; PDB 4PQE) and Ee AChE (white; PDB 1EEA) onto the co-crystal structure of LcαE7 (light grey) with compound 3 (dark grey). Phe288 of AChE significantly clashes with the Bromine atom of 3. FIG. 14B. A surface representation of LcαE7 (white) and hAChE (grey) demonstrates the aforementioned clash.

FIG. 15 presents that internal stabilizing mutations present in LcαE7-4a have no effect on boronic acid binding. LcαE7-4a is a variant of LcαE7 which contains 8 mutations to increase thermostability and allow crystallization. To determine whether the internal mutations present in LcαE7-4a affected inhibitor binding, the LcαE7-4a surface mutations were introduced into the WT background and tested for crystallization. Two mutations (Lys530Glu and Asp83Ala) were sufficient to allow crystallization, likely through the introduction of an intermolecular salt bridge (Lys530Glu) between molecules in the crystal lattice, and removal of a charge at a crystal packing interface (Asp83Ala). Comparison between the cocrystal structure of boronic acid 3 with LcαE7-4a (white sticks) and Asp83Ala+Lys530Glu LcαE7 (dark grey sticks) shows that the Ile419Phe and Ala472Thr mutations have little effect on inhibitor pose or binding pocket topology. The Ile419Phe shifts the χ2 dihedral angle of the adjacent Tyr420 by approximately 30°. For clarity, only the backbone of LcαE7-4a is shown (white cartoon). This confirms that the binding poses captured in the co-crystal structures correspond to the binding poses in WT LcαE7.

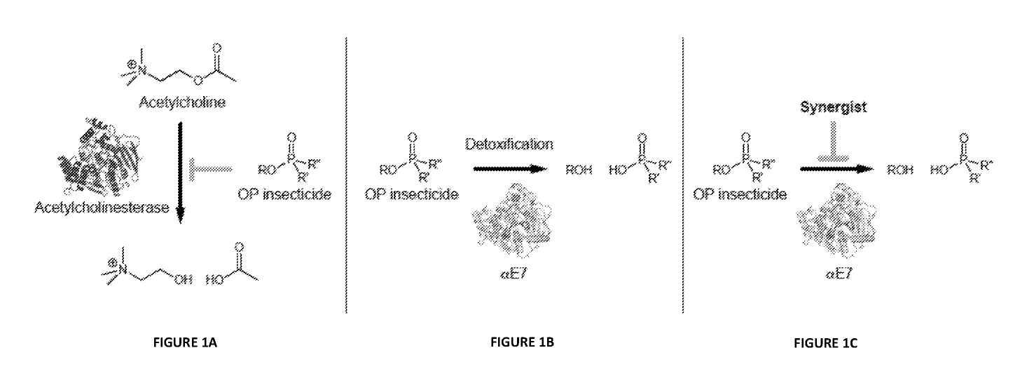

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

### Definitions

The term “organophosphates” or “OPs” refers to a group of insecticides or nerve agents acting on the enzyme acetylcholinesterase. The term is used often to describe virtually any organic phosphorus(V)-containing compound, especially when dealing with neurotoxic compounds. Also, many compounds which are derivatives of phosphinic acid are used as neurotoxic organophosphates. Examples of organophosphosphates used as pesticides include acephate, aspon, azinphos-methyl, azamethiphos, carbofuran carbophenothion, chlorfenvinphos, chlorpyrifos, Chlorpyrifos-ethyl (CPE), coumaphos crotoxyphos, crufomate, demeton, diazinon, dichlorvos, dicrotophos, dimethoate, dioxathion, disulfoton, diethyl-4-methylumbelliferyl phosphate, ethyl 4-nitrophenyl phenylphosphonothioate, ethio, ethoprop, famphur, fenamiphos, fenitrothion, fensulfothion, fenthion, fonofos, isofenfos, malathion, methamidophos, methidathion, methyl parathion, mevinphos, monocrotophos, naled, oxydemeton-methyl, parathion, phorate, phosalone, phosmet, phosphamidon, temephos, tetraethyl pyrophosphate, terbufos, tetrachlorvinphos, trichlorfon.

The term “carbamates” or “CMs”) refers to a group of insecticides acting on the enzyme acetylcholinesterase. The term is used often to describe virtually any carbamate-ester compound, especially when dealing with neurotoxic compounds. Examples of carbamates used as pesticides include Aldicarb, Aminocarb, Bendiocarb, Carbaryl, Carbofuran, Carbosulfan, Dimetilan, Ethiofencarb, Fenobucarb, Fenoxycarb, Formetanate, Formparanate, Methiocarb, Methomyl, Metolcarb, Oxamyl, Pirimicarb, Propoxur and Thiofanox.

The term “pyrethroid/synthetic pyrethroid” or “SPs” refers to a group of insecticides acting on the voltage-gated sodium channels in axonal membranes. The term is used often to describe virtually any carboxylic ester compound chemical structures that are adapted from the chemical structures of the pyrethrins and act in a similar manner to pyrethrins. Examples of SPs used as pesticides include Allethrin, Bifenthrin, Bioallethrin, Cyfluthrin, Cypermethrin, Cyphenothrin, Cyhalothrin, Deltamethrin, Esfenvalerate, Etofenprox, Fenpropathrin, Fenvalerate, Flucythrinate, Flumethrin, Imiprothrin, lambda-Cyhalothrin, Metofluthrin, Permethrin, Prallethrin, Pyrethrum, Resmethrin, Silafluofen, Sumithrin, tau-Fluvalinate, Tefluthrin, Tetramethrin, Tralomethrin and Transfluthrin.

The term “boronic acid” refers to, in various embodiments, to a chemical compound containing a —B(OH)₂ moiety. Boronic acids act as Lewis acids. Their unique feature is that they can form reversible covalent complexes with sugars, amino acids, hydroxamic acids, etc. The pKₐ of a boronic acid is ˜9, but they can form tetrahedral boronate complexes with pKₐ˜7. In some embodiments, the term “boronic acid derivative” refers to an alkyl or aryl substituted boronic acid containing a carbon-boron bond. A prominent feature of boronic acids is their reversible formation of esters with diols in aqueous solution. Therefore, in some embodiments, the term “boronic acid derivative” includes “boronate esters” (also referred to as “boronic esters”), which includes cyclic, linear, mono, and/or di-esters. Such boronic esters contain a —B(Z₁)(Z₂) moiety, wherein at least one of Z₁ or Z₂ is alkoxy, aralkoxy, or aryloxy; or Z₁ and Z₂ together form a ring. Examples of boronate esters include but are not limited to: 2-(Hydroxymethyl)phenylboronic acid cyclic monoester, 3-Pyridineboronic acid 1,3-propanediol ester, 5-formyl-4-methylthiophene-2-boronic acid 1,3-propanediol ester, 4-Isoxazoleboronic acid pinacol ester, 1H-Pyrazole-5-boronic acid pinacol ester, 2-Cyanophenylboronic acid 1,3-propanediol ester, 5-(5,5-Dimethyl-1,3,2-dioxaborinan-2-yl)-1-ethyl-1H-pyrazole, 4-cyanopyridine-3-boronic acid neopentyl glycol ester, 5-Bromo-2-fluoro-3-pyridineboronic acid pinacol ester, 5-Cyanothiophene-2-boronic acid pinacol ester, 5-(4,4,5,5-tetramethyl-1,3,2-dioxaborolan-2-yl)furan-2-carbonitrile, [1,2,5]Oxadiazolo[3,4-b]pyridin-6-ylboronic acid pinacol ester, 2,4-dimethyl-5-(4,4,5,5-tetramethyl-1,3,2-dioxaborolan-2-yl)-1,3-thiazole, (3-Cyanophenyl)boronic acid, neopentyl glycol ester, 2,4-dichlorophenylboronic acid, pinacol ester, Benzo[c][1,2,5]thiadiazol-5-ylboronic acid pinacol ester, 1-Methyl-5-(4,4,5,5-tetramethyl-[1,3,2]dioxaborolan-2-yl)-1H-pyridin-2-one and their like. In some embodiments, boronic acid compounds can form oligomeric anhydrides by dehydration of the boronic acid moiety. For example, Snyder et al., J. Am. Chem. Soc. 80:3611 (1958), reports oligomeric arylboronic acids. Accordingly, as used herein, the term “boronic acid derivative” refers, in some embodiments, to boronic acid anhydride, formed by combination of two or more molecules of a boronic acid compound, with loss of one or more water molecules. When mixed with water, the boronic acid anhydride compound is hydrated to release the free boronic acid or boronic acid derivative. In various embodiments, the boronic acid anhydride can comprise two, three, four, or more boronic acid units, and can have a cyclic or linear configuration.

The term “carboxyethylesterase” (CBE), refers to insect carboxylesterases from the alpha and beta and non-microsomal gene clusters, as defined in Oakeshott, Claudianos, Campbell, Newcomb and Russell, “Biochemical Genetic and Genomics of Insect Esterases”, pp 309-381, Chapter 10, Volume 5, 2005, Eds. Gilbert, Iatrou, Gill, published—Elsevier which is incorporated herein by reference. The αE7 CBE is an example of an alpha esterase, and is found in the sheep blowfly, Lucilia cuprina, with homologous genes being present in other insect pests. The sequence of wild-type LcαE7 CBE has been deposited to the GenBank sequence data base with accession number GenBank: AAB67728.1 which is incorporated herein by reference. The Gly137Asp mutation in LcαE7 CBE from Lucilia cuprina has been shown to confer resistance to OP insecticides in: Newcomb, Campbell, Ollis, Cheah, Russell and Oakeshott, “A single amino acid substitution converts a carboxylesterase to an organophosphorus hydrolase and confers insecticide resistance on a blowfly” pp 7464-7468, Volume 94, 1997, Proceedings of the National Academy of Sciences, USA which is incorporated herein by reference. The same mutation at the same position in homologues of LcαE7 CBE from Lucilia cuprina also results in OP resistance. The CBEs play an important physiological role in many aspects of insect metabolism and are implicated in the detoxification of organophosphate (OP), carbamate (CM) and pyrethroid/synthetic pyrethroid (SP) insecticides. In other embodiments, the CBE of this invention is a homologue of CBE or mutated CBE.

In various embodiments, this invention provides a selective inhibitor of carboxyethylesterase (CBE), wherein the inhibitor comprises a boronic acid derivative or salt thereof. In other embodiments, the CBE of this invention is wild-type-CBE, a homologue of CBE or mutated CBE. In other embodiments, the CBE of this invention is wild-type or mutant versions of αE7 CBE or homologue thereof. In other embodiments, the CBE of this invention is LcαE7, wild-type LcαE7, mutated LcαE7, a homologue thereof, or any combination thereof.

In various embodiments, the boronic acid derivative of this invention and uses thereof is an aryl boronic acid derivative or salt thereof, wherein said aryl (e.g. phenyl, naphthyl, indolyl) is optionally substituted by between 1-5 substituents, wherein each substituent is independently: H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), O—CH₂Ph, O—CH₂-aryl, CH₂—O-aryl, —C(O)NH₂, —C(O)N(R)₂, —C(O)NHR, —NHC(O)R, C₁-C₅ linear or branched thioalkoxy, C₁-C₅ linear or branched haloalkoxy (e.g., OCF₃), C₁-C₅ linear or branched alkoxyalkyl, aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and wherein

R is C₁-C₅ linear or branched alkyl, C₁-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring (e.g. morpholine).

In various embodiments, said aryl of said aryl boronic acid is phenyl. In other embodiments, the aryl is substituted phenyl. In other embodiments, the aryl is substituted or unsubstituted naphthyl. In other embodiments, the aryl is substituted or unsubstituted indolyl. In various embodiments, said aryl is substituted with one or more substituents selected from: F, Cl, Br, C₁-C₅ linear or branched alkyl, methyl, C₁-C₅ linear or branched alkoxy, O-iPr, O-tBu, aryloxy, O-Ph, O—CH₂Ph, O—CH₂-aryl, CH₂—O-aryl, —C(O)N(R)₂, —C(O)NHR, C₁-C₅ linear or branched haloalkoxy, OCF₃, C₃-C₈ heterocyclic ring, pyrrolidine, morpholine, piperidine, 4-Me-piperazine; each substituent is a separate embodiment according to this invention. In other embodiments, said aryl boronic acid is selected from compounds 1-5, PBA, 3.12-3.12, C2, C10 and C21 described herein below.

In various embodiments, the boronic acid derivative of this invention is represented by the structure of formula I:

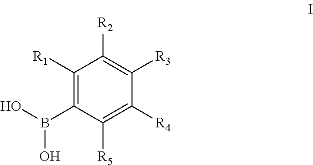

wherein
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;
or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂;
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

In various embodiments, the boronic acid derivative is represented by the structure of formula II:

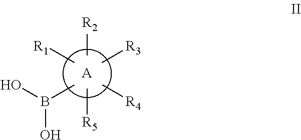

wherein
A ring is a single or fused aromatic (e.g. phenyl, naphthyl) or heteroaromatic (e.g. indole, 2,3-dihydrobenzofurane) ring system, or a single or fused C₃-C₁₀ cycloalkyl, or a single or fused C₃-C₁₀ heterocyclic ring;
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;

or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂;
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

In various embodiments, A of formula II is a phenyl. In other embodiments, A is pyridinyl. In other embodiments, A is naphthyl. In other embodiments, A is indolyl. In other embodiment, A is 2,3-dihydrobenzofuranyl. In various embodiments, the A ring is pyridinyl. In various embodiments, the A ring is pyrimidinyl. In various embodiments, the A ring is pyridazinyl. In various embodiments, A is pyrazinyl. In various embodiments, the A ring is triazinyl. In various embodiments, the A ring is tetrazinyl. In various embodiments, the A ring is thiazolyl. In various embodiments, the A ring is isothiazolyl. In various embodiments, the A ring is oxazolyl. In various embodiments, the A ring is isoxazolyl. In various embodiments, the A ring is imidazolyl. In various embodiments, the A ring is pyrazolyl. In various embodiments, the A ring is pyrrolyl. In various embodiments, the A ring is furanyl. In various embodiments, the A ring is thiophene-yl. In various embodiments, the A ring is indenyl. In various embodiments, the A ring is 2,3-dihydroindenyl. In various embodiments, the A ring is tetrahydronaphthyl. In various embodiments, the A ring is isoindolyl. In various embodiments, the A ring is naphthyl. In various embodiments, the A ring is anthracenyl. In various embodiments, the A ring is benzimidazolyl. In various embodiments, the A ring is indazolyl. In various embodiments, the A ring is purinyl. In various embodiments, the A ring is benzoxazolyl. In various embodiments, the A ring is benzisoxazolyl. In various embodiments, the A ring is benzothiazolyl. In various embodiments, the A ring is quinazolinyl. In various embodiments, the A ring is quinoxalinyl. In various embodiments, the A ring is cinnolinyl. In various embodiments, the A ring is phthalazinyl. In various embodiments, the A ring is quinolinyl. In various embodiments, the A ring is isoquinolinyl. In various embodiments, the A ring is 3,4-dihydro-2H-benzo[b][1,4]dioxepine. In various embodiments, the A ring is benzo[d][1,3]dioxole. In various embodiments, the A ring is acridinyl. In various embodiments, the A ring is benzofuranyl. In various embodiments, the A ring is isobenzofuranyl. In various embodiments, the A ring is benzothiophenyl. In various embodiments, the A ring is benzo[c]thiophenyl. In various embodiments, the A ring is benzodioxolyl. In various embodiments, the A ring is thiadiazolyl. In various embodiments, the A ring is oxadiaziolyl. In various embodiments, the A ring is 7-oxo-6H,7H-[1,3]thiazolo[4,5-d]pyrimidine. In various embodiments, the A ring is [1,3]thiazolo[5,4-b]pyridine. In various embodiments, the A ring is thieno[3,2-d]pyrimidin-4(3H)-one. In various embodiments, the A ring is 4-oxo-4H-thieno[3,2-d][1,3]thiazin. In various embodiments, the A ring is pyrido[2,3-b]pyrazin or pyrido[2,3-b]pyrazin-3(4H)-one. In various embodiments, the A ring is quinoxalin-2(1H)-one. In various embodiments, the A ring is 1H-indole. In various embodiments, the A ring is 2H-indazole. In various embodiments, the A ring is 4,5,6,7-tetrahydro-2H-indazole. In various embodiments, the A ring is 3H-indol-3-one. In various embodiments, the A ring is 1,3-benzoxazolyl. In various embodiments, the A ring is 1,3-benzothiazole. In various embodiments, the A ring is 4,5,6,7-tetrahydro-1,3-benzothiazole. In various embodiments, the A ring is 1-benzofuran. In various embodiments, the A ring is [1,3]oxazolo[4,5-b]pyridine. In various embodiments, the A ring is imidazo[2,1-b][1,3]thiazole. In various embodiments, the A ring is 4H,5H,6H-cyclopenta[d][1,3]thiazole. In various embodiments, the A ring is 5H,6H,7H,8H-imidazo[1,2-a]pyridine. In various embodiments, the A ring is 2H,3H-imidazo[2,1-b][1,3]thiazole. In various embodiments, the A ring is imidazo[1,2-a]pyridine. In various embodiments, the A ring is pyrazolo[1,5-a]pyridine. In various embodiments, the A ring is imidazo[1,2-a]pyrazine. In various embodiments, the A ring is imidazo[1,2-a]pyrimidine. In various embodiments, the A ring is 4H-thieno[3,2-b]pyrrole. In various embodiments, the A ring is 1H-pyrrolo[2,3-b]pyridine. In various embodiments, the A ring is 1H-pyrrolo[3,2-b]pyridine. In various embodiments, the A ring is 7H-pyrrolo[2,3-d]pyrimidine. In various embodiments, the A ring is oxazolo[5,4-b]pyridine. In various embodiments, the A ring is thiazolo[5,4-b]pyridine. In various embodiments, the A ring is triazolyl. In various embodiments, the A ring is benzoxadiazole. In various embodiments, the A ring is benzo[c][1,2,5]oxadiazolyl. In various embodiments, the A ring is 1H-imidazo[4,5-b]pyridine. In various embodiments, the A ring is 3H-imidazo[4,5-c]pyridine. In various embodiments, the A ring is a C₃-C₈ cycloalkyl. In various embodiments, the A ring is C₃-C₈ heterocyclic ring. In various embodiments, the A ring is tetrahydropyran. In various embodiments, the A ring is piperidine. In various embodiments, the A ring is 1-(piperidin-1-yl)ethanone. In various embodiments, the A ring is morpholine. In various embodiments, the A ring is thieno[3,2-c]pyridine.

In various embodiments, R₁ of formula I or II is H. In other embodiments, R₁ is F. In other embodiments, R₁ is Cl. In other embodiments, R₁ is Br. In other embodiments, R₁ is I. In other embodiments, R₁ is C₁-C₅ linear or branched alkyl. In other embodiments, R₁ is methyl. In other embodiments, R₁ is C₁-C₅ linear or branched haloalkyl. In other embodiments, R₁ is C₁-C₅ linear or branched alkoxy. In other embodiments, R₁ is —OiPr. In other embodiments, R₁ is —OtBu. In other embodiments, R₁ is —OCH₂-Ph. In other embodiments, R₁ is aryloxy. In other embodiments, R₁ is OPh. In other embodiments, R₁ is 1% R₇. In other embodiments, R₁ is —C(O)NH₂. In other embodiments, R₁ is —C(O)N(R)₂. In other embodiments, R₁ is C₁-C₅ linear or branched thioalkoxy. In other embodiments, R₁ is C₁-C₅ linear or branched haloalkoxy. In other embodiments, R₁ is OCF₃. In other embodiments, R₁ is aryl. In other embodiments, R₁ is C₃-C₈ cycloalkyl. In other embodiments, R₁ is C₃-C₈ heterocyclic ring. In other embodiments, R₁ is pyrrolidine. In other embodiments, R₁ is morpholine. In other embodiments, R₁ is piperidine. In other embodiments, R₁ is piperazine. In other embodiments, R₁ is 4-Me-piperazine; wherein each may be further substituted by F, Cl, Br, I, C₁-C₅ linear or branched alkyl, hydroxyl, alkoxy, N(R)₂, CF₃, CN or NO₂. In other embodiments, R is CF₃. In other embodiments, R is CN. In other embodiments, R is NO₂. In other embodiments, R₁ is —CH₂CN. In other embodiments, R₁ is NH₂. In other embodiments, R₁ is N(R)₂. In other embodiments, R₁ is alkyl-N(R)₂. In other embodiments, R₁ is hydroxyl. In other embodiments, R₁ is —OC(O)CF₃. In other embodiments, R₁ is COOH. In other embodiments, R₁ is C(O)O-alkyl. In other embodiments, R₁ is C(O)H.

In various embodiments, R₂ of formula I or II is H. In other embodiments, R₂ is F. In other embodiments, R₂ is Cl. In other embodiments, R₂ is Br. In other embodiments, R₂ is I. In other embodiments, R₂ is C₁-C₅ linear or branched alkyl. In other embodiments, R₂ is methyl. In other embodiments, R₂ is C₁-C₅ linear or branched haloalkyl. In other embodiments, R₂ is C₁-C₅ linear or branched alkoxy. In other embodiments, R₂ is —OiPr. In other embodiments, R₂ is —OtBu. In other embodiments, R₂ is —OCH₂-Ph. In other embodiments, R₂ is aryloxy. In other embodiments, R₂ is OPh. In other embodiments, R₂ is R₆R₇. In other embodiments, R₂ is —C(O)NH₂. In other embodiments, R₂ is —C(O)N(R)₂. In other embodiments, R₂ is C₁-C₅ linear or branched thioalkoxy. In other embodiments, R₂ is C₁-C₅ linear or branched haloalkoxy. In other embodiments, R₂ is OCF₃. In other embodiments, R₂ is aryl. In other embodiments, R₂ is C₃-C₈ cycloalkyl. In other embodiments, R₂ is C₃-C₈ heterocyclic ring. In other embodiments, R₂ is pyrrolidine. In other embodiments, R₂ is morpholine. In other embodiments, R₂ is piperidine. In other embodiments, R₂ is piperazine. In other embodiments, R₂ is 4-Me-piperazine; wherein each may be further substituted by F, Cl, Br, I, C₁-C₅ linear or branched alkyl, hydroxyl, alkoxy, N(R)₂, CF₃, CN or NO₂. In other embodiments, R₂ is CF₃. In other embodiments, R₂ is CN. In other embodiments, R₂ is NO₂. In other embodiments, R₂ is —CH₂CN. In other embodiments, R₂ is NH₂. In other embodiments, R₂ is N(R)₂. In other embodiments, R₂ is alkyl-N(R)₂. In other embodiments, R₂ is hydroxyl. In other embodiments, R₂ is —OC(O)CF₃. In other embodiments, R₂ is COOH. In other embodiments, R₂ is C(O)O-alkyl. In other embodiments, R₂ is C(O)H.

In various embodiments, R₃ of formula I or II is H. In other embodiments, R₃ is F. In other embodiments, R₃ is Cl. In other embodiments, R₃ is Br. In other embodiments, R₃ is I. In other embodiments, R₃ is C₁-C₅ linear or branched alkyl. In other embodiments, R₃ is methyl. In other embodiments, R₃ is C₁-C₅ linear or branched haloalkyl. In other embodiments, R₃ is C₁-C₅ linear or branched alkoxy. In other embodiments, R₃ is —OiPr. In other embodiments, R₃ is —OtBu. In other embodiments, R₃ is —OCH₂-Ph. In other embodiments, R₃ is aryloxy. In other embodiments, R₃ is OPh. In other embodiments, R₃ is R₆R₇. In other embodiments, R₃ is —C(O)NH₂. In other embodiments, R₃ is —C(O)N(R)₂. In other embodiments, R₃ is C₁-C₅ linear or branched thioalkoxy. In other embodiments, R₃ is C₁-C₅ linear or branched haloalkoxy. In other embodiments, R₁ is OCF₃. In other embodiments, R₃ is aryl. In other embodiments, R₃ is C₃-C₈ cycloalkyl. In other embodiments, R₃ is C₃-C₈ heterocyclic ring. In other embodiments, R₃ is pyrrolidine. In other embodiments, R₃ is morpholine. In other embodiments, R₃ is piperidine. In other embodiments, R₃ is piperazine. In other embodiments, R₃ is 4-Me-piperazine; wherein each may be further substituted by F, Cl, Br, I, C₁-C₅ linear or branched alkyl, hydroxyl, alkoxy, N(R)₂, CF₃, CN or NO₂. In other embodiments, R₃ is CF₃. In other embodiments, R₃ is CN. In other embodiments, R₃ is NO₂. In other embodiments, R₃ is —CH₂CN. In other embodiments, R₃ is NH₂. In other embodiments, R₃ is N(R)₂. In other embodiments, R₁ is alkyl-N(R)₂. In other embodiments, R₃ is hydroxyl. In other embodiments, R₃ is —OC(O)CF₃. In other embodiments, R₃ is COOH. In other embodiments, R₃ is C(O)O-alkyl. In other embodiments, R₃ is C(O)H.

In various embodiments, R₄ of formula I or II is H. In other embodiments, R₄ is F. In other embodiments, R₄ is Cl. In other embodiments, R₄ is Br. In other embodiments, R₄ is I. In other embodiments, R₄ is C₁-C₅ linear or branched alkyl. In other embodiments, R₄ is methyl. In other embodiments, R₄ is C₁-C₅ linear or branched haloalkyl. In other embodiments, R₄ is C₁-C₅ linear or branched alkoxy. In other embodiments, R₄ is —OiPr. In other embodiments, R₄ is —OtBu. In other embodiments, R₄ is —OCH₂-Ph. In other embodiments, R₄ is aryloxy. In other embodiments, R₄ is OPh. In other embodiments, R₄ is R₆R₇. In other embodiments, R₄ is —C(O)NH₂. In other embodiments, R₄ is —C(O)N(R)₂. In other embodiments, R₄ is C₁-C₅ linear or branched thioalkoxy. In other embodiments, R₄ is C₁-C₅ linear or branched haloalkoxy. In other embodiments, R₄ is OCF₃. In other embodiments, R₄ is aryl. In other embodiments, R₄ is C₃-C₈ cycloalkyl. In other embodiments, R₄ is C₃-C₈ heterocyclic ring. In other embodiments, R₄ is pyrrolidine. In other embodiments, R₄ is morpholine. In other embodiments, R₄ is piperidine. In other embodiments, R₄ is piperazine. In other embodiments, R₄ is 4-Me-piperazine; wherein each may be further substituted by F, Cl, Br, I, C₁-C₅ linear or branched alkyl, hydroxyl, alkoxy, N(R)₂, CF₃, CN or NO₂. In other embodiments, R₄ is CF₃. In other embodiments, R₄ is CN. In other embodiments, R₄ is NO₂. In other embodiments, R₄ is —CH₂CN. In other embodiments, R₄ is NH₂. In other embodiments, R₄ is N(R)₂. In other embodiments, R₄ is alkyl-N(R)₂. In other embodiments, R₄ is hydroxyl. In other embodiments, R₄ is —OC(O)CF₃. In other embodiments, R₄ is COOH. In other embodiments, R₄ is C(O)O-alkyl. In other embodiments, R₄ is C(O)H.

In various embodiments, R₅ of formula I or II is H. In other embodiments, R₅ is F. In other embodiments, R₅ is Cl. In other embodiments, R₅ is Br. In other embodiments, R₅ is I. In other embodiments, R₅ is C₁-C₅ linear or branched alkyl. In other embodiments, R₅ is methyl. In other embodiments, R₅ is C₁-C₅ linear or branched haloalkyl. In other embodiments, R₅ is C₁-C₅ linear or branched alkoxy. In other embodiments, R₅ is —OiPr. In other embodiments, R₅ is —OtBu. In other embodiments, R₅ is —OCH₂-Ph. In other embodiments, R₅ is aryloxy. In other embodiments, R₅ is OPh. In other embodiments, R₅ is R₆R₇. In other embodiments, R₅ is —C(O)NH₂. In other embodiments, R₅ is —C(O)N(R)₂. In other embodiments, R₅ is C₁-C₅ linear or branched thioalkoxy. In other embodiments, R₅ is C₁-C₅ linear or branched haloalkoxy. In other embodiments, R₅ is OCF₃. In other embodiments, R₅ is aryl. In other embodiments, R₅ is C₃-C₈ cycloalkyl. In other embodiments, R₅ is C₃-C₈ heterocyclic ring. In other embodiments, R₅ is pyrrolidine. In other embodiments, R₅ is morpholine. In other embodiments, R₅ is piperidine. In other embodiments, R₅ is piperazine. In other embodiments, R₅ is 4-Me-piperazine; wherein each may be further substituted by F, Cl, Br, I, C₁-C₅ linear or branched alkyl, hydroxyl, alkoxy, N(R)₂, CF₃, CN or NO₂. In other embodiments, R₅ is CF₃. In other embodiments, R₅ is CN. In other embodiments, R₅ is NO₂. In other embodiments, R₅ is —CH₂CN. In other embodiments, R₅ is NH₂. In other embodiments, R₅ is N(R)₂. In other embodiments, R₅ is alkyl-N(R)₂. In other embodiments, R₅ is hydroxyl. In other embodiments, R₅ is —OC(O)CF₃. In other embodiments, R₅ is COOH. In other embodiments, R₅ is C(O)O-alkyl. In other embodiments, R₅ is C(O)H.

In various embodiments, R₂ and R₁ or R₃ and R₁, or R₄ and R₃, or R₅ and R₄ of formula I or II (each pair is a separate embodiment) are joint together to form a 5 or 6 membered carbocyclic or heterocyclic ring, which may be further substituted by F, Cl, Br, I, C₁-C₅ linear or branched alkyl, hydroxyl, alkoxy, N(R)₂, CF₃, CN and/or NO₂. In other embodiments, R₂ and R₁ or R₃ and R₁, or R₄ and R₃, or R₅ and R₄ (each pair is a separate embodiment) are joint together to form benzene. R₂ and R₁ or R₃ and R₁, or R₄ and R₃, or R₅ and R₄ are joint together to form furane.

In various embodiments, R₆ of formula I or II is O. In other embodiments, R₆ is (CH₂)ₙ, wherein n is 1, 2, 3, 4, 5 or 6 (each is a separate embodiment). In other embodiments, R₆ is C(O). In other embodiments, R₆ is C(O)O. In other embodiments, R₆ is OC(O). In other embodiments, R₆ is C(O)NH. In other embodiments, R₆ is C(O)N(R). In other embodiments, R₆ is NHC(O). In other embodiments, R₆ is N(R)CO. In other embodiments, R₆ is NHSO₂. In other embodiments, R₆ is N(R)SO₂. In other embodiments, R₆ is SO₂NH. In other embodiments, R₆ is SO₂N(R). In other embodiments, R₆ is S. In other embodiments, R₆ is SO. In other embodiments, R₆ is SO₂. In other embodiments, R₆ is NH. In other embodiments, R₆ is N(R). In other embodiments, R₆ is OCH₂. In other embodiments, R₆ is CH₂O.

In various embodiments, R₇ of formula I or II is C₁-C₅ linear or branched alkyl. In other embodiments, R₇ is t-Bu. In other embodiments, R₇ is i-Pr. In other embodiments, R₇ is C₁-C₅ linear or branched haloalkyl. In other embodiments, R₇ is CF₃. In other embodiments, R₇ is C₁-C₅ linear or branched alkoxy. In other embodiments, R₇ is C₃-C₈ cycloalkyl. In other embodiments, R₇ is C₃-C₈ heterocyclic ring. In other embodiments, R₇ is morpholine. In other embodiments, R₇ is phenyl. In other embodiments, R₇ is aryl. In other embodiments, R₇ is 2-chlorophenyl. In other embodiments, R₇ is 2-fluorophenyl. In other embodiments, R₇ is naphthyl. In other embodiments, R₇ is benzyl. In other embodiments, R₇ is heteroaryl. In other embodiments, the aryl, benzyl, heteroaryl or naphthyl may be further substituted by F, Cl, Br, I, C₁-C₅ linear or branched alkyl, hydroxyl, alkoxy, N(R)₂, CF₃, CN and/or NO₂ (each is a separate embodiment.

In various embodiments, R of formula I or II is C₁-C₅ linear or branched alkyl. In other embodiments, R is t-Bu. In other embodiments, R is i-Pr. In other embodiments, R is C₁-C₅ linear or branched haloalkyl. In other embodiments, R is CF₃. In other embodiments, R is C₁-C₅ linear or branched alkoxy. In other embodiments, R is C₃-C₈ cycloalkyl. In other embodiments, R is C₃-C₈ heterocyclic ring. In other embodiments, R is morpholine. In other embodiments, R is phenyl. In other embodiments, R is aryl. In other embodiments, R is 2-chlorophenyl. In other embodiments, R is 2-fluorophenyl. In other embodiments, R is naphthyl. In other embodiments, R is benzyl. In other embodiments, R is heteroaryl. In other embodiments, the benzyl, heteroaryl or naphthyl may be further substituted by F, Cl, Br, I, C₁-C₅ linear or branched alkyl, hydroxyl, alkoxy, N(R)₂, CF₃, CN and/or NO₂ (each is a separate embodiment. In other embodiments, two gem R substituents are joint together to form a 5 or 6 membered heterocyclic ring.

In various embodiments, n of formula I or II is 1. In other embodiments, n is 2. In other embodiments, n is 3. In other embodiments, n is 4. In other embodiments, n is 5. In other embodiments, n is 6.

In various embodiments, the boronic acid derivative is selected from:

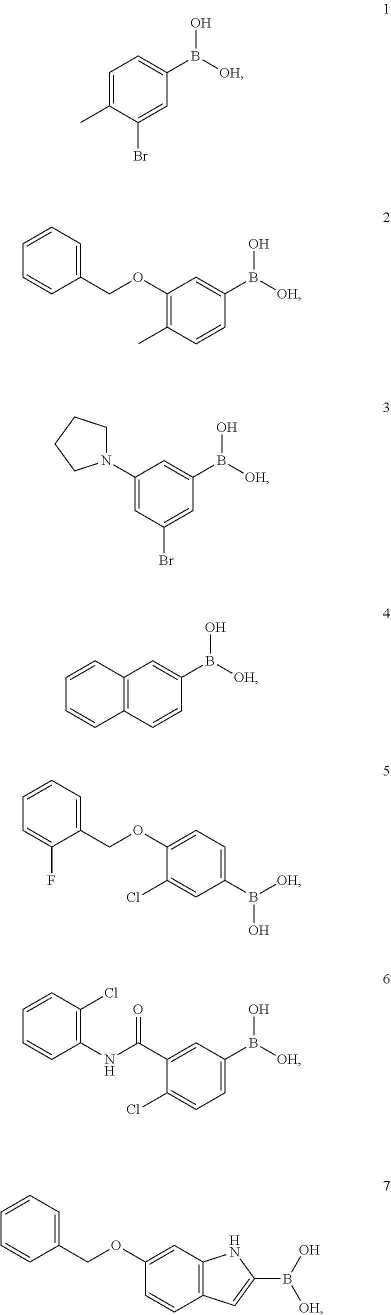

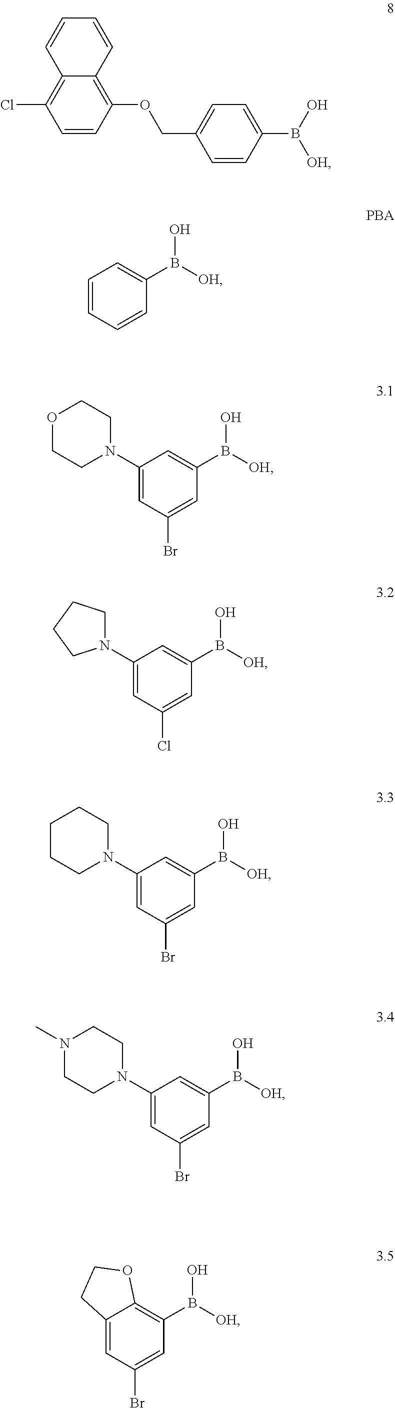

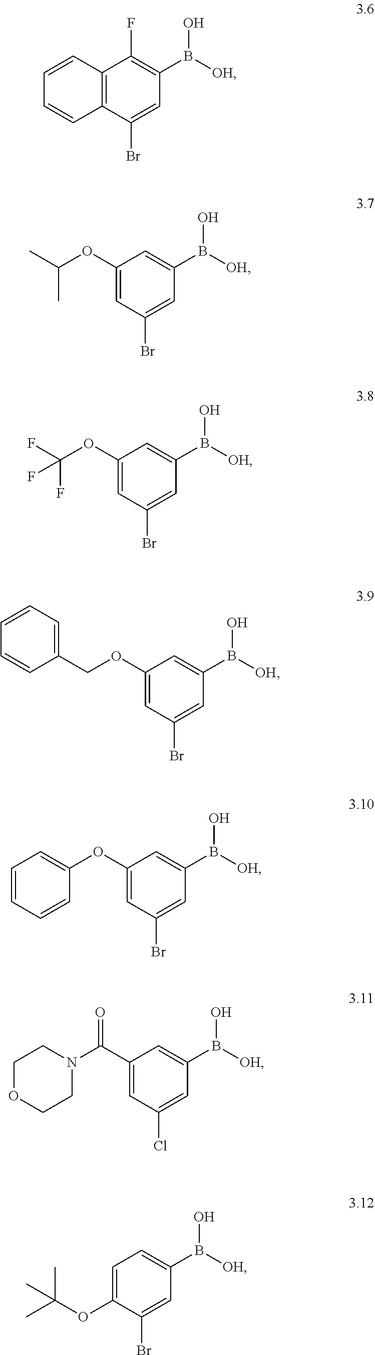

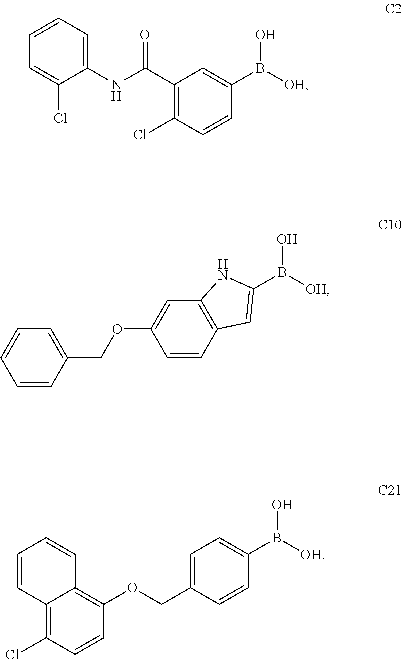 [SMILES: O=C(Nc1ccccc1Cl)c1cc(B(O)O)ccc1Cl ; OB(O)c1cc2ccc(OCc3ccccc3)cc2[nH]1 ; OB(O)c1ccc(COc2ccc(Cl)c3ccccc23)cc1]

In various embodiments, the salts of boronic acid derivative include any acidic salts. Non-limiting examples of inorganic salts of carboxylic acids include ammonium, alkali metals to include lithium, sodium, potassium, cesium; alkaline earth metals to include calcium, magnesium, aluminum; zinc, barium, chlorines or quaternary ammoniums. Non limiting examples of organic salts include organic amines to include aliphatic organic amines, alicyclic organic amines, aromatic organic amines, benzathines, t-butylamines, benethamines (N-benzylphenethylamine), dicyclohexylamines, dimethylamines, diethanolamines, ethanolamines, ethylenediamines, hydrabamines, imidazoles, lysines, methylamines, meglamines, N-methyl-D-glucamines, N,N′-dibenzylethylenediamines, nicotinamides, organic amines, ormithines, pyridines, picolies, piperazines, procain, tris(hydroxymethyl)methylamines, triethylamines, triethanolamines, trimethylamines, tromethamines or ureas.

As used herein, the term “alkyl” can be any straight- or branched-chain alkyl group containing up to about 30 carbons unless otherwise specified. In various embodiments, an alkyl includes C₁-C₅ carbons. In other embodiments, an alkyl includes C₁-C₆ carbons. In other embodiments, an alkyl includes C₁-C₈ carbons. In other embodiments, an alkyl includes C₁-C₁₀ carbons. In other embodiments, an alkyl is a C₁-C₁₂ carbons. In other embodiments, an alkyl is a C₁-C₂₀ carbons. In other embodiments, branched alkyl is an alkyl substituted by alkyl side chains of 1 to 5 carbons. In various embodiments, the alkyl group may be unsubstituted. In other embodiments, the alkyl group may be substituted by a halogen, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl.

The alkyl group can be a sole substituent or it can be a component of a larger substituent, such as in an alkoxy, alkoxyalkyl, haloalkyl, arylalkyl, alkylamino, dialkylamino, alkylamido, alkylurea, etc. Preferred alkyl groups are methyl, ethyl, and propyl, and thus halomethyl, dihalomethyl, trihalomethyl, haloethyl, dihaloethyl, trihaloethyl, halopropyl, dihalopropyl, trihalopropyl, methoxy, ethoxy, propoxy, arylmethyl, arylethyl, arylpropyl, methylamino, ethylamino, propylamino, dimethylamino, diethylamino, methylamido, acetamido, propylamido, halomethylamido, haloethylamido, halopropylamido, methyl-urea, ethyl-urea, propyl-urea, etc.

As used herein, the term “aryl” refers to any aromatic or heteroaromatic single or fused ring that is directly bonded to another group and can be either substituted or unsubstituted. The aryl group can be a sole substituent, or the aryl group can be a component of a larger substituent, such as in an arylalkyl, arylamino, arylamido, etc. Exemplary aryl groups include, without limitation, phenyl, tolyl, xylyl, furanyl, naphthyl, pyridinyl, pyrimidinyl, pyridazinyl, pyrazinyl, triazinyl, thiazolyl, oxazolyl, isooxazolyl, pyrazolyl, indolyl, imidazolyl, thiophene-yl, pyrrolyl, phenylmethyl, phenylethyl, phenylamino, phenylamido, etc. Substitutions include but are not limited to: F, Cl, Br, I, C₁-C₅ linear or branched alkyl, C₁-C₅ linear or branched haloalkyl, C₁-C₅ linear or branched alkoxy, C₁-C₅ linear or branched haloalkoxy, CF₃, CN, NO₂, —CH₂CN, NH₂, NH-alkyl, N(alkyl)₂, hydroxyl, —OC(O)CF₃, —OCH₂Ph, —NHCO-alkyl, COOH, —C(O)Ph, C(O)O— alkyl, C(O)H, or —C(O)NH₂.

As used herein, the term “alkoxy” refers to an ether group substituted by an alkyl group as defined above. Alkoxy refers both to linear and to branched alkoxy groups. Nonlimiting examples of alkoxy groups are methoxy, ethoxy, propoxy, iso-propoxy, tert-butoxy, —OCH₂-Ph.

As used herein, the term “thioalkoxy” refers to a thio group substituted by an alkyl group as defined above. Thioalkoxy refers both to linear and to branched thioalkoxy groups. Nonlimiting examples of thioalkoxy groups are S-Methyl, S-Ethyl, S-Propyl, S-iso-propyl, S-tert-butyl, —SCH₂-Ph.

As used herein, the term “aryloxy” refers to an ether group substituted by an aryl group as defined above. Nonlimiting examples of aryloxy groups are OPh.

A “haloalkyl” group refers, in other embodiments, to an alkyl group as defined above, which is substituted by one or more halogen atoms, e.g. by F, Cl, Br or I. Nonlimiting examples of haloalkyl groups are CF₃, CF₂CF₃, CH₂CF₃.

A “haloalkoxy” group refers, in other embodiments, to an alkoxy group as defined above, which is substituted by one or more halogen atoms, e.g. by F, Cl, Br or I. Nonlimiting examples of haloalkoxy groups are OCF₃, OCF₂CF₃, OCH₂CF₃.

An “alkoxyalkyl” group refers, in other embodiments, to an alkyl group as defined above, which is substituted by alkoxy group as defined above, e.g. by methoxy, ethoxy, propoxy, i-propoxy, t-butoxy etc. Nonlimiting examples of alkoxyalkyl groups are —CH₂—O—CH₃, —CH₂—O—CH(CH₃)₂, —CH₂—O—C(CH₃)₃, —CH₂—CH₂—O—CH₃, —CH₂—CH₂—O—CH(CH₃)₂, —CH₂—CH₂—O—C(CH₃)₃.

A “cycloalkyl” or “carbocyclic” group refers, in various embodiments, to a ring structure comprising carbon atoms as ring atoms, which may be either saturated or unsaturated, substituted or unsubstituted. In other embodiments the cycloalkyl is a 3-12 membered ring. In other embodiments the cycloalkyl is a 6 membered ring. In other embodiments the cycloalkyl is a 5-7 membered ring. In other embodiments the cycloalkyl is a 3-8 membered ring. In other embodiments, the cycloalkyl group may be unsubstituted or substituted by a halogen, alkyl, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In other embodiments, the cycloalkyl ring may be fused to another saturated or unsaturated cycloalkyl or heterocyclic 3-8 membered ring. In other embodiments, the cycloalkyl ring is a saturated ring. In other embodiments, the cycloalkyl ring is an unsaturated ring. Non limiting examples of a cycloalkyl group comprise cyclohexyl, cyclohexenyl, cyclopropyl, cyclopropenyl, cyclopentyl, cyclopentenyl, cyclobutyl, cyclobutenyl, cycloctyl, cycloctadienyl (COD), cycloctaene (COE) etc.

A “heterocycle” or “heterocyclic” group refers, in various embodiments, to a ring structure comprising in addition to carbon atoms, sulfur, oxygen, nitrogen or any combination thereof, as part of the ring. In other embodiments the heterocycle is a 3-12 membered ring. In other embodiments the heterocycle is a 6 membered ring. In other embodiments the heterocycle is a 5-7 membered ring. In other embodiments the heterocycle is a 3-8 membered ring. In other embodiments, the heterocycle group may be unsubstituted or substituted by a halogen, alkyl, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In other embodiments, the heterocycle ring may be fused to another saturated or unsaturated cycloalkyl or heterocyclic 3-8 membered ring. In other embodiments, the heterocyclic ring is a saturated ring. In other embodiments, the heterocyclic ring is an unsaturated ring. Non-limiting examples of a heterocyclic rings comprise pyridine, pyrrolidine, piperidine, morpholine, piperazine, thiophene, pyrrole, benzodioxole, or indole.

In various embodiments, this invention provides a selective inhibitor of carboxyethylesterase (CBE) comprising a boronic acid derivative and salt thereof. In other embodiments, the CBE of this invention is wild-type-CBE, a homologue of CBE or mutated CBE. In other embodiments, the CBE of this invention is wild-type or mutant versions of αE7 CBE or homologue thereof. In other embodiments, the CBE of this invention is LcαE7, wild-type LcαE7, mutated LcαE7, a homologue thereof, or any combination thereof. In other embodiments, the boronic acid derivative is an aryl boronic acid derivative and salt thereof as described herein above.

In various embodiments, this invention provides a selective inhibitor of carboxyethylesterase (CBE) comprising a boronic acid derivative or salt thereof represented by the structure of formula I:

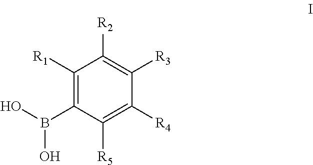

wherein
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;
or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

In other embodiments, the CBE of this invention is a wild-type CBE, a homologue of CBE or mutated CBE. In other embodiments, the CBE is LcαE7.

In various embodiments, this invention provides a selective inhibitor of carboxyethylesterase (CBE) comprising a boronic acid derivative selected from:

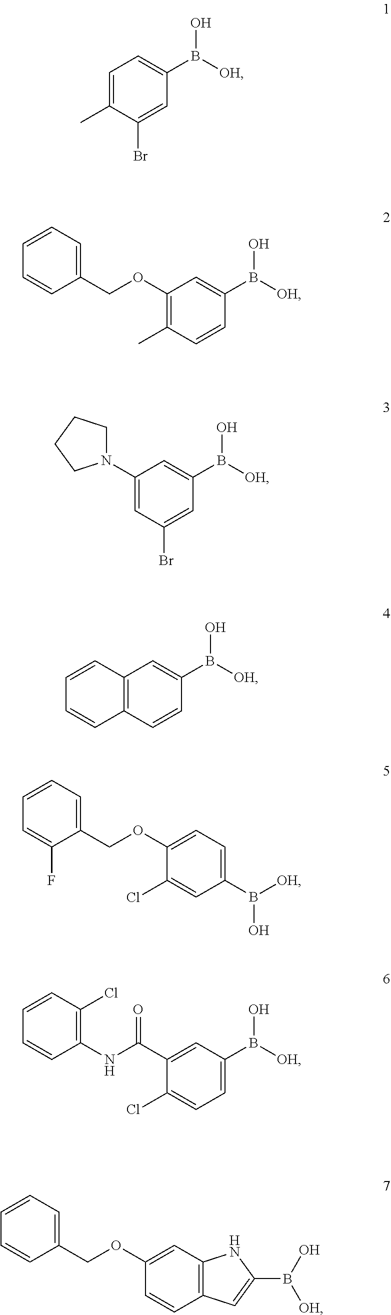

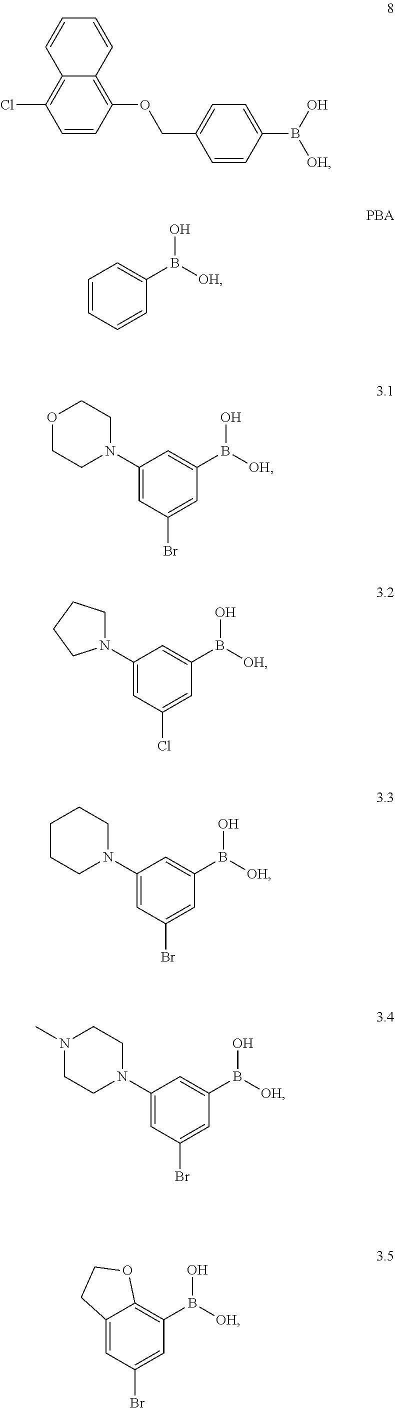

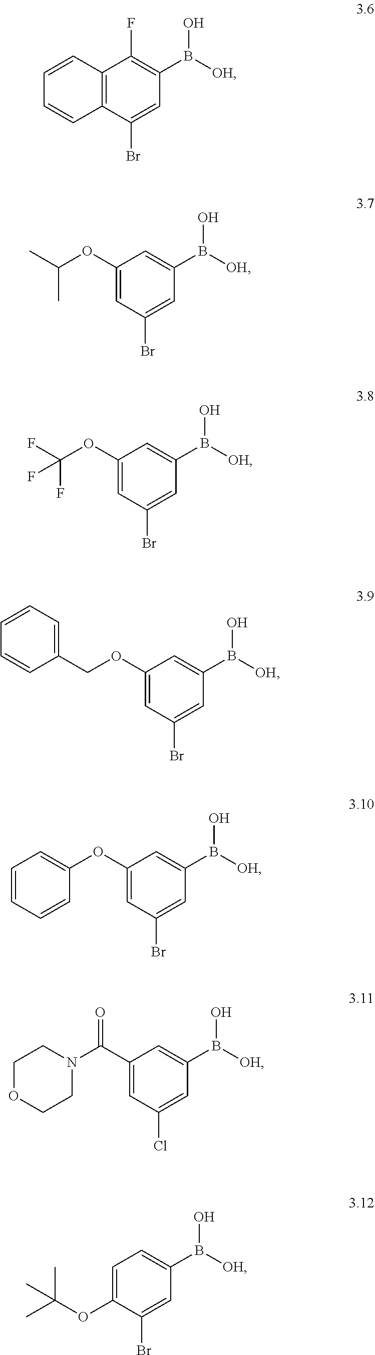

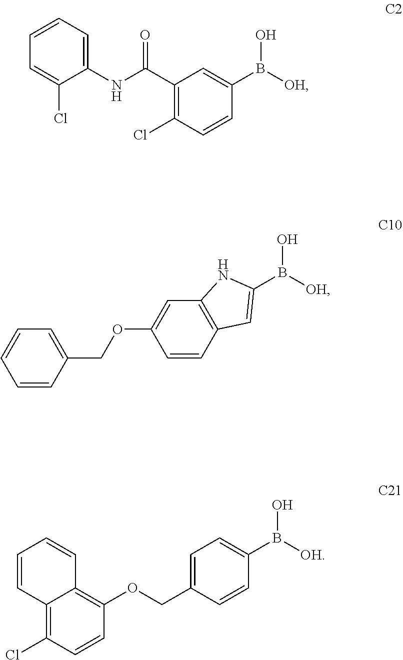 [SMILES: O=C(Nc1ccccc1Cl)c1cc(B(O)O)ccc1Cl ; OB(O)c1cc2ccc(OCc3ccccc3)cc2[nH]1 ; OB(O)c1ccc(COc2ccc(Cl)c3ccccc23)cc1]

In other embodiments, the inhibitor is covalently attached to the CBE, the homologue of CBE or the mutated CBE. In other embodiments, the CBE is a wild type αE7. In other embodiments, the CBE is a αE7 homologue. In other embodiments, the CBE is a mutated αE7. In other embodiments, the αE7 is LcαE7. In other embodiments, the CBE is a wild-type or a mutated CBE or combination thereof. In other embodiments, the mutation in said mutated CBE is αE7 Gly137Asp. In other embodiments, the CBE is equivalent mutation in a homologue of αE7 CBE. In other embodiments, the inhibitor is a nanomolar inhibitor. In other embodiments, the inhibitor is a picomolar inhibitor.

Despite the emergence of resistance, and issues relating to environmental and human contamination, insecticides are the primary measure for blowfly control. The recent detection of resistance against the main means of chemical control of the blowfly, dicyclanil and cyromazine (Levot G. et al., Survival advantage of cyromazine-resistant sheep blowfly larvae on dicyclanil-and cyromazine-treated Merinos. Aust. Vet. J. 92, 421-426 (2014) and Levot G. Cyromazine resistance detected in Australian sheep blowfly. Aust. Vets 90, 433-437 (2012).), highlights the need for continued innovatio in blowfly control measures. While new insecticide targets are under investigation (Kotze, A. C et al. Histone deacetylase enzymes as drug targets for the control of the sheep blowfly, Lucilia cuprina. Int. J. Parasitol. Drugs Drug Resist. 5, 201-208 (2015).), assisted by the recent publication of the L. cuprina genome geneome (Anstead C. a. et al. Lucilia cuprina genome unlocks parasitic fly biology to underpin future interventions. Nat Commun. 6, 7344 (2015)), the use of synergists to resurrect the effectiveness of OP insecticides may be a viable strategy for blowfly control, particularly if current control methods fail.

In various embodiments, this invention provides a pesticide composition for killing pests comprising a synergistically effective combination of at least one organophosphate (OP), carbamate (CM), and/or pyrethroid/synthetic pyrethroid (SP); and at least one boronic acid derivative or salt thereof. In other embodiments, the pests are organophosphate (OP), carbamate (CM) and/or pyrethroid/synthetic pyrethroid (SP) pesticide resistant. In various embodiments, this invention provides a pesticide composition for killing pests comprising a synergistically effective combination of organophosphate (OP) and at least one boronic acid derivative or salt thereof. In other embodiments, the pests are organophosphate (OP) pesticide resistant.

In other embodiments, the composition is for use in killing pests. In other embodiments, the composition is for use in killing insects. In other embodiments, the boronic acid derivative is an aryl boronic acid derivative or salt thereof as described herein above. In other embodiments, the boronic acid derivative is represented by formula I or II described herein above. In other embodiments, the boronic acid derivative is selected from compounds 1-8, PBA, 3.1-3.12, C2, C10 and C21 described herein above; each is a separate embodiment according to this invention. In other embodiments, the composition is useful for killing pests of agricultural crops including, vegetable crops, floriculture, ornamental crops, medicinal, and economic plants. In other embodiments, the agricultural crop is small broad bean (Vicia faba). In other embodiments, the agricultural crop is corn (e.g., Zea may). In other embodiments, the agricultural crop is potato.

A major requirement for such synergistically effective composition to be practical is a benign safety and environmental profile. The main concern in terms of toxicity is selectivity against AChE. While the overall structure of LcαE7 resembles that of human AChE (PDB 4PQE; 1.05 Å RMSD over 309 residues), the enzymes are quite different in the region of the active site, which results in the >10⁶ fold selectivity of e.g. compound 3 for LcαE7 (Table 1). As a result of the conformational differences in the active sites, the bromo-substituent, which is highly complementary to the LcαE7 active site, is sterically occluded from the active site of AChE due to a clash with Phe295 in (FIG. 14). Moreover, it is demonstrated herein that these compounds do not significantly inhibit other non-target proteins such as human serine and threonine proteases, nor are they generally toxic to cells. This is also consistent with other literature suggesting that boronic acids are relatively benign.

Accordingly, in various embodiments, the composition as described herein above, is not toxic to plants. In other embodiments, the composition is not toxic to mammals. In other embodiments, the composition is not toxic to birds. In other embodiments, the composition is not toxic to animals. In other embodiments, the composition is not toxic to humans.

In other embodiments, the composition kills pests, including but not limited to blowfly (e.g., Calliphora stygia), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof. Examples of pests include but are not limited to: blowfly (e.g., Calliphora stygia), screw-worm fly (e.g., Cochliomyia hominivorax), mosquitoes (e.g., Aedes aegypti, Anopheles gambiae, Culex quinquefasciatus), house flies (e.g., Musca domestica), stable flies (e.g., Stomoxys calcitrans), aphids (e.g. green peach aphid), borers (e.g. Ostrinia nubilalis (European corn borer)), beetles (e.g. Leptinotarsa decemlineata (Colorado Beetle)), moths, nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fiabricius), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); adults and larvae of the order Dermaptera including earwigs from the family Forficulidae (e.g., European earwig (Forficula auricularia Linnaeus), and black earwig (Chelisoches morio Fabricius)). Other examples are adults and larvae of the order Acari (mites) such as spider mites and red mites in the family Tetranychidae (e.g., European red mite (Panonychus ulmi Koch), two spotted spider mite (Tetranychus urticae Koch), and McDaniel mite (Tetranychus mcdanieli McGregor)); mites important in human and animal health (e.g., dust mites in the family Epidermoptidae, follicle mites in the family Demodicidae, and grain mites in the family Glycyphagidae); ticks in the order Ixodidae (e.g., deer tick (Ixodes scapularis Say), Australian paralysis tick (Ixodes holocyclus Neumann), American dog tick (Dermacentor variabilis Say), and lone star tick (Amblyomma americanum Linnaeus)); scab and itch mites in the families Psoroptidae, Pyemotidae, and Sarcoptidae; crickets such as house cricket (Acheta domesticus Linnaeus), mole crickets (e.g., tawny mole cricket (Scapteriscus vicinus Scudder), and southern mole cricket (Scapteriscus borellii Giglio-Tos)); flies including house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp. Lucilia cuprina), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera; mosquitoes (e.g., Aedes spp., Anopheles spp., Culex spp.), Aedes aegypti (yellow fever mosquito); Anopheles albimanus; Culex pipiens complex; Culex tarsalis; Culex tritaenorhynchus; black flies (e.g., Prosimulium spp., Simulium spp.), Simulium damnosum; Simulium sanctipauli (black flies); biting midges, sand flies, sciarids, and other Nematocera; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicomis Latreille), pavement ant (Tetramorium caespitum Linnaeus), cornfield ant (Lasius alienus Forster), odorous house ant (Tapinoma sessile Say)); insect pests of the Family Formicidae including the Florida carpenter ant (Camponotus floridanus Buckley), white-footed ant (Technomyrmex albipes fr. Smith), big headed ants (Pheidole spp.), and ghost ant (Tapinoma melanocephalum Fabricius); bees (including carpenter bees), hornets, yellow jackets, wasps, and sawflies (Neodiprion spp.; Cephus spp.); insect pests of the order Isoptera including termites in the Termitidae (ex. Macrotermes sp.), Kalotermitidae (ex. Cryptotermes sp.), and Rhinotermitidae (ex. Reticulitermes spp., Coptotermes spp.), families the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch); long-nosed cattle louse (Linognathus vituli Linnaeus) and other sucking and chewing parasitic lice that attack man and animals; examples for insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Examples for Arthropod pests also include spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus); Frankliniella occidentalis; Scirtothrips citri; Acyrthosiphon pisum; Aphis gossypii; Bemisia tabaci; Brevicoryne brassicae (cabbage aphid); Lygus Hesperus; Myzus persicae (Green peach aphid); Myzus nicotianaea (tobacco aphid); Nasonovia ribisnigri (Currantlettuce aphid); Nephotettix cincticeps; Nilaparvata lugens (brown rice planthopper); Phorodon humuli (damsonhop aphid); Schizaphis graminum (greenbug); Diabrotica virgifera; Leptinotarsa decemlineata; Oryzaephilus surinamensis (saw-toothed grain beetle); Leptinotarsa decemlineata (Colorado Beetle); moths such as: Cydia pomonella (codling moth); Epiphyas postvittana (light brown apple moth); Heliothis virescens; Platynota idaeusalis (tufted apple bud moth); Haematobia irritans (Buffalo fly); Lucilia sericata (green bottle fly); Amblyseius pontentillae; Boophilus microplus; Calliphora stygia, Cochliomyia hominivorax, Aedes aegypti, Anopheles gambiae, Culex quinquefasciatus and Tetranychus kanzawai. In other embodiments, the composition kills pests as listed hereinabove but is not harmful to animals. In other embodiments, the composition is not harmful to mammals. In other embodiments, the composition is not harmful to birds. In other embodiments, the composition is not harmful to human. In other embodiments, the composition is not harmful to plants.

In various embodiments the composition is applied to the agricultural crop by spray, film, infused onto nets or topically administered to a livestock.

In various embodiments, this invention provides a method for killing insect population that carry the causative agent of malaria disease comprising administering a combination of at least one organophosphate (OP), carbamate (CM), and/or pyrethroid/synthetic pyrethroid (SP); and at least one boronic acid derivative or salt thereof. In other embodiments, the combination composition of at least one organophosphate (OP), carbamate (CM), and/or pyrethroid/synthetic pyrethroid (SP); and at least one boronic acid derivative or salt thereof is infused onto a net.

In other embodiments, the insect population that carries the causative agent of malaria includes mosquitoes (e.g., Aedes spp., Anopheles spp., Culex spp.), Aedes aegypti (yellow fever mosquito); Anopheles albimanus; Culex pipiens complex; Culex tarsalis; Culex tritaenorhynchu or any combination thereof.

In various embodiments, this invention provides a method for killing pests, the method comprises contacting a population of pests with an effective amount of the composition of this invention. In other embodiments, the pests are insects. In other embodiments, the insect is blowfly (e.g., Calliphora stygia), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof. In other embodiments, the insect is blowfly. In other embodiments, the insect is aphid. In other embodiments, the insect is a borer. In other embodiments, the insect is a beetle. In other embodiments, the insect is a moth. In other embodiments, contacting the population comprises exposing the population to the pesticide so that the composition is ingested by the pests sufficient to kill at least 25%, 30%, 35%, 40%, 45%, 50%, 60%, 70%, 80%, 90%, 100% of the pest population, each value is a separate embodiment according to this invention. In other embodiments, contacting the population comprises exposing the population to the insecticide so that the composition is ingested by the insects sufficient to kill at least 50% of the population. In other embodiments, the method is not toxic to animals. In other embodiments, the method is not toxic to humans. In other embodiments, the method is not toxic to plants. In other embodiments, the method is environmentally safe.

In various embodiments, this invention provides a method for killing insect pests on a plant, the method comprising contacting the plant with the composition of this invention, wherein the composition has a synergistic effect on insecticidal activity. In other embodiments, this invention provides a method for killing insect pests on an animal, the method comprising contacting the animal with the composition of this invention. In other embodiments the insect is blowfly (e.g., Calliphora stygia), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof, or any of the other insect species described herein. In other embodiments, the insect is blowfly. In other embodiments, the insect is aphid. In other embodiments, the insect is a borer. In other embodiments, the insect is a beetle. In other embodiments, the insect is a moth. In other embodiments, the method comprises direct application of the composition to the insect. In other embodiments, the composition is useful for killing pests of agricultural animals including sheep, cattle, goats, domestic pests such as cats, dogs, birds, pigs and fish. In other embodiments the pest is organophosphate (OP), carbamate (CM) and/or pyrethroid/synthetic pyrethroid (SP) pesticide resistant. In other embodiments, the method for killing insect pests as listed hereinabove is not toxic to plants. In other embodiments, the method is not toxic to mammals. In other embodiments, the method is not toxic to birds. In other embodiments, the method is not toxic to animals. In other embodiments, the method is not toxic to humans. In other embodiments, the method is environmentally safe.

In various embodiments, this invention provides a method of killing pests comprising inhibiting carboxylesterase (CBE)—mediated organophosphate (OP), carbamate (CM), and/or pyrethroid/synthetic pyrethroid (SP) resistance in a pest, said method comprises contacting a boronic acid derivative according to this invention with said pest in combination with an OP, CM, and/or SP. In other embodiments, the CBE is any CBE within the alpha, beta or non-microsomal gene clusters as described in Oakeshott, Claudianos, Campbell, Newcomb and Russell, “Biochemical Genetic and Genomics of Insect Esterases”, pp 309-381, Chapter 10, Volume 5, 2005, Eds. Gilbert, Iatrou, Gill, published—Elsevier which is incorporated herein by reference. In other embodiments, the CBE is αE7 homologue. In other embodiments, the CBE is a wild-type or a mutated CBE or combination thereof. In other embodiments, the mutation in said mutated CBE is αE7 Gly137Asp. In other embodiments, the αE7 is LcαE7. In other embodiments, the CBE is equivalent mutation in a homologue of CBE. In other embodiments, the boronic acid derivative is an aryl boronic acid derivative as described herein above. In other embodiments, the boronic acid is a phenyl boronic acid derivative represented by formula I or II described herein above. In other embodiments, the boronic acid derivative is selected from compounds 1-8, PBA, 3.1-3.12, C2, C10 and C21 described herein above; each is a separate embodiment according to this invention.

In various embodiments, this invention provides a method of potentiation an OP, CM and/or SP pesticide comprising contacting a boronic acid derivative according to this invention with a pest: before, after or simultaneously with contacting the OP, CM and/or SP pesticide with the pest.

The most important feature of CBE mediated resistance is the high OP binding affinity. The boronic acid derivatives according to this invention, are ˜100-fold higher affinity compared to OPs, thereby allow overcoming the resistance of insects to OP.

In various embodiments, this invention provides a method of killing organophosphate (OP), carbamate (CM) and/or synthetic pyrethroid (SP) pesticide resistance pest, comprising inhibiting CBE in said pest, by contacting a boronic acid derivative of this invention with the insect, before, after or simultaneously with contacting the OP, CM and/or SP pesticide with the pest. In other embodiments, the boronic acid derivative is covalently attached to the CBE. In other embodiments, the boronic acid derivative is selected from compounds 1-8, PBA, 3.1-3.12, C2, C10 and C21 described herein above; each is a separate embodiment according to this invention. In other embodiments, the CBE is αE7. In other embodiments, the CBE is αE7 homologue. In other embodiments, the αE7 is wild-type αE7 (or homologue thereof), mutated αE7 (or homologue thereof) or combination thereof. In other embodiments, the mutation in said mutated αE7 is Gly137Asp or equivalent mutation in a homologue of αE7. In other embodiments, the αE7 is LcαE7.

In other embodiments, the methods described hereinabove (each method is a separate embodiment), are not toxic to plants. In other embodiments, the methods are not toxic to mammals. In other embodiments, the methods are not toxic to rodents. In other embodiments, the methods are not toxic to birds. In other embodiments, the methods are not toxic to animals. In other embodiments, the methods are not toxic to humans. In other embodiments, the methods are environmentally safe.

According to the invention described herein, picomolar boronic acid inhibitors of LcαE7 were rapidly identified, structure-activity relationships that assisted inhibitor optimization were obtained, and it was demonstrated that the compounds eliminated OP insecticide resistance in an important agricultural pest. Perhaps the most important feature of CBE mediated resistance is the high OP binding affinity. Resistance was overcame by developing inhibitors that are 100-fold higher affinity compared to OPs, using selective and relatively mild boronic acid scaffolds.

Insecticides remain the primary measure for control of agricultural pests, such as the sheep blowfly, as well as disease vectors, such as mosquitoes. The constant evolution of pesticide resistance in almost all species makes the development of new approaches to prevent or abolish resistance of great importance. While there is hope for the development of new pesticides, there are a finite number of biochemical targets and the use of synergists to knock out the resistance mechanisms and restore the effectiveness of OP insecticides is a viable alternative strategy. In this work, CBEs, which have been associated with over 50 cases of pesticide resistance over the last 50 years, were targeted. The observation that a Gly>Asp mutation at an equivalent position to 137 in other insect pests, and the relatively high sequence conservation of metabolic insect CBEs, suggests that the synergists such as those developed herein could have broad spectrum activity against a range of insect species. An added benefit of boronic acid derivatives synergists is the potential protection from the evolution of resistance. Since boronic acid derivatives are transition state analogues for the phosphorylation of the catalytic serine by OP insecticides, mutations that hinder boronic acid derivatives binding will also likely disrupt OP sequestration and/or hydrolysis.

The potent and selective CBE inhibitors reported herein represent a milestone in the use of virtual screening for inhibitor discovery in the context of combating pesticide resistance. High affinity boronic acid based inhibitors of a key resistance enzyme were identified, and understanding of the general structure-activity relationships that underlie the effectiveness of boronic acid derivatives with serine hydrolases was developed, facilitating inhibitor optimization. The demonstration that the compounds effectively abolished OP insecticide resistance in L. cuprina, without significant toxicity on their own or significant inhibition of human enzymes, establishes the viability of this synergist-focused approach to combat pesticide resistance and restore the effectiveness of existing pesticide classes. The substantial increase in insecticide efficacy would allow more sustainable pesticide usage and reduce off-target environmental and health-related pesticide effects.

The following examples are presented in order to more fully illustrate the preferred embodiments of the invention. They should in no way be construed, however, as limiting the broad scope of the invention.

### EXAMPLES

### Example 1

### Virtual Screen of Boronic Acid Compounds

A computational design of potent and selective covalent inhibitors of αE7 was carried out using DOCKovalent. DOCKovalent is a general method for screening large virtual libraries for the discovery of specific covalent inhibitors (London, N. et al. Covalent docking of large libraries for the discovery of chemical probes. Nat. Chem. Biol. 10, 1066-72 (2014) and London, N. et al. Covalent docking predicts substrates for haloalkanoate dehalogenase superfamily phosphatases. Biochemistry 54, 528-537 (2015).). DOCKovalent was used to screen a library of 23,000 boronic acids against the crystal structure of LcαE7 (coordinates correspond to protein data bank (www.rcsb.org; PDB) code 4FNG). Given as input a structural model of the protein target with a nucleophilic residue, and a library of small molecule electrophilic ligands, this protocol exhaustively samples all ligand conformations with respect to a covalent bond to the target nucleophile. Ligand conformations are scored using a physics-based scoring function, which evaluates the ligand's van der Waals and electrostatic interactions with the protein target, and corrects for ligand desolvation (Mysinger, M. M. & Shoichet, B. K. Rapid context-dependent ligand desolvation in molecular docking. Chem. Inf. Model. 50, 1561-73 (2010).). DOCKovalent was applied to the crystal structure of LcαE7 to search for new covalent inhibitors of insecticide target.

LcαE7 catalyzes the hydrolysis of fatty acid substrates via the canonical serine hydrolase mechanism. Boronic acids are known to form reversible covalent adducts to the catalytic serine of serine hydrolases, which mimic the geometry of the transition state for carboxylester hydrolysis and therefore bind with high affinity. DOCKovalent, an algorithm for screening covalent inhibitors, was used to screen a library of 23,000 boronic acids against the crystal structure of LcαE7 (PDB code 4FNG).

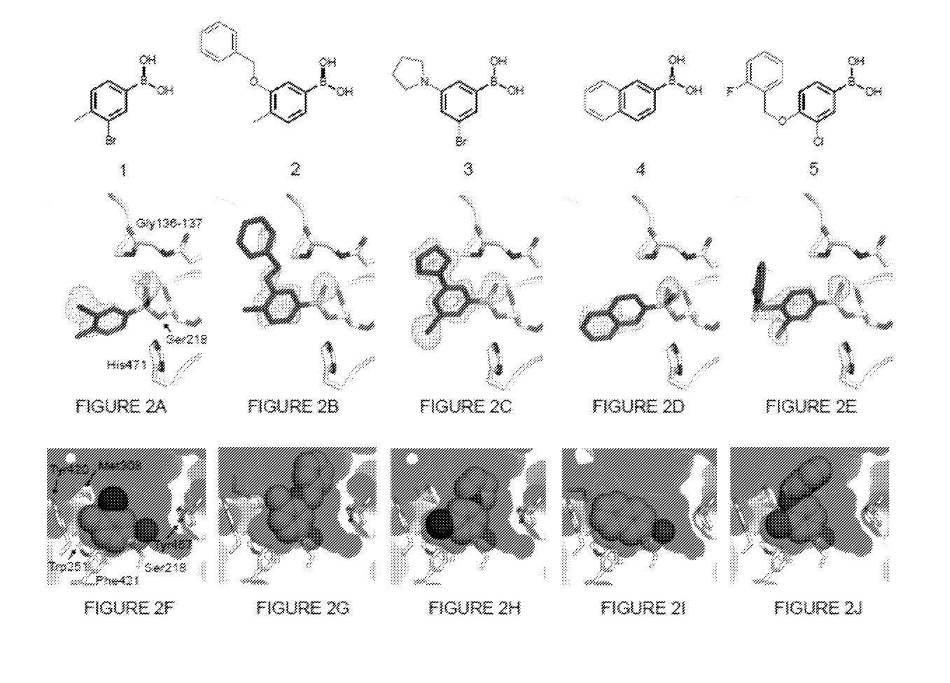

The tetrahedral adduct formed when a boronic acid coordinates to the catalytic serine is a putative transition state analogue for ester hydrolysis. Each boronic acid was modelled as a tetrahedral species covalently attached to the catalytic serine (Ser218). After applying the covalent docking protocol, the top 2% of the ranked library was manually examined, and five compounds ranked between 8 and 478 (FIG. 2A-J) were selected for testing on the basis of docking score, ligand efficiency, molecular diversity, correct representation of the molecule and internal strain (ligand internal energy is not part of the scoring function) (Compounds 1-5). Additionally, poses were selected in which either hydroxyl of the boronic acid was predicted to occupy the oxyanion hole).

### Experimental Details:

DOCKovalent is a covalent adaptation of DOCK3.6. Given a pre-generated set of ligand conformation and a covalent attachment point, it exhaustively samples ligand poses around the covalent bond and selects the lowest energy pose using a physics-based energy function that evaluates Van der Waals and electrostatics interactions as well as penalizes for ligand desolvation. For the docking performed in this work, a boronic acids library of 23,000 commercially available compounds, was used.

Receptor Preparation:

PDB code 4FNG was used for the docking. Ser218 was deprotonated to accommodate the covalent adduct and the Oγ partial charge was adjusted to represent a bonded form. His471 was represented in its doubly protonated form.

Docked Pose of Boronic Acids Used for Virtual Screen:

The boronic acid was covalently attached to the catalytic serine (Ser218). The catalytic histidine (His471) was represented in its doubly protonated form. The B—Oγ bond was set to 1.5±0.1 Å and the Cβ-Oγ-B bond angle was set to 116.0±5° and the Oγ-B—R bond angle was set to 109.5±5°. In the manual selection of compound for testing, preference was given to compounds where either of the boronic acid hydroxyls occupied the oxyanion hole (formed by the backbone nitrogens of Gly136, Gly137 and Ala219).

Candidate Selection:

the top 500 molecules from the ranked docking list, sorted by calculated ligand efficiency (docking score divided by number of heavy atoms) were manually inspected for exclusion criteria based on considerations that are orthogonal to the docking scoring function such as novelty of the compounds, diversity, commercial availability, correct representation of the molecule, internal strain (ligand internal energy is not part of the scoring function). Additionally, poses in which either of the boronic acid hydroxyls is predicted to occupy the oxyanion hole were selected.

### Example 2

### Potent and Selective Inhibitors of Wild-Type αE7

Wild-type LcαE7 was heterologously expressed in Escherichia coli and purified using metal ion affinity and size exclusion chromatography. The potency of the boronic acids was determined by enzymatic assays of recombinant LcαE7 with the model carboxylester substrate 4-nitrophenol butyrate. All five boronic acid compounds 1-5 exhibited Kᵢ values lower than 12 nM (Table 1), with the most potent compound (3) exhibiting a Kᵢ value of 250 pM. While the five compounds are diverse, they all share a phenylboronic acid (PBA) sub-structure, which inhibits LcαE7 with a Kᵢ value approximately 2-3 orders of magnitude lower than the designed compounds (210 nM). Compared to the nanomolar inhibition of LcαE7, PBA exhibits micromolar to millimolar inhibition of other serine hydrolases.

(e.g. α-lytic protease, (Kettner, C. a, et al. Kinetic properties of the binding of a-lytic protease to peptide boronic acids. Biochemistry 27, 7682-7688 (1988).). The 10- to 1000-fold lower Kᵢ values of the docked compounds (and the greater ligand efficiency), indicates that the phenylboronic substituents identified by the virtual screen are important for high affinity binding. Although αE7 is known to be a promiscuous enzyme (Correy, G. J. et al. Mapping the Accessible Conformational Landscape of an Insect Carboxylesterase Using Conformational Ensemble Analysis and Kinetic Crystallography. Structure 24, 1-11 (2016)), the potency of all compounds selected from the virtual screen suggests that the αE7 binding site is able to accommodate a structurally diverse set of compounds with little similarity to the enzyme's native substrate.

TABLE 1
Docking rank, in vitro LcαE7 inhibition and selectivity of compounds 1-5 and phenyl boronic acid (PBA).

| | | Kᵢ (nM) | | | | | | | | | | |
|---|---|---|---|---|---|---|---|---|---|---|---|---|
| | Dock | wildtype | | Gly137Asp | | | | | | | Viability IC₅₀ (μM) | |
| Comp. | rank | LcαE7 | | LcαE7 | | Ee AChE^{b} | | Trypsin^{b} | | AmpC | MDA-MB-231^{c} | HB-2^{c} |
| PBA | — | 210 | (270-260) | 450 | (370-550) | >10 | mM | — | | — | — | — |
| 1 | 8 | 12 | (9-16) | 49 | (42-56) | >1 | mM | >0.1 | mM | 216 | >100 | >100 |
| 2 | 169 | 2.9 | (2.2-3.8) | 29 | (27-32) | >0.3 | mM | >0.1 | mM | 380 | >100 | 20.5 |
| 3 | 202 | 0.25 | (0.22-0.28) | 110 | (97-130) | 0.27 | mM | >0.1 | mM | 60 | >100 | >100 |
| 4^{a} | 210 | 7.2 | (6.0-8.7) | 190 | (160-230) | >1 | mM | >10 | μM | 104 | >100 | >100 |
| 5 | 478 | 11 | (9-13) | 170 | (140-190) | >0.1 | mM | >0.1 | mM | 220 | >100 | 77.8 |

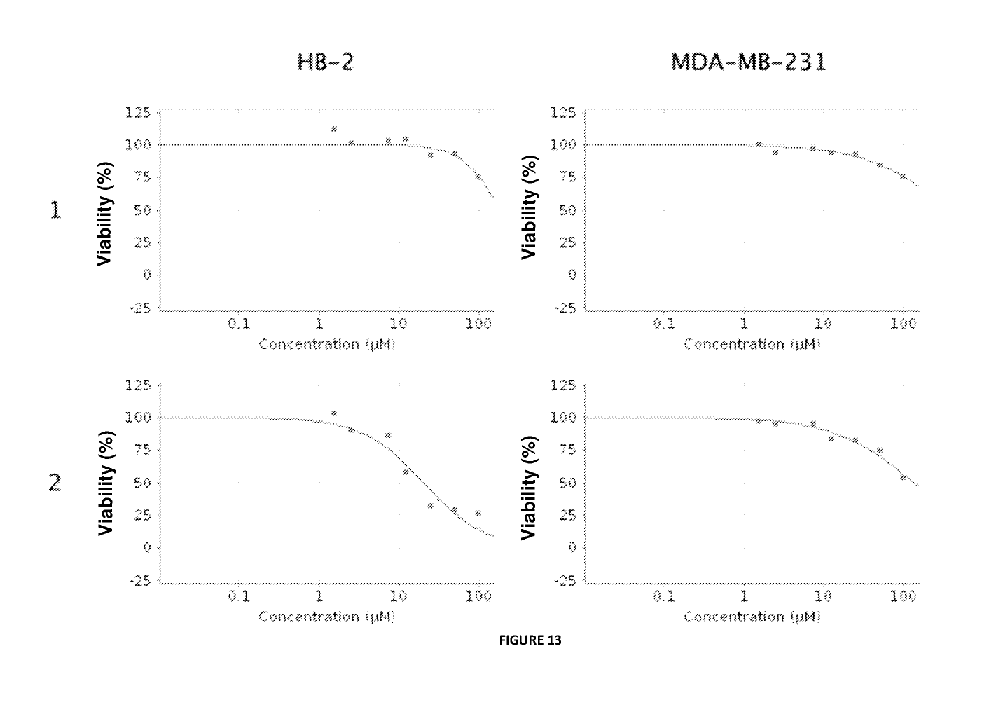

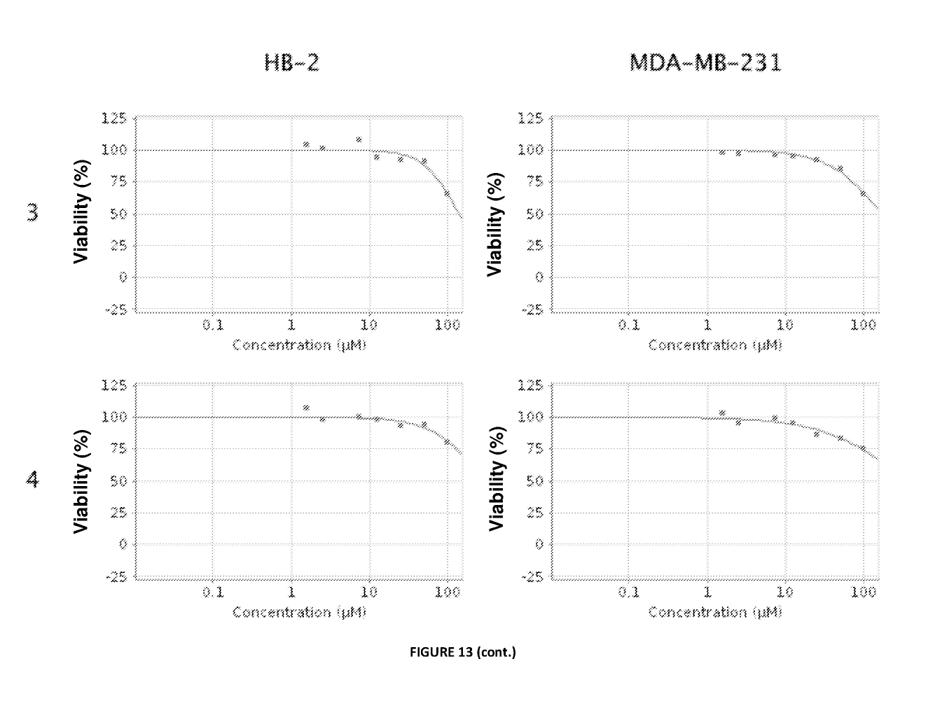

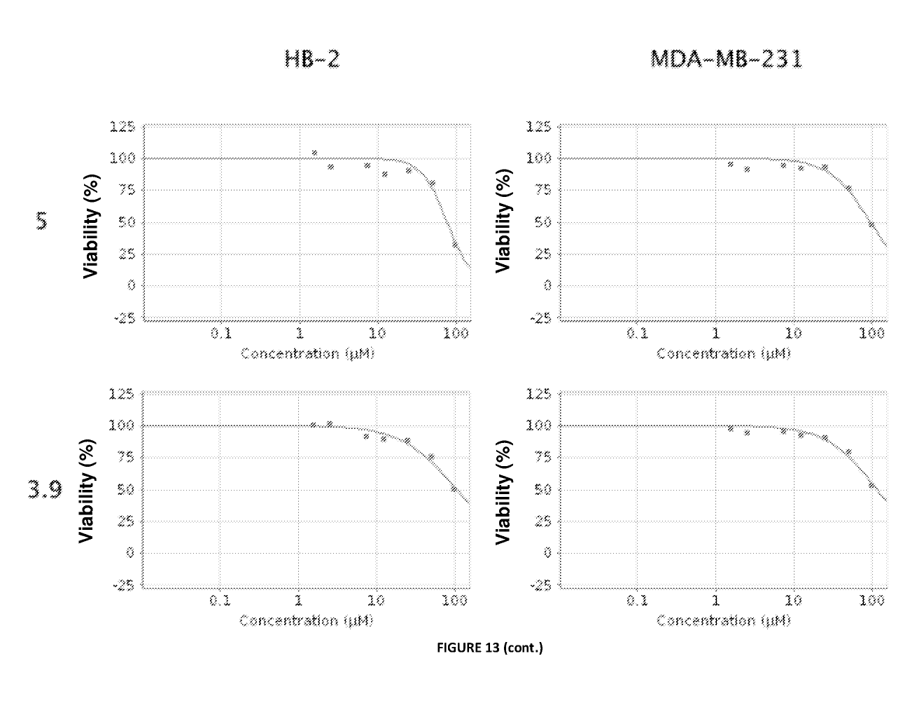

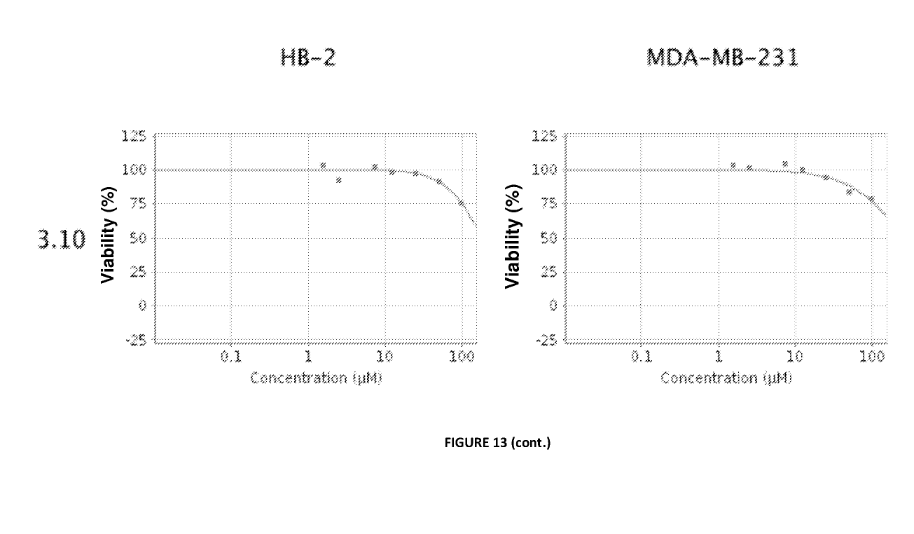

^{a}Values in brackets represent the 95% confidence interval in the Kᵢ. The Kᵢ was calculated according to the Cheng-Prusoff equation from a dose-response curve with three (technical) repeat measurements of enzyme activity at each concentration of compound.
^{b}Compounds were tested to their solubility limit..
^{c}Cell viability after 48 h incubation with the compounds was assessed using Cell Titer Glo. See FIG. 13 for complete dose response curves.

To characterize the selectivity of boronic acids 1 to 5, they were assayed against AChE, the target of OP and carbamate insecticides (Table 1) as well as trypsin and bacterial AmpC β-lactamase. None of the five compounds showed significant inhibition of AChE when tested up to their solubility limits (Table 1), with the most potent compound 3 displaying >10⁶ fold selectivity for LcαE7 over AChE. Compound 3 was further tested against a panel of 26 human serine or threonine proteases (Table 2 and 3). At a 100 μM compound concentration (10⁴-fold higher than the Kᵢ for LcαE7), only 3 of the 26 proteases were inhibited by more than 50% and even those had residual activity of at least 30%. The toxicity of the hits against two human cell lines was further assessed. None of the five compounds were toxic to MDA-MB-231 cells up to 100 μM, and only compounds 2 and 5 showed limited toxicity against HB-2 cells at relatively high concentrations (IC₅₀=20.5 μM and 77.8 μM respectively; Table 1 and FIG. 13). Overall, these data establish that the compounds are highly selective to their target with minimal off-target effects.

TABLE 2
Synergists are selective over human proteases.

| Protease | 3 ^{a} | 3.9 ^{a} | 3.10 ^{a} |
|---|---|---|---|
| DPP4 | 6 | 2 | −3 |
| DPP8 | 42 | 53 | 37 |
| DPP9 | 45 | 75 | 71 |
| Factor VII | 15 | 26 | 53 |
| Factor-Xa | 53 | 26 | 35 |
| Furin | 1 | −2 | −5 |
| GranzymeA | 12 | 23 | 12 |
| GranzymeB | 3 | 17 | 11 |
| GranzymeK | 5 | 14 | 3 |
| HTRA2 | 23 | 28 | 2 |
| Kallikrein11 | −71 | −148 | −43 |
| Kallikrein13 | 3 | −1 | 0 |
| Matriptase | −1 | 5 | 4 |
| Plasma-Kallikrein | 6 | 41 | 64 |
| Plasmin | 13 | 16 | −2 |
| Prolyl Oligopeptidase | 61 | 48 | 30 |
| PSMB5 | 3 | 34 | 2 |
| PSMB6 | 16 | 54 | 27 |
| PSMB7 | 39 | 70 | 48 |
| PSMB8 | 19 | 52 | 49 |
| PSMB9 | 12 | 50 | 15 |
| PSMB10 | 43 | 78 | 45 |
| Spinesin | 26 | 13 | 34 |
| Thrombin | 32 | 54 | 58 |
| tPA | 26 | 40 | 19 |
| uPA | 67 | 40 | 32 |

^{a} Average % inhibition of protease at 100 μM of the indicated boronic acid compound (n = 2).
Inhibition >50% is marked in red.

To characterize the selectivity of boronic acids 1 to 5, they were assayed against the target of OP insecticides, AChE, as well as trypsin and bacterial AmpC β-lactamase (Table 1). AChE and αE7 are homologous, sharing the α/β-hydrolase fold and the same catalytic machinery, however the topology of their binding pockets is dissimilar (Jackson, C. J. et al. Structure and function of an insect α-carboxylesterase (αEsterase7) associated with insecticide resistance. Proc. Natl. Acad. Sci. U.S.A. 110, 10177-82 (2013) and Correy, G. J. et al. Mapping the Accessible Conformational Landscape of an Insect Carboxylesterase Using Conformational Ensemble Analysis and Kinetic Crystallography. Structure 24, 1-11 (2016).). Both trypsin and AmpC β-lactamase contain an activated serine nucleophile and oxyanion hole, however trypsin contains a serine-histidine-aspartic acid (Hedstrom, L. Serine protease mechanism and specificity. Chem. Rev. 102, 4501-4523 (2002).) while AmpC β-lactamase contains a serine-tyrosine-lysine catalytic triad (Dubus, A., et al. The roles of residues Tyr150, Glu272, and His314 in class C β-lactamases. Proteins Struct. Funct. Genet. 25, 473-485 (1996).). While the boronic acids were poor inhibitors of AChE and trypsin, they exhibited nanomolar inhibition of AmpC μ-lactamase (Table 1). This relatively high affinity binding may reflect the exposed nature of the AmpC μ-lactamase catalytic triad compared to AChE and Trypsin, and the generally potent inhibition of activated serine nucleophiles by boronic acids. Despite this cross reactivity, compound 3 exhibited 240-fold selectivity for αE7 over AmpC β-lactamase, and more than 10⁶-fold selectivity over AChE or trypsin.

### Experimental Details:

### Enzyme Expression and Purification

His₆-tagged proteins were expressed in BL21(DE3) E. coli (Invitrogen) at 26° C. for 18 hours. Cells were collected by centrifugation, resuspended in lysis buffer (300 mM NaCl, 10 mM imidazole, 50 mM HEPES pH 7.5) and lysed by sonication. Cell debris was pelleted by centrifugation and the soluble fraction was loaded onto a HisTrap-HP Ni-Sepharose column (GE Healthcare). Bound protein was eluted with lysis buffer supplemented with 300 mM imidazole. Fractions containing the eluted protein were concentrated with a 30 kDa molecular mass cutoff centrifuge concentrator (Amicon) and loaded onto a HiLoad 26/60 Superdex-200 size-exclusion column (GE Healthcare) pre-equilibrated with 150 mM NaCl, 20 mM HEPES pH 7.5. Eluted fractions containing the monomeric protein were pooled for enzyme inhibition assays or crystallization. Protein concentration was determined by measuring the absorbance at 280 nm with an extinction coefficient calculated using the Protparam online server (Gasteiger, E. et al. Protein identification and analysis tools on the ExPASy server. Proteomics Protoc. Handb. 571-607 (2005). doi:10.1385/1-59259-890-0:571).

### Enzyme Inhibition Assays

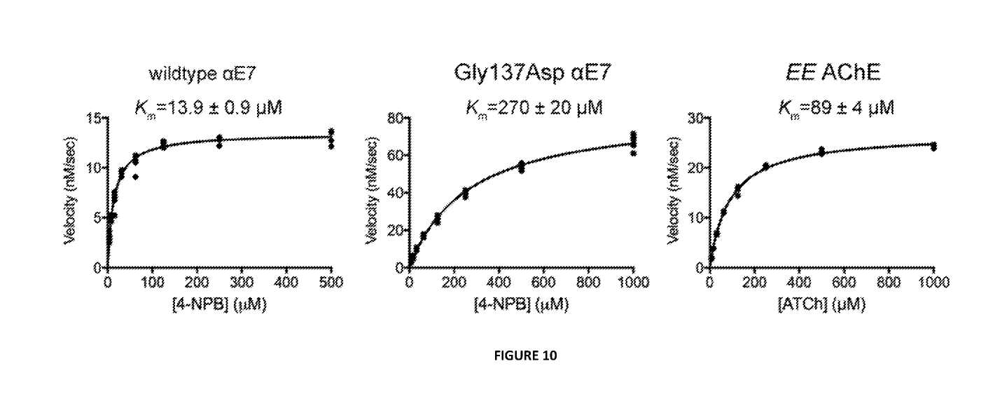

Inhibition of wild-type αE7 and the Gly137Asp αE7 variant was determined by a competition assay between the native-substrate analogue 4-nitrophenol butyrate (Sigma) and the boronic acid compounds. Initially, the Michalis constant (K_{M}) with 4-nitrophenol butyrate was measured for both enzymes to determine an appropriate concentration of substrate for use in the competition assays. Formation of the 4-nitrophenolate product of hydrolysis was monitored at 405 nm in the presence of enzyme and eight different concentrations of substrate. 4-nitrophenol butyrate was prepared in methanol to 100 mM and serially diluted 1-in-2 to achieve concentrations from 100 mM to 0.8 mM. Enzyme stocks were prepared in 4 mg/ml bovine serum albumin (Sigma) to maintain enzyme stability. Reactions were prepared by pipetting 178 μl assay buffer (100 mM NaCl, 20 mM HEPES pH 7.5) and 2 μl substrate (final concentrations of 1000 to 8 μM) into 300 μl wells of a 96-well plate. The reaction was initiated by the addition of 20 μl enzyme (final concentration 2.5 nM for wildtype αE7 and 4 nM for Gly137Asp αE7). Product formation was monitored for four minutes at room temperature using an Epoch microplate spectrophotometer (BioTek) and the initial rates of ester hydrolysis were determined by linear regression using GraphPad Prism. The Michalis constant was determined by fitting the initial rates to the Michalis-Menton equation (FIG. 10).

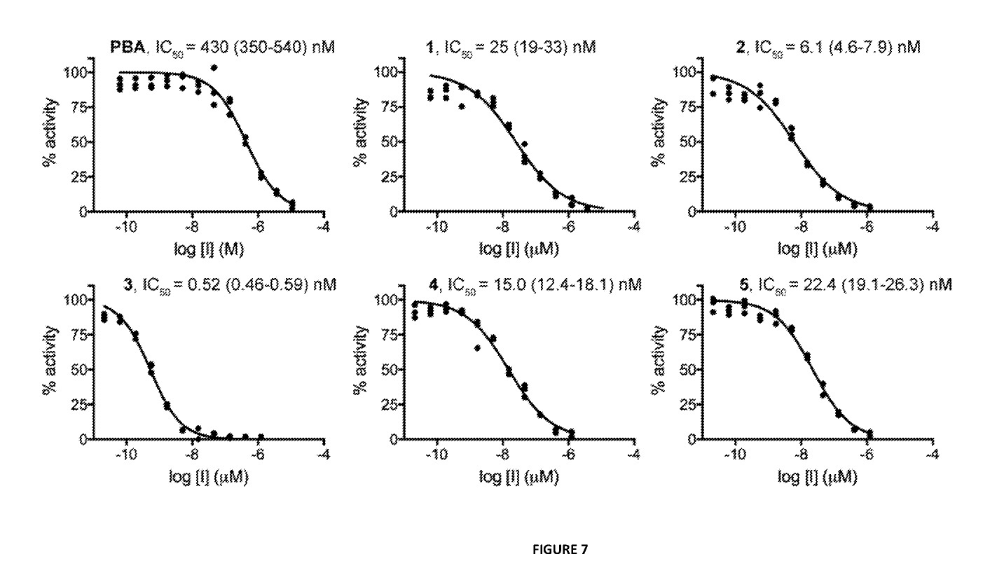

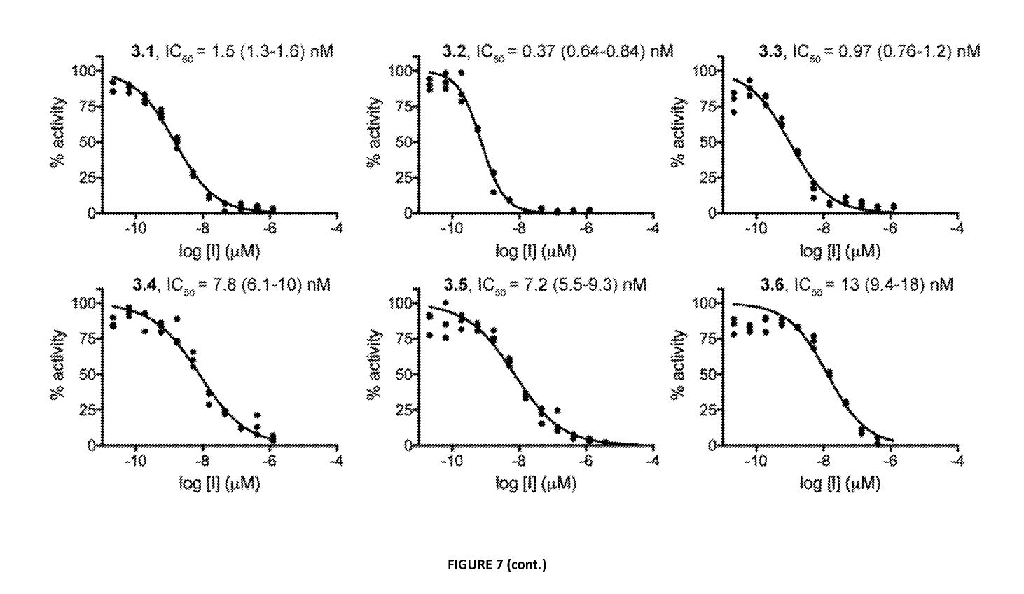

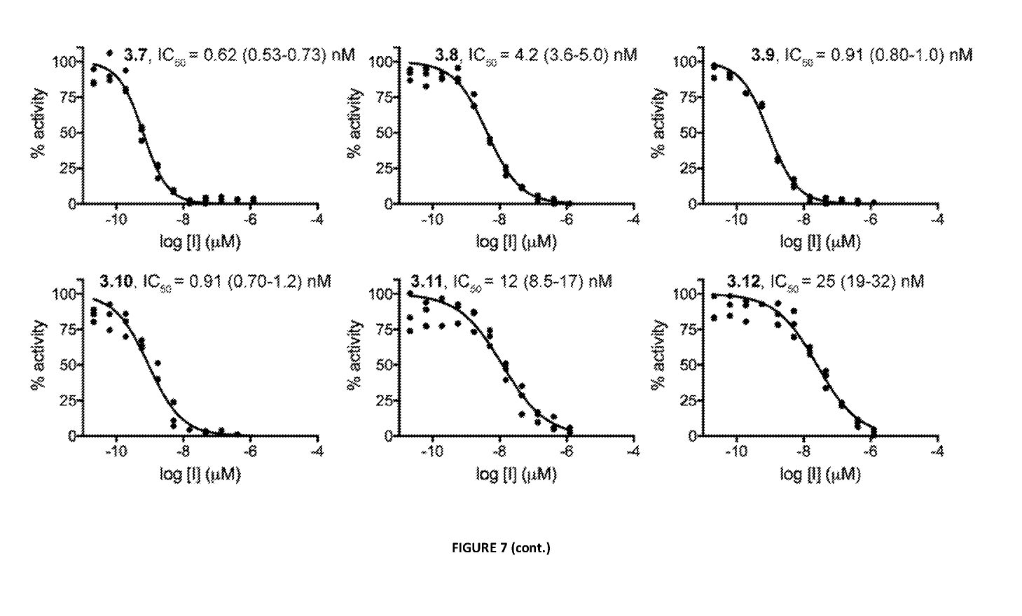

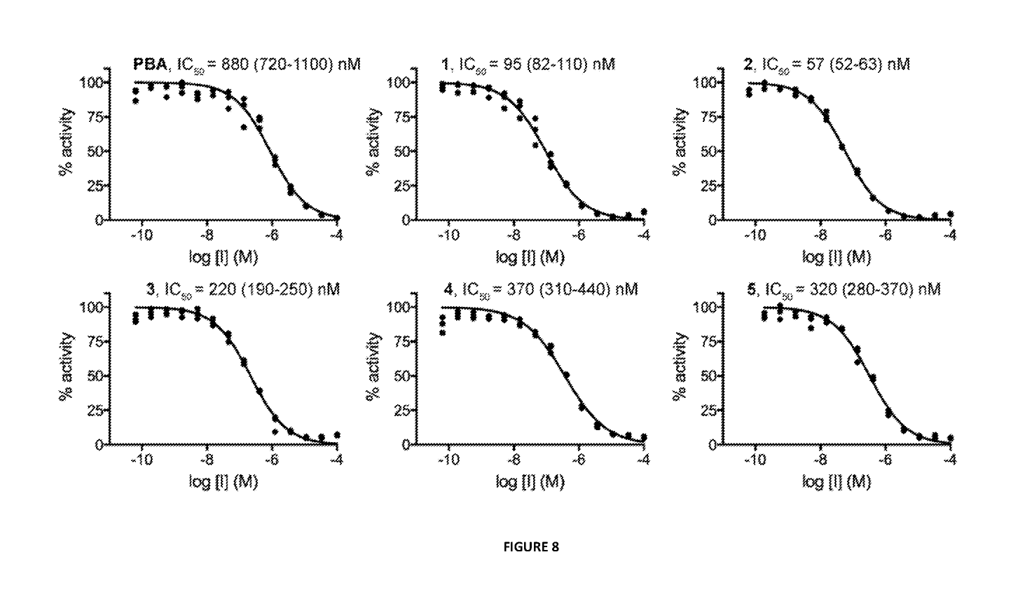

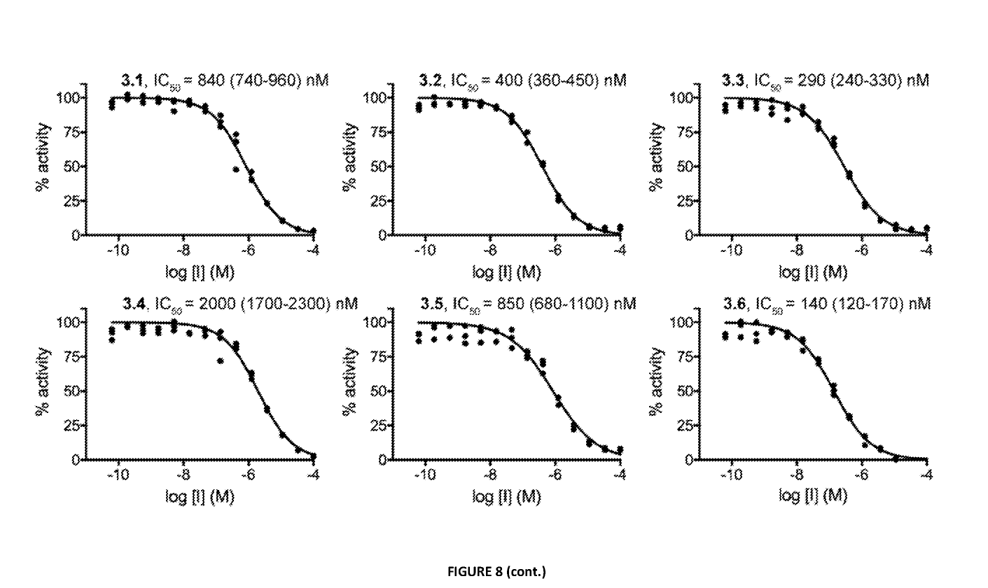

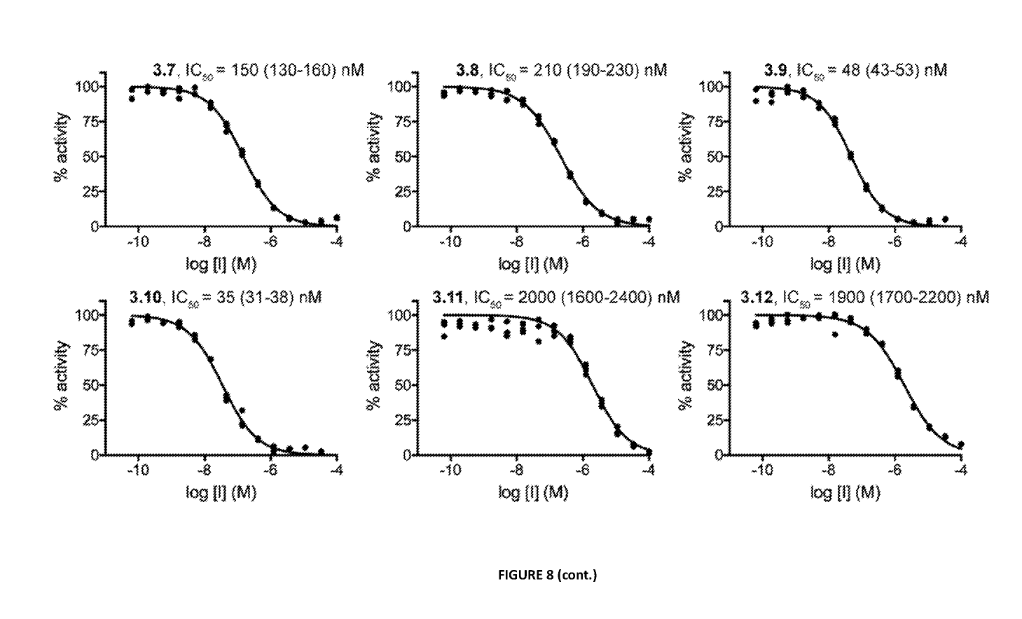

Enzyme inhibition with the boronic acid compounds was determined by assaying the initial rate of 4-nitrophenol butyrate hydrolysis in the presence of either neat DMSO or the boronic acid compounds in DMSO. Compounds were prepared by serially diluting 1-in-3 an initial 10 mM stock to achieve concentrations from 10 mM to 2 nM. Reactions were prepared by pipetting 178 μl assay buffer supplemented with substrate to a final concentration equal to the K_{M} of the enzyme (15 μM for wildtype αE7 and 250 μM for Gly137Asp αE7) into wells of a 96-well plate. 2 μl neat DMSO or 2 μl serially diluted inhibitor (final concentrations of 100 μM to 20 pM) were added to the wells. The reaction was initiated by the addition of 20 μl enzyme (final concentration 0.5 nM for wildtype αE7 and 10 nM for Glyl37Asp αE7). Product formation was monitored for four minutes at room temperature and the initial rates of ester hydrolysis were determined by linear regression. To determine the concentration of boronic acid compounds required to inhibit 50% of esterase activity (IC₅₀), a four-parameter sigmoidal dose-response curve was fitted to percentage inhibition using GraphPad Prism (FIGS. 7 and 8). Kᵢ values were determined using the Cheng-Prusoff equation assuming competitive inhibition (Yung-Chi, C. & Prusoff W. H. Relationship between the inhibition constant (KI) and the concentration of inhibitor which causes 50 percent inhibition (150) of an enzymatic reaction. Biochem. Pharmacol. 22, 3099-3108 (1973)).

### AChE Selectivity

Inhibition of Electrophorus electricus AChE (Type V-S, Sigma) by phenylboronic acid and compounds 1-5 was determined using the method described by Ellman et. al. (A new and rapid colorimetric determination of acetylcholinesterase activity. Biochem. Pharmacol. 7, 88-95 (1961)). Initially, the K_{M} for AChE with the substrate acetylthiocholine was determined by monitoring thiocholine production with 5,5′-dithiobis(2-nitrobenzoic acid) (DTNB) at 412 nm. Acetylthiocholine was prepared in assay buffer (100 mM NaH₂PO₄ pH 7.4) to 10 mM and serially diluted 1-in-2 to achieve concentrations from 10 mM to 0.08 mM while AChE was prepared in 20 mM NaH₂PO₄ pH 7.0 supplemented with 4 mg/ml BSA to 0.4 nM. Reactions were prepared by pipetting 160 μl assay buffer (supplemented with DTNB to a final concentration of 300 μM) and 20 μl acetylthiocholine (1000 to 7.8 μM final concentration) into wells of a 96-well plate. The reaction was initiated by the addition of 20 μl AChE (40 pM final concentration). Product formation was monitored for six minutes at room temperature and the initial rates of thioester hydrolysis were determined by linear regression using GraphPad Prism. The Michalis constant was determined as before (FIG. 10).

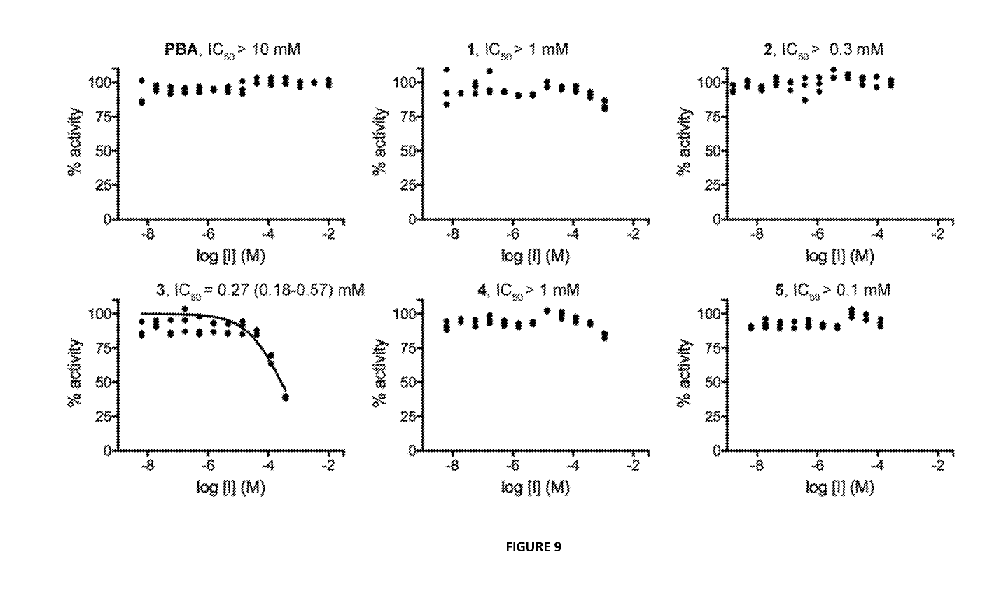

AChE inhibition was determined by assaying the initial rate of acetylthiocholine hydrolysis in the presence of either neat DMSO or the boronic acid compounds in DMSO. Compounds were prepared by making serial 1-in-3 dilutions of 1 M stocks to achieve concentrations from 1 M to 627 nM. Reactions were prepared by pipetting 178 μl assay buffer supplemented with acetylthiocholine (to a final concentration of 100 μM) and DTBN (to a final concentration of 300 μM) into wells of a 96-well plate. 2 μl neat DMSO or 2 μl serially diluted inhibitor (final concentrations of 100 mM to 6.27 nM) were added to the wells. The reaction was initiated by the addition of 20 μl enzyme (final concentration 40 pM). Product formation was monitored for six minutes at room temperature and the initial rates of thioester hydrolysis were determined by linear regression. IC₅₀ and Kᵢ values were determined as described previously (FIG. 9).

### Protease Selectivity Panel

Compounds were tested for inhibition of a panel of 26 Ser/Thr proteases at a single point concentration of 100 μM in duplicates by NanoSyn (Santa Clara, Calif.). See Table 3 for assay conditions. Test compounds were dissolved in 100% DMSO to make 10 mM stock. Final compound concentration in assay is 100 mM. Compounds were tested in duplicate wells at single concentration and the final concentration of DMSO in all assays was kept at 1%. Five reference compounds, AEBSF, Carfilzomib, Granzyme B Inhibitor II, Dec-RVKR-CMK, and Teneligliptin hydrobromide, were tested in an identical manner with 8 concentration points at 5× dilutions.

TABLE 3
Protease selectivity panel.

| | | | | | Incuba- |
|---|---|---|---|---|---|
| | | | | | tion |
| | | | [Enzyme], | | Time |
| Target | Vendor | Lot# | nM | Substrate | (hr) |
| DPP4 | ENZO | 2021206 | 0.369 | RPAGARK | 1.5 |
| DPP8 | ENZO | 2281220 | 0.5 | RPAGARK | 1.5 |
| DPP9 | ENZO | 7221432 | 0.3125 | RPAGARK | 1.5 |
| Factor VII^{a} | R&D Systems | NJX0716031 | 38.6 | BOC-VPA-AMC | 0.3 |
| Factor Xa | Calbiochem | B76791 | 20 | VMIAALPRTMFIQRR | 5 |
| Furin | R&D Systems | INK025061 | 16 | LRRVKRSLDDA | 6 |
| Granzyme A | ENZO | 11061411 | 30 | PRTLTAKK | 5 |
| Granzyme B | ENZO | 9161556 | 0.493 | IEPDSGGKRK | 5 |
| Granzyme K | ENZO | L27095 | 40 | RPAGARK | 5 |
| HTRA2 | R&D Systems | HVL1015111 | 76.1 | Casein Fluoroscein | 3 |
| Kallikrein 11^{b} | R&D Systems | MZV0116081 | 0.032 | BOC-VPA-AMC | 3 |
| Kallikrein 13^{c} | R&D Systems | NXS0117021 | 8.9 | BOC-VPA-AMC | 0.2 |
| Matriptase | R&D Systems | PZZ0916101 | 0.3134 | BOC-QAR-AMC | 0.5 |
| Plasma- | R&D Systems | NVH0111081 | 1.5 | ARDIYAASFFRK | 1 |
| Kallikrein | | | | | |
| Plasmin^{d} | R&D Systems | MQB0411091 | 2 | KHPFHLVIHTKR | 2 |
| Prolyl | R&D Systems | QBQ0212011 | 0.1 | VMIAALPRTMFIQRR | 2 |
| Oligo- | | | | | |
| peptidase | | | | | |
| PSMB5 | BOSTON- | 21118515B | 0.8 | TYETFKSIMKKSPF | 1.75 |
| | BIOCHEM | | | | |
| PSMB6 | BOSTON- | 21118515B | 1 | GLTNIKTEEISEVNLDAEFRKKRR | 3.75 |
| | BIOCHEM | | | | |
| PSMB7 | BOSTON- | 21118515B | 0.24 | GRSRSRSRSR | 2 |
| | BIOCHEM | | | | |
| PSMB8 | BOSTON- | 04720017A | 0.8 | TYETFKSIMKKSPF | 4.5 |
| | BIOCHEM | | | | |
| PSMB9 | BOSTON- | 04720017A | 1 | GLTNIKTEEISEVNLDAEFRKKRR | 3.75 |
| | BIOCHEM | | | | |
| PSMB10 | BOSTON- | 04720017A | 2 | GRSRSRSRSR | 2 |
| | BIOCHEM | | | | |
| Spinesin^{b} | R&D Systems | NOS031701A | 8.721 | BOC-QAR-AMC | 0.5 |
| Thrombin | R&D Systems | HWO0413121 | 1 | PRTLTAKK | 1.5 |
| tPA | R&D Systems | DATN0212041 | 9 | VMIAALPRTMFIQRR | 6 |
| uPA | R&D Systems | HKY0112041 | 6.5 | ADFVRAARR | 3 |

^{a}Cascade assay where enzyme was first activated by Thermolysin and then Factor III.
^{b}Cascade assay where enzyme was activated by Thermolysin.
^{c}Cascade assay where enzyme was activated by Lysyl Endopeptidase.
^{d}Cascade assay where enzyme was activated by 0.04× of uPA.

### Cellular Toxicity Assays

A seven-point, two-fold dose response series, with a 100 uM as the upper limit and a DMSO-only control point was generated using an Echo 550 liquid handler (Labcyte Inc.) in 384-well plates. Subsequently, the human breast cell lines MDA-MB-231 (tumorigenic) and HB2 (non-tumorigenic) were seeded (1000 cells/well) using a multi-drop Combi (Thermo Fisher Scientific) on top of the compounds. Plates were then incubated at 37° C. and 5% CO2 for 48 hours upon which cell viability was assessed by adding CellTiter-Glo® (Promega) to the reaction. The luminescence signal was measured on a Pherastar FS multi-mode plate reader (BMG Labtech).

### Example 3

### Docking Pose Validation

The co-crystal structures of boronic acids 1 to 5 with LcαE7 was solved in order to assess the binding poses predicted by DOCKovalent (FIG. 2). The co-crystal structures were solved with αE7-4a, a variant of αE7 which crystallizes (Jackson, C. J. et al. Structure and function of an insect α-carboxylesterase (αEsterase7) associated with insecticide resistance. Proc. Natl. Acad. Sci. U.S.A. 110, 10177-82 (2013) and Fraser, N. J. et al. Evolution of Protein Quaternary Structure in Response to Selective Pressure for Increased Thermostability. J. Mol. Biol. 428, 2359 2371 (2015).). Difference electron density maps of the active site calculated prior to ligand placement shows the boronic acid compounds covalently bound to the catalytic serine (FIG. 2). The orientation of the proximal aromatic ring is conserved across all five compounds, indicating that the binding pocket topology enforces a conserved binding mode despite the structural diversity of the compounds. The boronic acids all occupy the larger of the two LcαE7 binding pocket subsites, which accommodates a fatty acid chain of the predicted native lipid substrate²⁷. The distal rings of compounds 2, 3 and 5 are projected toward the funnel that leads to the active site. Both the binding pocket and funnel are lined with hydrophobic residues; the topology of the larger subsite is defined by Trp251, Phe355, Tyr420, Phe421, Met308 and Phe309. The fit of the boronic acids to the binding pocket varies with substitution pattern; the 3,5-disubstitution of compound 3 is highly complementary while the 3,4-disubstituted arrangement of the remaining compounds results in sub-optimal arrangement depending on relative substituent size (FIG. 2).

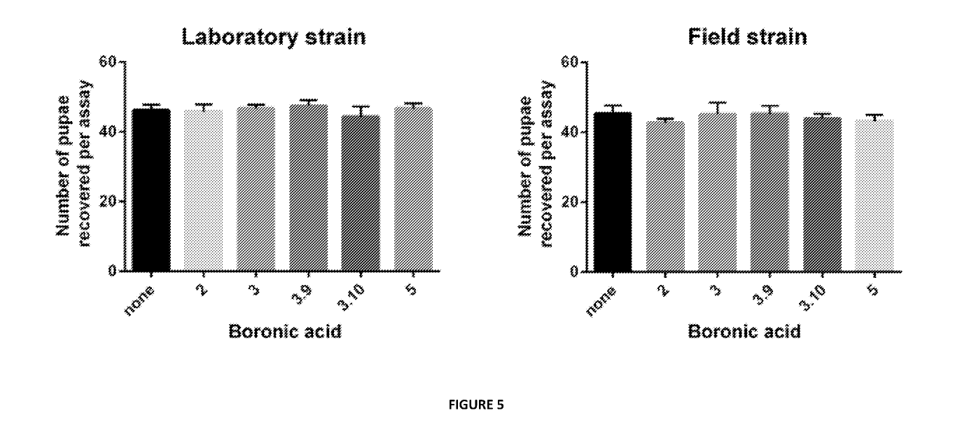

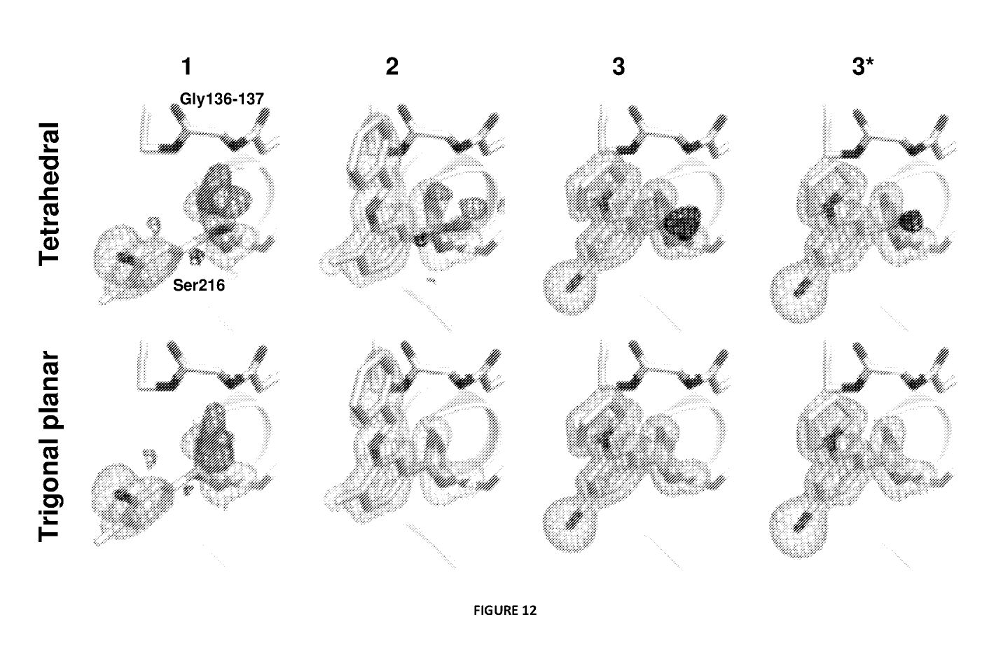

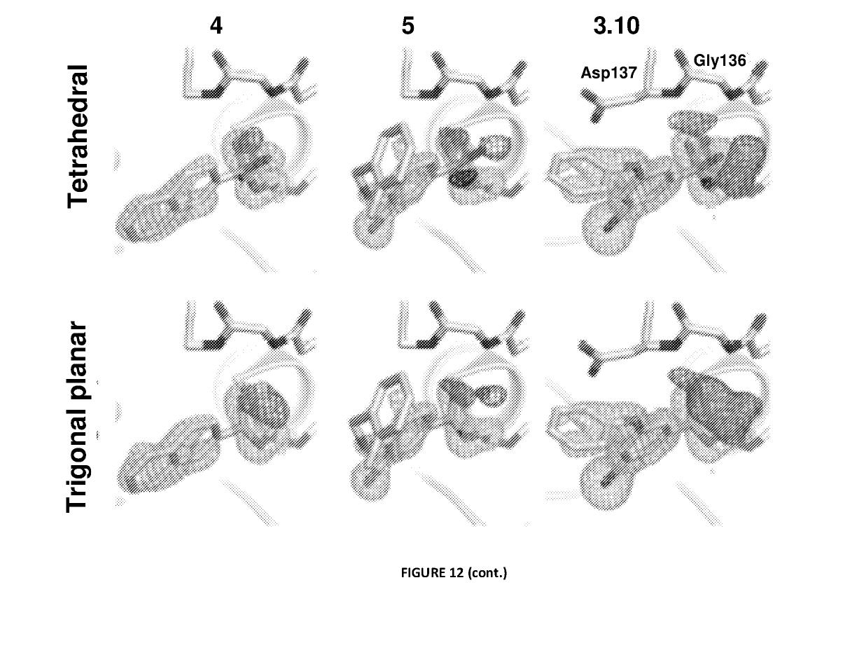

Alignment of the co-crystal structures with the apo LcαE7 structure shows minor structural rearrangement in the enzyme-inhibitor complexes. The geometry of the oxyanion hole, and hydrogen bonding within in the catalytic triad, is retained. Structural differences includes a shift in the orientation of the Tyr457 sidechain, which occludes the smaller subsite of the LcαE7 binding pocket, and has previously been noted to occur upon OP binding. (Correy, G. J. et al. Mapping the Accessible Conformational Landscape of an Insect Carboxylesterase Using Conformational Ensemble Analysis and Kinetic Crystallography. Structure 24, 1-11 (2016)). The orientation of the Met308 side-chain is heterogeneous, with alternative conformations modelled in the co-crystal structures of 2, 3, 4 and 5. Interestingly, the coordination geometry of the boronic acids in the various crystal complexes varied between being either tetrahedral or trigonal planar (FIG. 4 and FIG. 12). Compounds 2 and 5 appear to be trigonal planar, while 1 and 4 were best modelled as tetrahedral adducts. The difference in geometry reflects the two possible coordination states of boronic acids; either tetrahedral with two hydroxides or trigonal planar with one hydroxide (FIG. 4). The trigonal planar geometry enabled more favorable hydrogen bonding to the oxyanion hole; on average the hydrogen bonding distance was 2.7 Å for trigonal planar species versus 3.0 Å for the tetrahedral species.

### Example 4

### Crystalization of LcαE7-4a with Surface Mutations

To determine whether the internal mutations present in the variant of αE7 used for crystallization had an effect on inhibitor binding, the LcαE7-4a surface mutations were introduced into the wildtype gene and tested for crystallization. Two mutations (Lys530Glu and Asp83Ala) were sufficient to allow crystallization, likely through the introduction of an intermolecular salt bridge (Lys530Glu) and removal of a charge at a crystal packing interface (Asp83Ala). Comparison of the two structures indicates that the internal mutations have no observable effect on the binding of compound 3, with structural changes limited to a small change in the packing of Tyr420 and Phe421 as a result of the Ile419Phe mutation. This confirms that the binding poses captured in the co-crystal structures correspond to the binding poses in wild-type αE7. Difference electron density maps calculated with either the trigonal or tetrahedral boron species confirm that compound 3 coordinates as a trigonal planar species (FIG. 12).

### Experimental Details:

### Crystallization and Structure Determination

Co-crystals of compounds 1-5 with the thermostable LcαE7 variant (Jackson, C. J. et al. Structure and function of an insect α-carboxylesterase (αEsterase7) associated with insecticide resistance. Proc. Natl. Acad. Sci. U.S.A. 110, 10177-82 (2013) and Fraser, N J. et al. Evolution of Protein Quaternary Structure in Response to Selective Pressure for Increased Thermostability. J. Mol. Biol. 428, 2359-2371 (2015).) (LcαE7-4a) (PDB code 5TYP, 5TYO, 5TYN, 5TYL and 5TLK) and compound 3.10 with Glyl37Asp LcαE7-4a (PDB code 5TYM) were grown using the hanging drop vapor-diffusion method. Reservoir solutions contained 100 mM sodium acetate (pH 4.6-5.1) and 15-26% PEG 2000 monomethyl ether (MME) or PEG 550 MME. Inhibitors prepared in DMSO were incubated with protein (7 mg/ml in 75 mM NaCl and 10 mM HEPES pH 7.5) to achieve a 5:1 inhibitor-to-compound stoichiometric ratio. Hanging drops were set-up with 2 μl reservoir and 1 μl protein with crystals forming overnight at 19° C. For cryoprotection, crystals were briefly immersed in a solution containing the hanging-drop reservoir solution with the PEG concentration increased to 35%, and then vitrified at 100 K in a gaseous stream of nitrogen.

Diffraction data was collected at 100 K on either the MX1 or MX2 beam line at the Australian Synchrotron using a wavelength of 0.954 Å. Data was indexed, integrated and scaled using XDS (Kabsch, W. XDS. Acta Crystallogr. Sect. D Biol. Crystallogr. 66, 125-132 (2010).). High resolution data was excluded when the correlation coefficient between random half data sets (CC_{1/2}) (Karplus, P. A. & Diederichs, K. Linking crystallographic model and data quality. Science 336, 1030-3 (2012) and Diederichs, K. & Karplus, P. A. Better models by discarding data? Acta Crystallogr. D. Biol. Crystallogr. 69, 1215-22 (2013).) decreased below 0.3 in the highest resolution shell. Phases were obtained by molecular replacement with the program Phaser (McCoy, A. J. et al. Phaser crystallographic software. J. Appl. Crystallogr. 40, 658-674 (2007)) using the coordinates of apo-LcαE7-4a (PDB code 5CH3) as the search model. The initial model was improved by iterative model building with COOT (Emsley, P., Lohkamp, B., Scott, W. G. & Cowtan, K. Features and development of Coot. Acta Crystallogr. Sect. D Biol. Crystallogr. 66, 486-501 (2010)) and refinement with phenix.refine (Afonine, P. A. et al. Towards automated crystallographic structure refinement with phenix.refine. Acta Crystallogr. Sect. D Biol. Crystallogr. 68, 352-367 (2012)). Inhibitor coordinates and restraints were generated with eLBOW (Adams, P. D. et al. PHENIX: A comprehensive Python-based system for macromolecular structure solution. Acta Crystallogr. Sect. D Biol. Crystallogr. 66, 213-221 (2010).

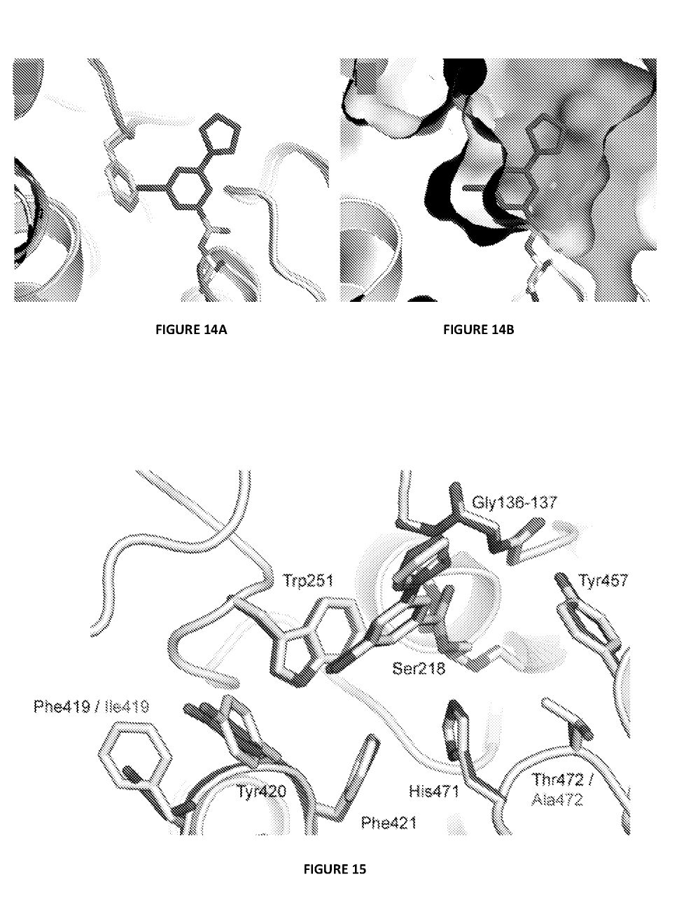

To determine if the mutations present in the thermostable LcαE7-4a influenced the orientation or mode of inhibitor binding, the surface mutations present in LcαE7-4a (Asp83Ala and Lys530Glu) were introduced into the wildtype background and the protein was tested for crystallization. Two mutations (Lys530Glu and Asp83Ala) were sufficient to allow crystallization in the same conditions as described previously (PDB code 5TYM) (FIG. 12 and FIG. 15).

### Example 5

### Potent Inhibitors of Gly137Asp αE7

The two most common CBE-mediated insecticide resistance mechanisms involve increased protein expression, or mutation to gain new catalytic (OP-hydrolase) functions. Compounds 1 to 5 were tested against the resistance associated Gly137Asp variant of LcαE7^{17,27} (Table 1). The Glyl37Asp mutation is located in the oxyanion hole and positions a new general base in the active site to catalyze dephosphorylation of the catalytic serine. Thus, compounds that inhibit WT LcαE7 as well as this common resistance associated Glyl37Asp variant would increase the efficacy of OPs by targeting both detoxification routes. Encouraged by the activity of the boronic acids 1 to 5, the compounds were tested against the Gly137Asp variant of LcαE7 (Table 1).

The most potent compound was 2, exhibiting a Kᵢ of 29 nM. The ratio of wildtype to Glyl37Asp Kᵢ value, normalized by the difference in PBA potency, indicates structural features which are tolerated by the Asp137 side chain (Table 1). The decreased affinity of all compounds for Glyl37Asp LcαE7 suggests that the Asp137 side chain is impeding binding. This is consistent with the higher affinity of both OP and carboxylester substrates for wild-type αE7 relative to Gly137Asp LcαE7²⁷. The tolerance of compounds 1 and 4 by Gly137Asp αE7 may reflect their relatively compact nature, while the flexible linker connecting the proximal and distal rings of compounds 2 and 5 may allow these compounds to avoid unfavorable interactions with the Asp137 side chain. The rigidity of the pyridinyl substituent of compound 3 may explain why this compound is a poor inhibitor of Gly137Asp LcαE7.

### Example 6

### Optimized Gly137Asp αE7 Inhibition

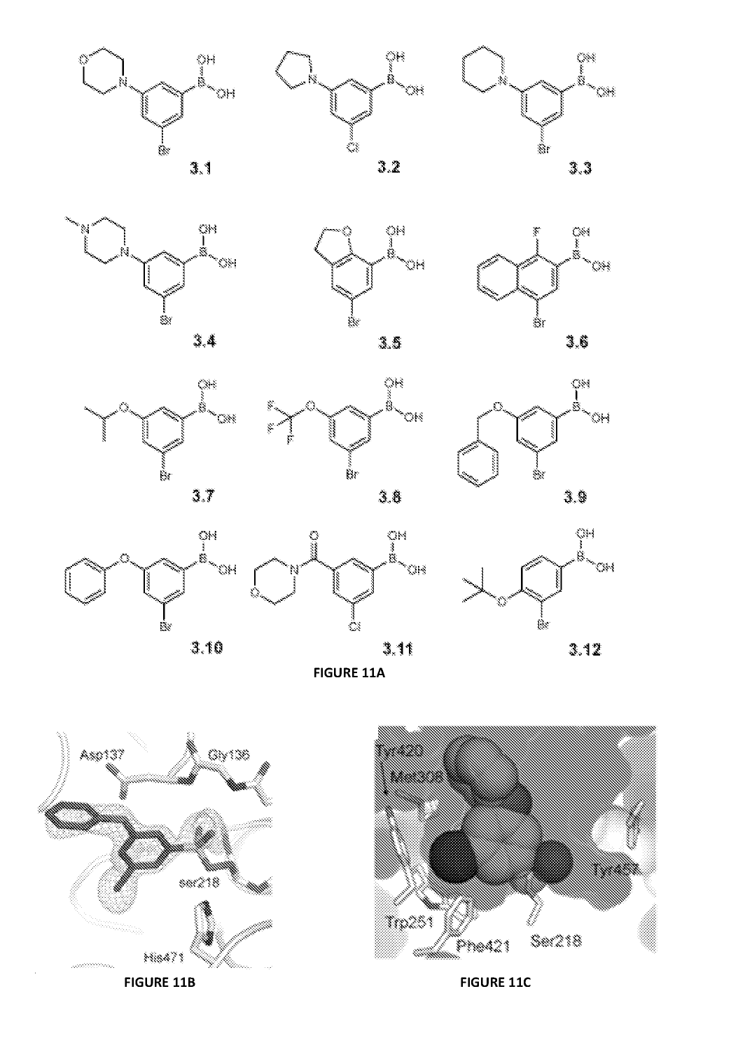

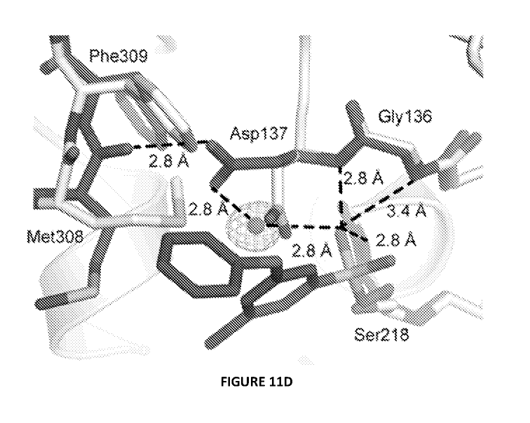

To improve Gly137Asp inhibition while maintaining good WT potency, the focus went to elaborating compound 3, the most potent WT inhibitor. It was predicted that combining the structural features tolerated by the Gly137Asp mutation (small or flexible substituents) with the 3,5-disubstitution pattern of compound 3 might improve inhibition of Gly137Asp LcαE7. To test this, 12 analogues of 3-bromo phenylboronic acid with the 3,5-disubstitution pattern of compound 3 were purchased (FIG. 11) and the Kᵢ values were determined for wild-type and Glyl37Asp LcαE7 (Table 4).

TABLE 4
In vitro activity of boronic acids 3.1-3.12
optimized for Gly137Asp LcαE7 inhibition.

| | Ki (nM) | | |
|---|---|---|---|
| Compound | | wildtype LcαE7 | Gly137Asp LcαE7 |

| | | | | |
|---|---|---|---|---|
| 3.1 | 0.70 | (0.62-0.79) | 430 | (380-500) |
| 3.2 | 0.35 | (0.31-0.40) | 210 | (180-230) |
| 3.3 | 0.47 | (0.36-0.59) | 150 | (130-170) |
| 3.4 | 3.8 | (2.9-4.9) | 1000 | (900-1200) |
| 3.5 | 3.4 | (2.6-4.5) | 440 | (350-550) |
| 3.6 | 6 | (5-9) | 71 | (60-85) |
| 3.7 | 0.30 | (0.26-0.35) | 76 | (69-85) |
| 3.8 | 2.0 | (1.7-2.4) | 110 | (100-120) |
| 3.9 | 0.44 | (0.39-0.50) | 25 | (22-27) |
| 3.10 | 0.44 | (0.33-0.56) | 18 | (16-20) |
| 3.11 | 5.8 | (4.1-8.0) | 1000 | (800-1200) |
| 3.12 | 12 | (9.2-15) | 990 | (870-1100) |

^{a} Values in brackets represent the 95% confidence interval in the Ki. The Ki was calculated according to the Cheng-Prusoff equation from a dose-response curve with three (technical) replicate measurements of enzyme activity at each concentration of compound.

While a more potent inhibitor of wildtype LcαE7 was not found, six of the 12 analogs exhibited picomolar Kᵢ values (Table 2). This establishes a stable structure-activity relationship between the 3,5-disubstituted phenylboronic acid and high affinity wild-type LcαE7 binding. Importantly, analogs 3.9 and 3.10, which possess the 3,5-disubstitution pattern and flexible linkers, exhibited a 4.4- and 6.1-fold improvement in inhibition of the Glyl37Asp LcαE7 respectively, compared to compound 3. The results indicate that a phenyl group connected via a flexible linker confers the highest affinity binding to Gly137Asp αE7, while still retaining high affinity binding to wildtype LcαE7. Both optimized compounds 3.9 and 3.10 do not exhibit any cellular toxicity up to 100 μM (FIG. 13), nor potent inhibition across the panel of 26 human proteases (Table 2).

To investigate the binding of the most potent inhibitor of Glyl37Asp LcαE7, compound 3.10, the co-crystal structure was solved to 1.75 Å. mF_{O}-DF_{C} difference density prior to ligand placement shows the boronic acid covalently bound to the catalytic serine (FIG. 11). The orientation of 3.10 is conserved compared to 3, with the 3-bromo substituent located in the larger binding pocket subsite, and the 5-methoxy-phenol orientated toward the binding pocket funnel (FIG. 11). To accommodate the covalently bound inhibitor, the sidechains of Asp137 and Met308 adopt new, alternative conformations. While the new Asp137 conformation allows compound 3.10 to bind, the resulting steric clash with the adjacent Phe309 forces this side-chain to adopt a new buried conformation (FIG. 11). The relative positions of the Asp137 and Phe309 side-chains suggests that the Phe309 side-chain must attain the buried conformation prior to the Asp137 side-chain adopting the new rotamer. Hence the binding of boronic acid 3.10 exploits a pre-existing network of dynamic coupled residues within the αE7 active site.

Although both the Phe309 and Met308 side-chains rotate away from the oxyanion hole, the overall effect is that the 308-309 backbone shifts closer to the oxyanion hole (FIG. 11). A hydrogen bond is formed between the Asp137 carboxylate and the Met308 backbone oxygen (FIG. 11), and a network of hydrogen bonds connects one of the boronic acid hydroxyls to the Asp137 carboxylate via a water molecule. Difference density in the active-site (FIG. 12) indicates that the geometry around the boron is tetrahedral, however, unlike compounds 1 and 4, whose hydroxyl is positioned almost equidistant from the three backbone nitrogens of the oxyanion hole, the hydroxyl of compound 3.10 is not in hydrogen bonding range of the Gly136 backbone nitrogen (3.4 Å).

### Example 7

### In Vivo Screen

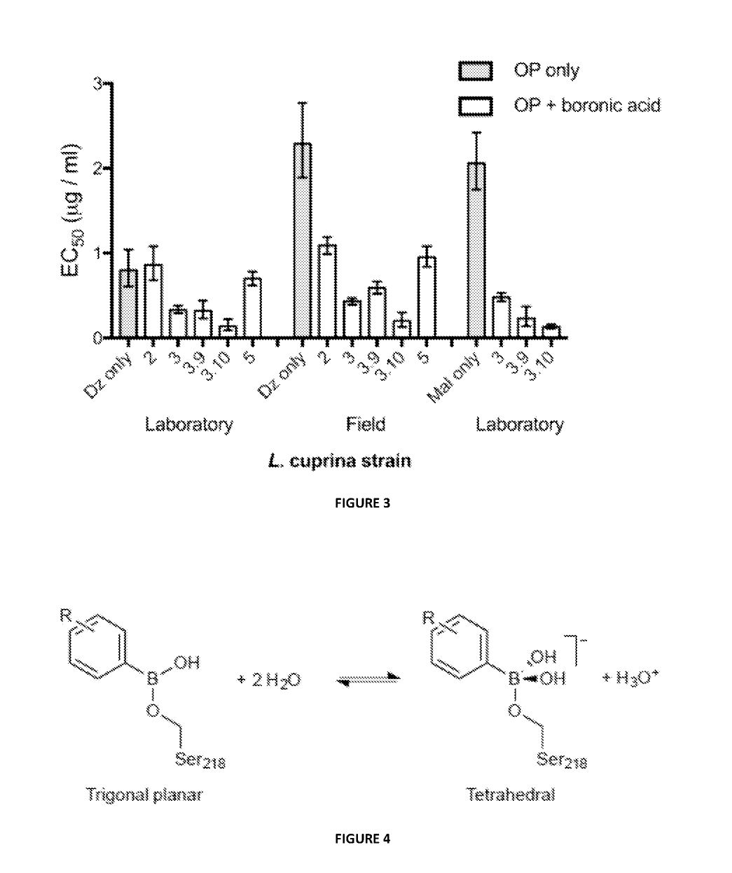

It was investigated whether the boronic acid compounds could inhibit the activity of LcαE7 in vivo, thereby acting as synergists to restore the effectiveness of OP insecticides. Compounds were initially tested against L. cuprina strains both susceptible and resistant to the OP insecticide diazinon (FIG. 3 and Table 5).

TABLE 5
Effects of boronic acid inhibitors on sensitivity
of blowfly larvae to diazinon.

| | | Diazinon dose response | | | |
|---|---|---|---|---|---|
| Blowfly | | EC₅₀^{b} | | | |
| strain | Drug treatment^{a} | (μg/assay) | 95% CI | SR^{c} | RR^{d} |
| Laboratory | Dz alone | 0.80 | 0.61-1.04 | — | — |
| (LS) | | | | | |
| | Dz plus 2 | 0.86 | 0.68-1.08 | 0.9 | — |
| | Dz plus 3 | 0.33 * | 0.29-0.38 | 2.4 | — |
| | Dz plus 3.9 | 0.32 * | 0.23-0.44 | 2.5 | — |
| | Dz plus 3.10 | 0.14 * | 0.09-0.22 | 5.7 | |
| | Dz plus 5 | 0.70 | 0.62-0.78 | 1.1 | — |
| Field (Tara) | Dz alone | 2.29 | 1.89-2.77 | | 2.86 ^{#} |
| | Dz plus 2 | 1.09 * | 0.99-1.19 | 2.1 | 1.36 |
| | Dz plus 3 | 0.43 * | 0.39-0.47 | 5.3 | 0.54 ^{#} |
| | Dz plus 3.9 | 0.59 * | 0.52-0.67 | 3.9 | 0.74 |
| | Dz plus 3.10 | 0.20 * | 0.13-0.30 | 11.5 | 0.25 ^{#} |
| | Dz plus 5 | 0.95 * | 0.84-1.08 | 2.4 | 1.19 |
| Laboratory | Mal alone | 2.06 | 1.75-2.42 | — | — |
| (LS) | | | | | |
| | Mal plus 3 | 0.48 * | 0.43-0.53 | 4.3 | — |
| | Mal plus 3.9 | 0.23 * | 014-0.37 | 9.0 | — |
| | Mal plus 3.10 | 0.13 * | 0.11-0.16 | 16 | — |

^{a}Diazinon (Dz) and malathion (Mal) examined at a range of concentrations in the presence or absence of boronic acid at constant concentration of 1 mg/assay
^{b}* indicates that, within a blowfly strain, EC₅₀ for Dz/Mal plus boronic acid is significantly different from EC₅₀ for Dz/Mal alone (based on overlap of 95% CIs)
^{c}SR = synergism ratio = EC₅₀ for Dz/Mal alone/EC₅₀ for Dz/Mal plus boronic acid, within a blowfly strain
^{d}RR = resistance ratio = EC₅₀ for Dz alone or Dz plus boronic acid with the field strain/EC₅₀ for Dz alone for the laboratory strain;
^{#} indicates that the field strain value is significantly different to the laboratory strain value (based on overlap of 95% CIs).

Inhibitor efficacy was determined by treating larvae with diazinon over a range of concentrations, in the presence or absence of the compounds at constant concentrations, and comparing pupation rates. Compounds 2, 3, 3.9, 3.10 and 5 were selected for testing based on high potency against wildtype and/or Glyl37Asp LcαE7, and their structural diversity. In assays of the susceptible strain, synergism was observed for compounds 3, 3.9 and 3.10. Compound 3.1 was the most potent, decreasing the amount of diazinon required to achieve a 50% reduction in pupation (EC₅₀ value) reduced by 5.7-fold compared to a diazinon only control (FIG. 3). These picomolar inhibitors were able to outcompete diazinon for LcαE7 binding, thereby rescuing OP anti-cholinesterase activity. This highlights the protective effect of wild-type LcαE7 against OP insecticides. No synergism was observed for compounds 2 and 5, suggesting that despite low nanomolar inhibition, these compounds were unable to outcompete diazinon for αE7 binding. The observed differences in the levels of synergism for compounds 3, 3.9 and 3.10 could be related to differences in the bioavailability of the compounds, since their in vitro potency is very similar.

To confirm that the observed synergism was due to LcαE7 inhibition, and not toxic side-effects of the boronic acid compounds, the compounds were tested in the absence of diazinon (FIG. 5). There was no significant difference between the fly pupation rates in the presence or absence of the boronic acids compounds. This is consistent with in vitro tests showing that these compounds have low (mM) affinity for AChE (Table 1), the low cellular toxicity data presented herein below, and the known low toxicity of boronic acids (Hall, D. G. in Boronic Acids (2005).).

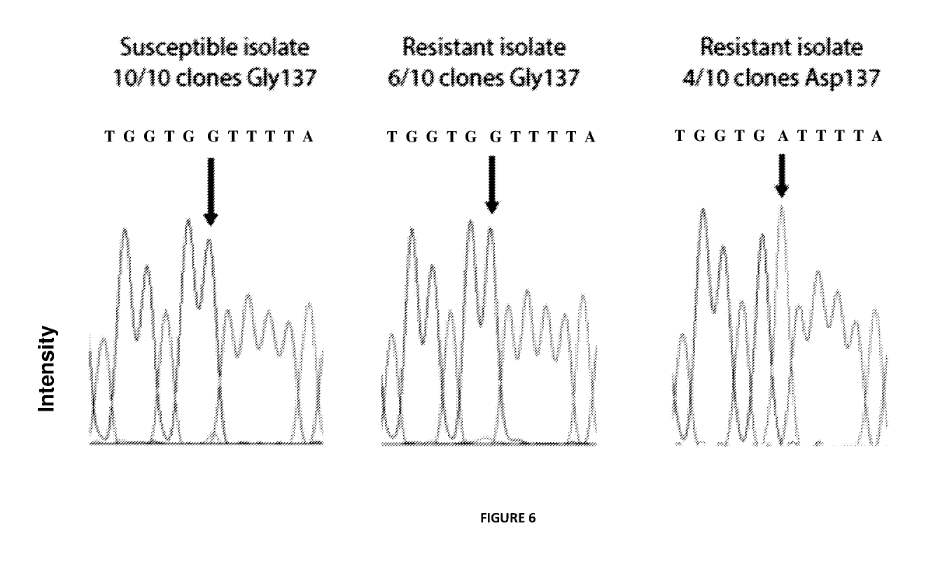

Having demonstrated synergism between the boronic acids and an OP insecticide, the compounds were tested against a field strain of L. cuprina resistant to diazinon. Diazinon resistance is typically associated with the Gly137Asp mutation/resistance allele. The genotype of the field strain used in the bioassays was determined, and it was found that, although the laboratory strain carried only WT susceptible alleles (Gly137), the field strain carried both susceptible (Gly137) and resistance (Asp137) alleles (FIG. 6). This is consistent with previous results showing that duplications of the chromosomal region containing αE7 have occurred, meaning that resistant strains now carry copies of both WT and Glyl37Asp LcαE7. In the absence of the boronic acids, the diazinon EC₅₀ for the field strain was 2.9-fold higher compared to the laboratory strain (FIG. 3). Synergism was observed for all the boronic acids tested with the most effective compound (3.10) reducing the EC₅₀ 12-fold compared to a diazinon only control (Table 5). Compound 3.10 therefore abolished OP resistance in the field strain of L. cuprina and rendered the field strain 4-fold more sensitive to diazinon compared to the laboratory strain (when treated with only diazinon).

Based on the in vitro enzyme inhibition profile (Table 1), the higher level of diazinon synergism in the field strain with compound 3 versus compound 2 was surprising. To investigate this discrepancy, multiple copies of each of the L. cuprina strains were sequenced, and it was found that, although the susceptible strain only contained wildtype αE7, the resistant strain carried an equal number of wildtype and gly137asp genes (FIG. 6). This discrepancy is consistent with the observation that contemporary resistant strains contain both wild type and Glyl37Asp alleles LcαE7²⁹; Specifically, a compound, such as 3.10, that effectively inhibits both LcαE7 variants would be the best synergist against a resistant strain. The synergism exhibited by compound 3.10 is therefore a function of the optimized Gly137Asp LcαE7 inhibition and retention of WT LcαE7 inhibition. This highlights the importance of both sequestration (via WT) and catalytic detoxification (via Gly137Asp) by LcαE7 in OP resistance.

The effects of compounds 3, 3.9 and 3.10 on the sensitivity of the laboratory strain to the OP insecticide malathion was tested. Sensitivity to malathion and diazinon is qualitatively different; WT LcαE7 confers a low level of resistance to diazinon via high affinity binding and slow hydrolysis, however WT LcαE7 displays significant malathion hydrolysis activity. This difference is evident in the similar EC₅₀ values for the laboratory L. cuprina strain treated with malathion compared to the field (resistant) strain treated with diazinon (FIG. 6). Synergism with malathion was observed for all the boronic acid compounds tested. Compound 3.10 was the most effective, reducing the EC₅₀ 16-fold compared to a malathion only control (FIG. 3 and Table 5).

The association between OP resistance and LcαE7 homologues from other insect pests suggests that the synergists developed here have potential for broad spectrum activity against CBE-mediated OP resistance.

Organophosphate insecticides are used worldwide; an estimated 9 million kilograms are applied annually in the United States alone. The in vivo results presented herein indicate that administration in combination with these or similar synergists may reduce OP use by more than an order of magnitude. Such a reduction, without compromising efficacy, could have enormous health environmental and economic consequences.

In summary, an initial screen of 23,000 boronic acids against the crystal structure of αE7 was implemented to identify inhibitors of LcαE7, which identified picomolar-to-nanomolar inhibitors of WT αE7. Improving the understanding of the structure-activity relationships underlying the interaction enabled inhibitor optimization, resulting in a potent and selective inhibitor of both WT and the resistance associated Gly137Asp enzymes. Bioassays of blowfly survival confirmed that the optimized inhibitor synergized with OP insecticides and abolished resistance. These compounds show no significant intrinsic toxicity to flies or human cell lines, as well as very high selectivity against a panel of 26 human serine/threonine proteases. They can overcome resistance to cheap and available insecticides, while lowering the overall amount of insecticide required by more than an order of magnitude. Such synergists could have major economic and environmental benefits. The general approach demonstrated in this work should be applicable to additional CBEs as a route to fight insecticide resistance.

### Experimental Details:

Lucilia cuprina Bioassays

Two strains of L. cuprina were used: 1) a laboratory reference drug-susceptible strain, LS, derived from collections in the Australian Capital Territory over 40 years ago, with no history of exposure to insecticides; and 2) a field-collected strain, Tara, resistant to diazinon and diflubenzuron (Levot, G. W. & Sales, N. New high level resistance to diflubenzuron detected in the Australian sheep blowfly, Lucilia cuprina (Wiedemann) (Diptera: Calliphoridae). Gen. Appl. Entomol. 31, 43-46 (2002)). The LcαE7 gene was sequenced in each of the strains. Briefly, genomic DNA was prepared from 20 adult female flies from each strain using the DNeasy Blood and Tissue kit (Qiagen). PCR was performed with primers specific to the LcαE7 gene, and the product was cloned into a pGEM-T EASY vector (Promega). Eight clones of the susceptible strain and 10 clones of the resistant strain were sequenced using M13 forward and reverse primers.

The effect of compounds 2, 3, 5, 3.9 and 3.10 on the development of blowfly larvae in the presence of diazinon/malathion was assessed using a bioassay system in which larvae were allowed to develop from the first instar stage until pupation on cotton wool impregnated with diazinon/malathion over a range of concentrations, in the presence or absence of the compounds at constant concentrations (Kotze, A. C. et al. Histone deacetylase enzymes as drug targets for the control of the sheep blowfly, Lucilia cuprina. Int. J. Parasitol. Drugs Drug Resist. 5, 201-208 (2015)). Each experiment utilized 50 larvae at each diazinon/malathion concentration. Experiments were replicated three times for diazinon, and twice for malathion. The insecticidal effects were defined by measuring the pupation rate. The pupation rate dose-response data were analyzed by non-linear regression (GraphPad Prism) in order to calculate EC₅₀ values (with 95% confidence intervals) representing the concentration of diazinon/malathion (alone or in combination with compounds 2, 3, 5, 3.9 or 3.10) required to reduce the pupation rate to 50% of that measured in control assays. The effects of compounds 2, 3, 5, 3.9 and 3.10 was defined in two ways: 1) synergism ratio within each isolate=the EC₅₀ for diazinon/malthion alone/EC₅₀ for diazinon/malthion in combination with the compounds; and 2) resistance ratio=the EC₅₀ for diazinon alone or in combination with the compounds for the Tara strain/EC₅₀ for diazinon alone with the LS strain. Significant differences between EC₅₀ values were assessed based on overlap of 95% confidence intervals. Compounds were also without diazinon or malathion at 1 mg per assay.

The association between OP resistance and LcαE7 homologues from other insect pests²⁰ suggests that the synergists described herein have potential for broad spectrum activity against CBE-mediated OP resistance.

### Example 8

### Biological Assessment of Chlorpyrifos-Ethyl (CPE) Combined with Boronic Acid Derivatives (BA) Towards Myzus persicae (Green Peach Aphid) on Small Broad Bean (Vicia faba)

The ability of Boronic acid derivatives (BA) to increase the efficacy of Chlorpyrifos-ethyl (CPE) organophosphate towards Myzus persicae (Green peach aphid) on small broad bean (Vicia faba) was investigated.

### Results:

TABLE 6
Percentage of efficacy of chlorpyrifos-ethyl conditions.

| | CPE 0.7 | CPE 1.4 | CPE 2.8 | CPE 5.6 |
|---|---|---|---|---|
| 1 DAT | 38% | 41% | 32% | 36% |
| 3 DAT | 20% | 27% | 26% | 48% |
| 7 DAT | 25% | 25% | 23% | 67% |
| | CPE 0.7 + | CPE 1.4 + | CPE 2.8 + | CPE 5.6 + |
| | 3.10 | 3.10 | 3.10 | 3.10 |
| 1 DAT | 38% | 24% | 59% | 71% |
| 3 DAT | 56% | 8% | 77% | 92% |
| 7 DAT | 66% | 24% | 94% | 100% |
| | CPE 0.7 + | CPE 1.4 + | CPE 2.8 + | CPE 5.6 + |
| | 5 | 5 | 5 | 5 |
| 1 DAT | 45% | 41% | 59% | 74% |
| 3 DAT | 34% | 38% | 84% | 98% |
| 7 DAT | 18% | 30% | 95% | 100% |
| | CPE 0.7 + | CPE 1.4 + | CPE 2.8 + | CPE 5.6 + |
| | 3.7 | 3.7 | 3.7 | 3.7 |
| 1 DAT | 34% | 39% | 48% | 79% |
| 3 DAT | 24% | 46% | 39% | 92% |
| 7 DAT | 27% | 38% | 63% | 100% |

TABLE 7
Calibration results.
Calibration results

| | CPE 1.4 | CPE 2.8 | CPE 5.6 |
|---|---|---|---|
| 1 DAT | 33% | 31% | 67% |
| 3 DAT | 51% | 79% | 98% |
| 7 DAT | 51% | 99% | 100% |

CPE: Chlorpyrifos-ethyl (Pyrinex 480 EC; 480 g a.i./L); Compound 3.10: 3-Bromo-5-phenoxyfenylboronic acid 98%; Compound 5: 3-Chloro-4(2′-fluorobenzyloxy) phenylboronic acid 95%; Compound 3.7: 3-Bromo-5-isopropoxyphenylboronic acid 95%

Flocculation is observed with Compound 5 alone and in mixture with CPE in all doses.

No significant toxicity of DMSO or of derivative Compounds 3.10, 5 or 3.7 was observed. (ANOVAs followed by Newman-Keuls tests with a threshold of 5%).

As shown in Table 6, the insecticidal efficacy of CPE used at 2.8 g a.i./ha (gram active ingredient per hectar) and 5.6 g a.i./ha was increased by the addition of both Compounds 3.10, 5 and 3.7.

### Experimental Details:

Experimentations was carried out in BIOtransfer, France under controlled conditions.

Bean leaves were treated with chlorpyrifos 480 EC (480 g a.i./1) at 4 application rates (360, 180, 90, 45 g a.i./ha), used alone or in combination with 3 boronic acid (BA) derivates (3.10, 5 and 3.7) each at 0.2 mg/ml. The treatment was performed with an agricultural nozzle (300 L per hectare) after infestation. A non-treated control condition were also evaluated in parallel. Statistical analysis of the data was then performed. When the leaves were totally dry, 3 leaves were sampled and infested with 3 wingless adults of M. persicae per leaf fragment.

### Assessment Timing:

T+1 (DAT 1)—One day later the number of adults remaining on the leaves was counted.
T+3 (DAT 3)—3 days after treatment the aphid population was estimated;
T+7 (DAT 7)—7 days after treatment the development of aphid population was estimated.

### Operating Procedure:

3 bean leaves fragments per microbox*4 microbox per condition (1 condition is 1 formulation at 1 dose)*9 adult aphids per microbox*4 insecticides (3 chlorpyrifos derivates+clorpyrifos alone)*4 rates+2 controls (1 reference insecticide formulation at one dose and non-treated)*3 assessments timings (DAT+1, DAT+3 and DAT+7).

### Example 9

### Biological Assessment of Chlorpyrifos-Ethyl (CPE) Combined with Boronic Acid Derivatives (BA) Towards Ostrinia nubilalis (European Corn Borer) on Selection of Corn Leaves (Zea may)

The ability of Boronic acid derivatives (BA) to increase the efficacy of Chlorpyrifos-ethyl (CPE) organophosphate towards Ostrinia nubilalis (European corn borer) on selection of Corn leaves (Zea may) was investigated.

### Experimental Details:

Treatments were performed by spraying a volume of mixture corresponding to 200 l/ha. 4 boxes/condition.

Conditions (Tested doses): CPE: chlorpyrifos-ethyl (Pyrinex 480 EC; 480 g a.i./L); Compound 3.10: 3-Bromo-5-phenoxyfenylboronic acid 98%; Compound 5: 3-Chloro-4(2′-fluorobenzyloxy) phenylboronic acid 95%; Compound 3.7: 3-Bromo-5-isopropoxyphenylboronic acid 95%; All boronic acid derivatives were dissolved in DMSO before dilution resulting in 1% DMSO final.

Drying 1 h at 20° C.; Deposit of three leaf fragments per box on water agar (4 box/condition); Infection of each leaf fragment with 4 Ostrinia nubilalis (12 larvae/box); Incubation 18° C./28° C. 16 h photoperiod; Living larvae were counted 1, 2 and 6 days after treatment (DAT). The percentage of mortality was calculated for each assessment times. Statistical analysis of the data was performed with XLSTAT® software (ANOVAs followed by Newman-Keuls tests with a threshold of 5%, see Table below).

TABLE 8
Experimental Conditions Summary.

| | |
|---|---|
| Treatment | Dose (g a.i./ha) |

| | |
|---|---|
| Control | Water |
| DMSO | 1% |

| | | | | | |
|---|---|---|---|---|---|
| 3.10 | (mg/ml) | 0.2 | 0.2 | 0.2 | 0.2 |
| 5 | (mg/ml) | 0.2 | 0.2 | 0.2 | 0.2 |
| 3.7 | (mg/ml) | 0.2 | 0.2 | 0.2 | 0.2 |

| | | | | |
|---|---|---|---|---|
| CPE | 2.5 | 6.24 | 15.6 | 39 |
| CPE | 2.5 | 6.24 | 15.6 | 39 |

| | | | | | |
|---|---|---|---|---|---|
| +3.10 | (mg/ml) | 0.2 | 0.2 | 0.2 | 0.2 |

| | | | | |
|---|---|---|---|---|
| CPE | 2.5 | 6.24 | 15.6 | 39 |

| | | | | | |
|---|---|---|---|---|---|
| +5 | (mg/ml) | 0.2 | 0.2 | 0.2 | 0.2 |

| | | | | |
|---|---|---|---|---|
| CPE | 2.5 | 6.24 | 15.6 | 39 |

| | | | | | |
|---|---|---|---|---|---|
| +3.7 | (mg/ml) | 0.2 | 0.2 | 0.2 | 0.2 |

### Results:

TABLE 9
Summary of efficacy results for BA + chlorpyrifos-ethyl treatment.

| | | Evaluation of Larvae number | | | | | | | | |
|---|---|---|---|---|---|---|---|---|---|---|
| | | 1 DAT | | | 3 DAT | | | 6 DAT | | |
| Treatment | Dose | Mean | s-d | N-K | Mean | s-d | N-K | Mean | s-d | N-K |
| Control | | 12 | 0 | A | 11.5 | 0.6 | A | 10.8 | 1.3 | A |
| DMSO | 1% | 12 | 0 | A | 11.8 | 0.5 | A | 10.8 | 0.5 | A |
| 3.1 | 0.2 mg/ml | 12 | 0 | A | 12 | 0 | A | 8.3 | 1.2 | ABC |
| 5 | 0.2 mg/ml | 12 | 0 | A | 12 | 0 | A | 10.3 | 1.2 | AB |
| 3.7 | 0.2 mg/ml | 11.7 | 0.6 | A | 11 | 1 | A | 8 | 1 | ABCD |
| CPE 2.5 | 2.5 g a.i./ha | 12 | 0 | A | 12 | 0 | A | 8 | 1 | ABCD |
| CPE 2.5 + | 2.5 g a.i./ha + | 11.8 | 0.6 | A | 11 | 0.6 | A | 5.3 | 1.5 | CDEF |
| 3.10 | 0.2 mg/ml | | | | | | | | | |
| CPE 2.5 + | 2.5 g a.i./ha + | 11.7 | 0.6 | A | 11.3 | 1.2 | A | 6.3 | 2.3 | BCDE |
| 5 | 0.2 mg/ml | | | | | | | | | |
| CPE 2.5 + | 2.5 g a.i./ha + | 11.8 | 0.5 | A | 10.3 | 0.5 | AB | 6 | 0.8 | ABCDE |
| 3.7 | 0.2 mg/ml | | | | | | | | | |
| CPE 6.24 | 6.24 g a.i./ha | 10.7 | 1.5 | A | 9.7 | 2.3 | ABC | 4 | 3.5 | CDEFGH |
| CPE 6.24 + | 6.24 g a.i./ha + | 12 | 0 | A | 11.7 | 0.6 | A | 3 | 3 | DEFGH |
| 3.10 | 0.2 mg/ml | | | | | | | | | |
| CPE 6.24 + | 6.24 g a.i./ha + | 11 | 2 | A | 9.3 | 2.5 | ABC | 7 | 2.2 | ABCD |
| 5 | 0.2 mg/ml | | | | | | | | | |
| CPE 6.24 + | 6.24 g a.i./ha + | 12 | 0 | A | 11 | 1.2 | A | 6.5 | 1.9 | ABCD |
| 3.7 | 0.2 mg/ml | | | | | | | | | |
| CPE 15.6 | 15.6 g a.i./ha | 7.3 | 3.1 | B | 7 | 3.2 | C | 3.5 | 2.4 | DEFGH |
| CPE 15.6 + | 15.6 g a.i./ha + | 8 | 0.8 | B | 8 | 0.8 | BC | 4.8 | 3.2 | CDEFG |
| 5 | 0.2 mg/ml | | | | | | | | | |
| CPE 15.6 + | 15.6 g a.i./ha + | 4 | 1 | C | 4 | 1 | D | 4 | 1 | CDEFGH |
| 3.10 | 0.2 mg/ml | | | | | | | | | |
| CPE 15.6 + | 15.6 g a.i./ha + | 2.3 | 0.5 | C | 1.8 | 1.3 | DE | 1 | 1.2 | GH |
| 3.7 | 0.2 mg/ml | | | | | | | | | |
| CPE 39 | 39 g a.i./ha | 3.3 | 2.5 | C | 2 | 1.7 | DE | 1.3 | 1.2 | FGH |
| CPE 39 + | 39 g a.i./ha + | 2.7 | 2.5 | C | 2 | 2 | DE | 1.7 | 1.5 | EFGH |
| 3.10 | 0.2 mg/ml | | | | | | | | | |
| CPE 39 + | 39 g a.i./ha + | 2.3 | 1.7 | C | 0.8 | 1 | E | 0.5 | 1 | H |
| 5 | 0.2 mg/ml | | | | | | | | | |
| CPE 39 + | 39 g a.i./ha + | 1.3 | 1 | C | 0.3 | 0.5 | E | 0.3 | 0.5 | H |
| 3.7 | 0.2 mg/ml | | | | | | | | | |

N-K: Newman-Keuls test results.
Two conditions with the same letter are not significantly different from each other.

TABLE 10
Summary of percentage of efficacy results for BA + CPE treatment

| Percentage | | | | |
|---|---|---|---|---|
| of efficacy | DMSO | 3.10 | 5 | 3.7 |
| 1 DAT | 0% | 0% | 0% | 3% |
| 3 DAT | 0% | 0% | 0% | 4% |
| 6 DAT | 0% | 22% | 4% | 26% |
| Percentage | | | | |
| of efficacy | CPE 2.5 | CPE 6.24 | CPE 15.6 | CPE 39 |
| 1 DAT | 0% | 11% | 40% | 72% |
| 3 DAT | 0% | 16% | 39% | 83% |
| 6 DAT | 26% | 63% | 67% | 88% |
| Percentage | CPE 2.5 + | CPE 6.24 + | CPE 15.6 + | CPE 39 + |
| of efficacy | 3.10 | 3.10 | 3.10 | 3.10 |
| 1 DAT | 2% | 0% | 67% | 78% |
| 3 DAT | 4% | 0% | 65% | 83% |
| 6 DAT | 51% | 72% | 63% | 84% |
| Percentage | CPE 2.5 + | CPE 6.24 + | CPE 15.6 + | CPE 39 + |
| of efficacy | 5 | 5 | 5 | 5 |
| 1 DAT | 3% | 8% | 33% | 81% |
| 3 DAT | 1% | 20% | 30% | 93% |
| 6 DAT | 41% | 35% | 56% | 95% |
| Percentage | CPE 2.5 + | CPE 6.24 + | CPE 15.6 + | CPE 39 + |
| of efficacy | 3.7 | 3.7 | 3.7 | 3.7 |
| 1 DAT | 2% | 0% | 81% | 90% |
| 3 DAT | 11% | 4% | 85% | 98% |
| 6 DAT | 44% | 40% | 91% | 98% |

### Conclusions:

Absence of toxicity of DMSO 1%. Absence of significant toxicity of Compounds 3.10, 5 and 3.7 despite some larvae death with Compounds 3.10 and 3.7 at 6 DAT. CPE with or without BA compounds are dose dependent and are significantly more efficient at 6 DAT when compared with control conditions at the exception of:

CPE used alone at 2.5 g a.i./ha.

CPE+compound 5 at 6.24 g a.i./ha.

CPE+compound 3.7 at 2.5 and 6.24 g a.i./ha.

The addition of Compound 3.10 increased significantly the efficacy when compared with CPE used alone at:

1 DAT and 3 DAT at the dose of 15.6 g a.i./ha.

The addition of compound 3.7 increased significantly the efficacy when compared with CPE used alone at:

1 DAT and 3 DAT at the dose of 15.6 g a.i./ha

### Example 10

### Biological Assessment of Chlorpyrifos-Ethyl (CPE) Combined with Boronic Acid Derivatives (BA) Towards Leptinotarsa decemlineata (Colorado Beetle) on Potato Leaves

The ability of Boronic acid derivatives (BA) to increase the efficacy of Chlorpyrifos-ethyl (CPE) organophosphate towards Leptinotarsa decemlineata (Colorado Beetle) on potato leaves is investigated.

### Experimental Details:

Experimentations is carried out in BIOtransfer, France under controlled conditions.

Potato leaves are treated with chlorpyrifos 480 EC (480 g a.i./1) at 4 application rates (360, 180, 90, 45 g a.i./ha), used alone or in combination with 3 boronic acid (BA) derivates (3.10, 5 and 3.7) each at 0.2 mg/ml. The treatment is performed with an agricultural nozzle (300 L per hectare) after infestation. A non-treated control condition and a reference insecticide are also evaluated in parallel. Statistical analysis of the data is then performed. When the leaves are totally dry, they are infested by six (6) larvae of Colorado Beetle. The Karate Zeon at 1 dose (1-2 g/ha) is justified by the high sensibility of the beetles in lab conditions. This dose is then compared to the registered field dose (7.5 g/ha).

### Assessment Timing:

Three observation timings, 1 day, 2 days and 3 days after treatment enables the evaluation of the number of living insects.

### Operating Procedure:

Potato leaves*6 larvae per test*3 repetitions (1 repetition is 1 formulation at 1 dose)*4 insecticides (3 chlorpyrifos derivates+clorpyrifos alone)*4 rates+2 controls (1 insecticide: Karate Zeon*1 rate+non-treated condition)*3 assessments timings (T+1, T+2 and T+3).

After full leaf drying, they are infested by six (6) larvae of Colorado Beetle. Three observation timings (1 day, 2 days and 3 days) permit the evaluation of the number of living insects.

The Karate Zeon at 1 dose (1-2 g/ha) is justified by the high sensibility of the beetles in lab conditions. This dose is then compared to the registered field dose (7.5 g/ha).

### Example 11

### Inhibition of Various CBEs by Compounds of the Invention

To prove the generality of the approach and of various compounds of the invention (3.7, 3, 5 and 2, C21, C10 and C2), their inhibition constants against a panel of CBEs from various pests was determined.

Compounds 3.7, 3, 5 and 2 were designed to inhibit Lucilia cuprina αE7. Compounds C21, C10 and C2 were designed to inhibit Culix quinquefasciatus B2.

### Results:

TABLE 11
Kᵢ values (in nanomolar) for boronic acid inhibitors against various insect CBEs.

| | Compound | | | | | | |
|---|---|---|---|---|---|---|---|
| | 2 | 3 | 3.7 | 5 | C2 | C10 | C21 |
| Stomoxys calcitrans | 8 | 3 | 14 | 20 | 270 | 3 | 2 |
| Musca domestica | 50 | <1 | <1 | 13 | 700 | 5 | 130 |
| Calliphora stygia | <1 | <1 | <1 | 2 | 210 | 40 | 9 |
| Cochliomyia hominivorax | <1 | <1 | <1 | 2 | 110 | 3 | 2 |
| Aedes aegypti | 3100 | 9900 | 2600 | 40000 | 37000 | 10 | 10000 |
| Anopheles gambiae | 170 | 790 | 330 | 30 | 420 | 80 | 200 |
| Culex quinquefasciatus | 2400 | 4700 | 900 | 420 | 3600 | 190 | 140 |

Assays were performed with 4-NPB as the substrate. Kᵢ values are presented as mean±SD, n=3; values lower than 1 nM are reported as <1 as these are at the detection limit.

Some compounds such as “5” showed a very broad spectrum efficiently inhibiting six different CBEs. Other boronic acids were more specific to a smaller subset of CBEs.

### Example 12

### Selectivity Panel for Compounds of the Invention

To further establish the safety and cell toxicity of compounds according to this invention, their IC₅₀ in killing a broad panel of human cell lines (including both cancerous and non-cancerous) cell lines was determined, and their cell toxicity was tested.

### Results:

TABLE 12
Cell toxicity data for seven boronic acid derivatives of the invention against seven cell lines.

| | 6543 IC₅₀ Viability Cells: IC₅₀ (μM) | | | | | | |
|---|---|---|---|---|---|---|---|
| | (Readout: Luminescence) | | | | | | |
| | Cell line: | Cell line: | Cell line: | Cell line: | Cell line: | Cell line: | Cell line: |
| Compound | Colo205 | H23 | 293T | HCT116 | Hela | HT29 | PC3 |
| 2 | 91.5 | >99.8 | 42.9 | 62.8 | 4 | 34.1 | 49.1 |
| 5 | 79.4 | 92.7 | 90.3 | 88.5 | 4.8 | 62.4 | 83.7 |
| 3.9 | >99.8 | 99.3 | >99.8 | >99.8 | 2.1 | 72.8 | >99.8 |
| 3 | >99.8 | >99.8 | >99.8 | >99.8 | 8.1 | >99.8 | >99.8 |
| 1 | >99.8 | >99.8 | >99.8 | >99.8 | 37.9 | >99.8 | >99.8 |
| 3.1 | >99.8 | >99.8 | N.A. | >99.8 | >99.8 | >99.8 | >99.8 |
| 4 | >99.8 | N.A. | >99.8 | >99.8 | 32.7 | >99.8 | >99.8 |

Except HeLa cells which showed some sensitivity to some of the boronic acids, all other cell lines showed almost no reaction to any of the compounds up to 100 μM.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A pesticide composition for killing insect pests comprising a synergistically effective combination of at least one of: organophosphate (OP), carbamate (CM), and synthetic pyrethroid (SP); and at least one boronic acid derivative or salt thereof.

2. The pesticide composition of claim 1, for use on insects.

3. The pesticide composition of claim 1, wherein the boronic acid derivative is aryl boronic acid or salt thereof wherein said aryl is optionally substituted by between 1-5 substituents, wherein each substituent is independently: H, F, Cl, Br, I, C₁-C₅ linear or branched alkyl, C₁-C₅ linear or branched haloalkyl, C₁-C₅ linear or branched alkoxy, aryloxy, O—CH₂Ph, O—CH₂-aryl, CH₂—O-aryl, —C(O)NH₂, —C(O)N(R)₂, —C(O)NHR, —NHC(O)R, C₁-C₅ linear or branched thioalkoxy, C₁-C₅ linear or branched haloalkoxy, C₁-C₅ linear or branched alkoxyalkyl, aryl, C₃-C₈ cycloalkyl, C₃-C₈ heterocyclic ring; each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and wherein
R is C₁-C₅ linear or branched alkyl, C₁-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring.

4. The pesticide composition of claim 1, wherein the boronic acid derivative is represented by the structure of formula I: 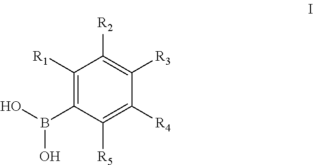
wherein
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;
or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

5. The pesticide composition of claim 1, wherein the boronic acid derivative is selected from:

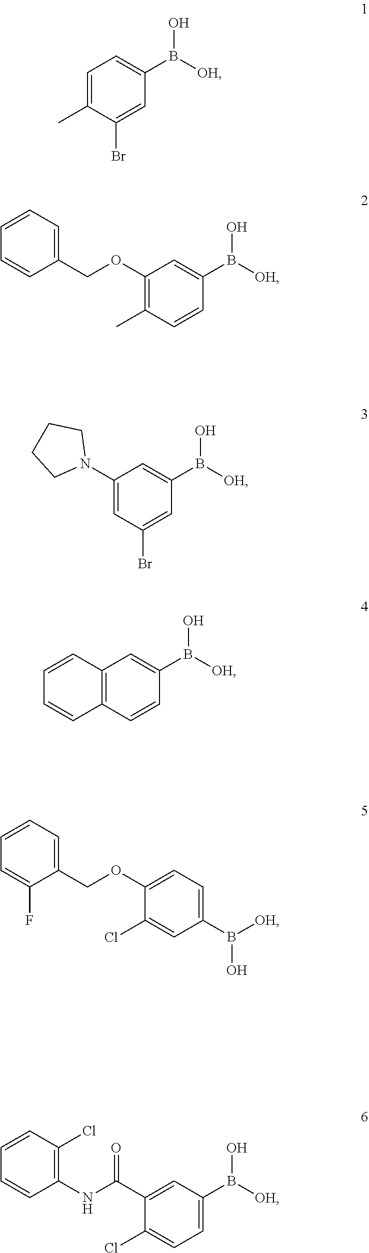 [SMILES: Cc1ccc(B(O)O)cc1Br ; Cc1ccc(B(O)O)cc1OCc1ccccc1 ; OB(O)c1cc(Br)cc(N2CCCC2)c1 ; OB(O)c1ccc2ccccc2c1 ; OB(O)c1ccc(OCc2ccccc2F)c(Cl)c1 ; O=C(Nc1ccccc1Cl)c1cc(B(O)O)ccc1Cl]

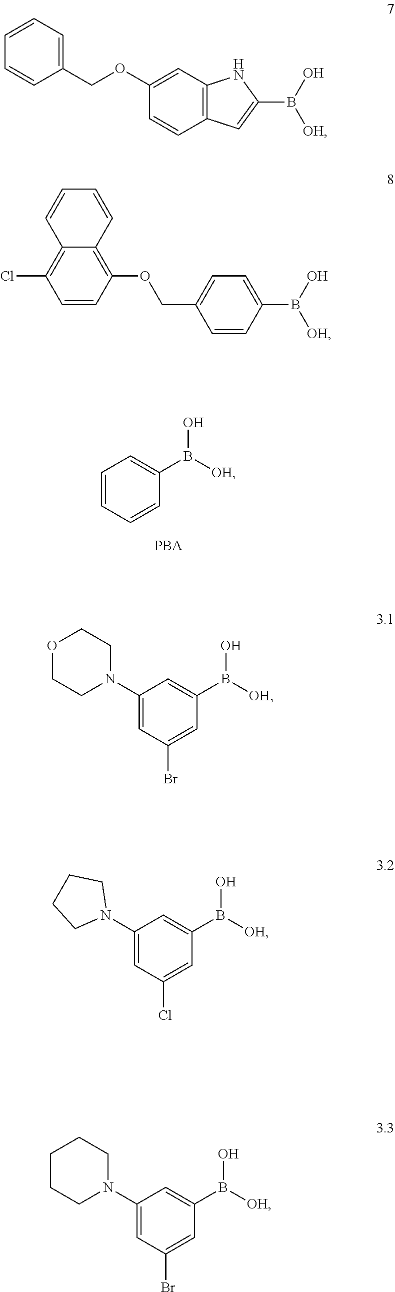 [SMILES: OB(O)c1cc2ccc(OCc3ccccc3)cc2[nH]1 ; OB(O)c1ccc(COc2ccc(Cl)c3ccccc23)cc1 ; OB(O)c1ccccc1 ; OB(O)c1cc(Br)cc(N2CCOCC2)c1 ; OB(O)c1cc(Cl)cc(N2CCCC2)c1 ; OB(O)c1cc(Br)cc(N2CCCCC2)c1]

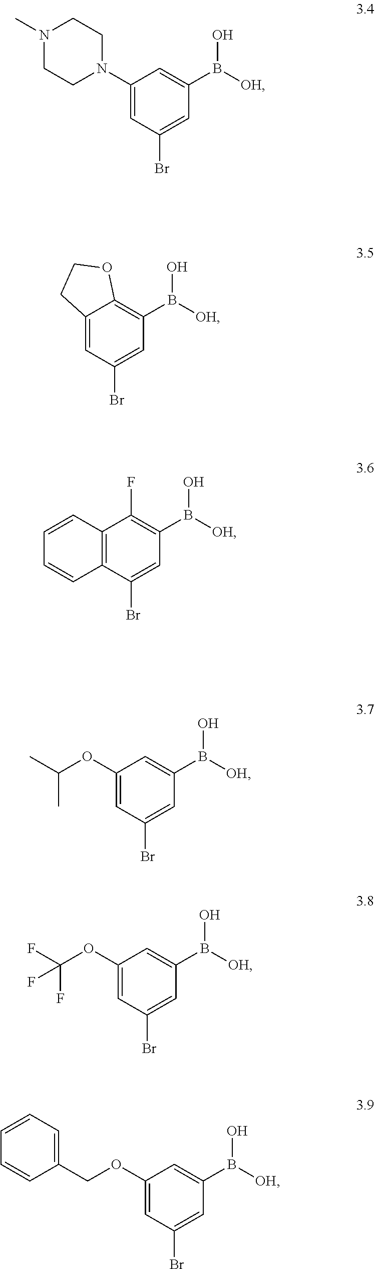 [SMILES: CN1CCN(c2cc(Br)cc(B(O)O)c2)CC1 ; OB(O)c1cc(Br)cc2c1OCC2 ; OB(O)c1cc(Br)c2ccccc2c1F ; CC(C)Oc1cc(Br)cc(B(O)O)c1 ; OB(O)c1cc(Br)cc(OC(F)(F)F)c1 ; OB(O)c1cc(Br)cc(OCc2ccccc2)c1]

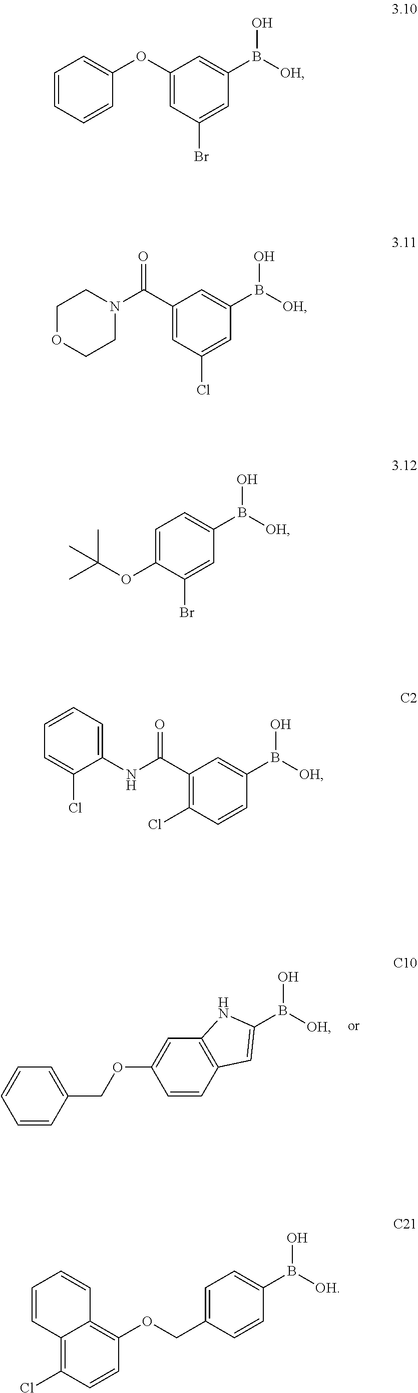

6. The composition of claim 1, wherein the said composition is useful for killing pests of agricultural crops including vegetable crops, floriculture, ornamental crops, medicinal, and economic plants.

7. The composition of claim 1, wherein the composition is useful for killing pests of agricultural animals including sheep, cattle, goats, domestic pests such as cats, dogs and birds, pigs, fish.

8. The composition of claim 1, wherein said composition kills pests including blowfly (e.g., Calliphora stygia, Lucilia cuprina), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof.

9. The composition of claim 1, wherein the OP is acephate, aspon, azinphos-methyl, azamethiphos, carbofuran carbophenothion, chlorfenvinphos, chlorpyrifos, Chlorpyrifos-ethyl (CPE), coumaphos crotoxyphos, crufomate, demeton, diazinon, dichlorvos, dicrotophos, dimethoate, dioxathion, disulfoton, diethyl-4-methylumbelliferyl phosphate, ethyl 4-nitrophenyl phenylphosphonothioate, ethio, ethoprop, famphur, fenamiphos, fenitrothion, fensulfothion, fenthion, fonofos, isofenfos, malathion, methamidophos, methidathion, methyl parathion, mevinphos, monocrotophos, naled, oxydemeton-methyl, parathion, phorate, phosalone, phosmet, phosphamidon, temephos, tetraethyl pyrophosphate, terbufos, tetrachlorvinphos, trichlorfon or any combination thereof.

10. The composition of claim 1, wherein the OP is diazinon, malathion or Chlorpyrifos-ethyl (CPE).

11. The composition of claim 1, wherein the composition is not toxic to animals and/or human.

12. The composition of claim 1, wherein the boronic acid derivative is a selective covalent inhibitor of carboxyethylesterase (CBE).

13. A method for killing insect pests, the method comprises contacting a population of insect pests with an effective amount of the composition of claim 1.

14. The method of claim 13, wherein contacting the population comprises exposing the population to the insecticide so that the composition is ingested by the insect pests sufficient to kill at least 50% of the population.

15. A method for killing insect pests on a plant or animal, the method comprises contacting the plant or animal with the composition of claim 1, wherein the composition has a synergistic effect on insecticidal activity.

16. A method of killing pests comprising inhibiting carboxylesterase (CBE)-mediated organophosphate (OP), carbamate (CM), and/or pyrethroid/synthetic pyrethroid (SP) resistance in a pest, said method comprises contacting a boronic acid derivative or salt thereof with said pest in combination with OP, CM and/or SP pesticide.

17. The method of claim 16, wherein said CBE is a wild-type-CBE, a homologue of CBE or mutated CBE.

18. The method of claim 16 wherein said CBE is wild-type or mutant versions of αE7 CBE or homologue thereof.

19. The method of claim 16, wherein said CBE is LcαE7, wild-type LcαE7, mutated LcαE7, a homologue thereof, or any combination thereof.

20. The method of claim 19 wherein the mutation in said mutated LcαE7 (or homologue thereof) is Gly137Asp (or equivalent mutation in homologue).

21. A method of potentiation an OP, a CM and/or an SP pesticide, comprising contacting a boronic acid derivative or a salt thereof with a pest, before, after or simultaneously with contacting said OP, CM and/or SP pesticide with said pest.

22. The method of claim 13, wherein the pest is blowfly (e.g., Calliphora stygia, Lucilia cuprina), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof.

23. The method of claim 16, wherein the boronic acid derivative is an aryl boronic acid or salt thereof, wherein said aryl is optionally substituted by between 1-5 substituents, wherein each substituent is independently: H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), O—CH₂Ph, O—CH₂-aryl, CH₂—O-aryl, —C(O)NH₂, —C(O)N(R)₂, —C(O)NHR, —NHC(O)R₁, C₁-C₅ linear or branched thioalkoxy, C₁-C₅ linear or branched haloalkoxy (e.g., OCF₃), C₁-C₅ linear or branched alkoxyalkyl, aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and wherein R is C₁-C₅ linear or branched alkyl, C₁-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring (e.g. morpholine).

24. The method of claim 16, wherein said boronic acid derivative is represented by the structure of formula I: 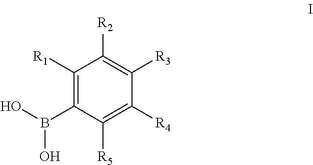
wherein
R₁, R₂, R₃, R₄ and R₅ are each independently H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), R₆R₇, —C(O)NH₂, —C(O)N(R)₂, C₁-C₅ linear or branched thioalkoxy, C₁-C₅ linear or branched haloalkoxy (e.g., OCF₃), aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, N(R)₂, alkyl-N(R)₂, hydroxyl, —OC(O)CF₃, —NHCO-alkyl, COOH, C(O)O-alkyl, C(O)H;
or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂;
R₆ is O, (CH₂)ₙ, C(O), C(O)O, OC(O), C(O)NH, C(O)N(R), NHC(O), N(R)CO, NHSO₂, N(R)SO₂, SO₂NH, SO₂N(R), S, SO, SO₂, NH, N(R), OCH₂, or CH₂O;
R and R₇ are each independently C₁-C₅ linear or branched alkyl (e.g. t-Bu, i-Pr), C₁-C₅ linear or branched haloalkyl (e.g. CF₃), C₁-C₅ linear or branched alkoxy, C₃-C₈ cycloalkyl, C₃-C₈ heterocyclic ring (e.g. morpholine), phenyl, aryl (e.g., 2-chlorophenyl, 2-fluorophenyl), naphthyl, benzyl, or heteroaryl, each may be further substituted by F, Cl, Br, I, C₁-C₅ linear or branched alkyl, hydroxyl, alkoxy, N(R)₂, CF₃, CN or NO₂; or two gem R substituents are joint together to form a 5 or 6 membered heterocyclic ring; and
n is and integer number between 1 and 6.

25. The method of claim 16, wherein the boronic acid derivative is selected from:

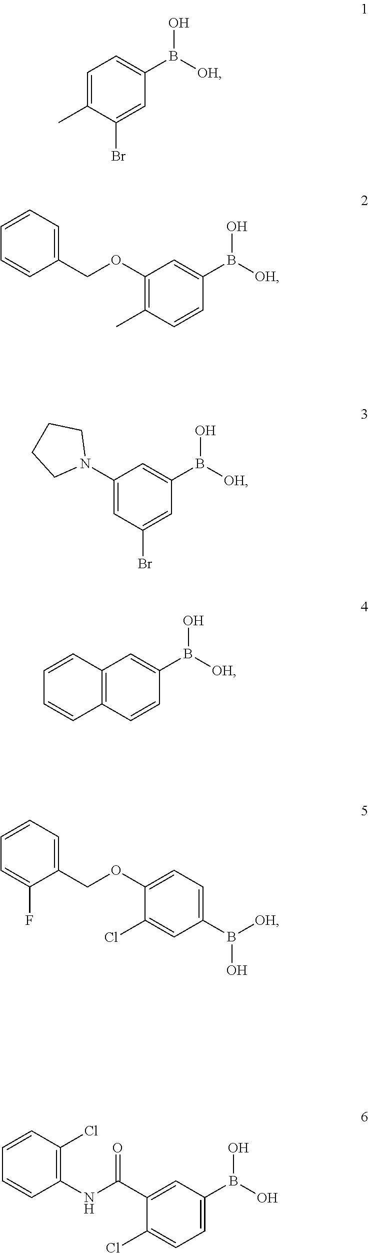 [SMILES: Cc1ccc(B(O)O)cc1Br ; Cc1ccc(B(O)O)cc1OCc1ccccc1 ; OB(O)c1cc(Br)cc(N2CCCC2)c1 ; OB(O)c1ccc2ccccc2c1 ; OB(O)c1ccc(OCc2ccccc2F)c(Cl)c1 ; O=C(Nc1ccccc1Cl)c1cc(B(O)O)ccc1Cl]

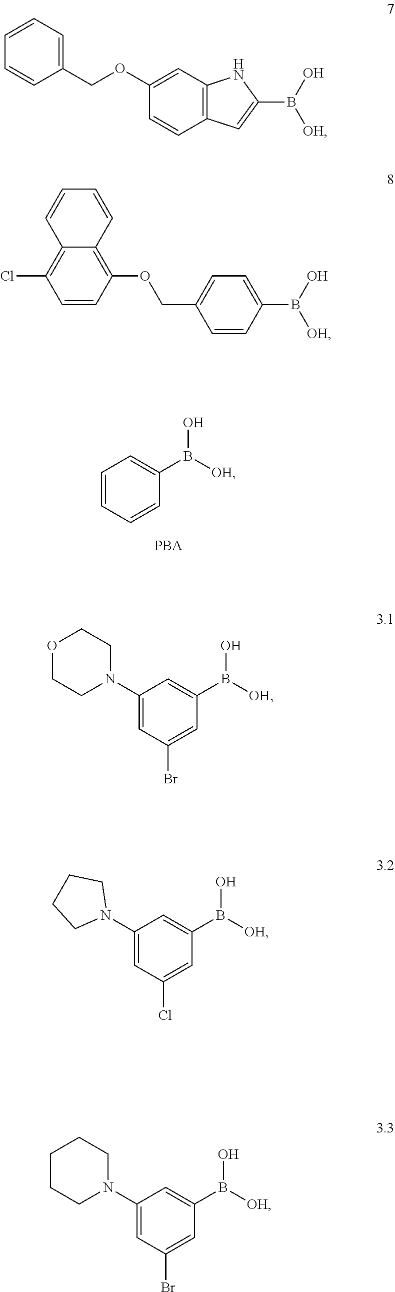 [SMILES: OB(O)c1cc2ccc(OCc3ccccc3)cc2[nH]1 ; OB(O)c1ccc(COc2ccc(Cl)c3ccccc23)cc1 ; OB(O)c1ccccc1 ; OB(O)c1cc(Br)cc(N2CCOCC2)c1 ; OB(O)c1cc(Cl)cc(N2CCCC2)c1 ; OB(O)c1cc(Br)cc(N2CCCCC2)c1]

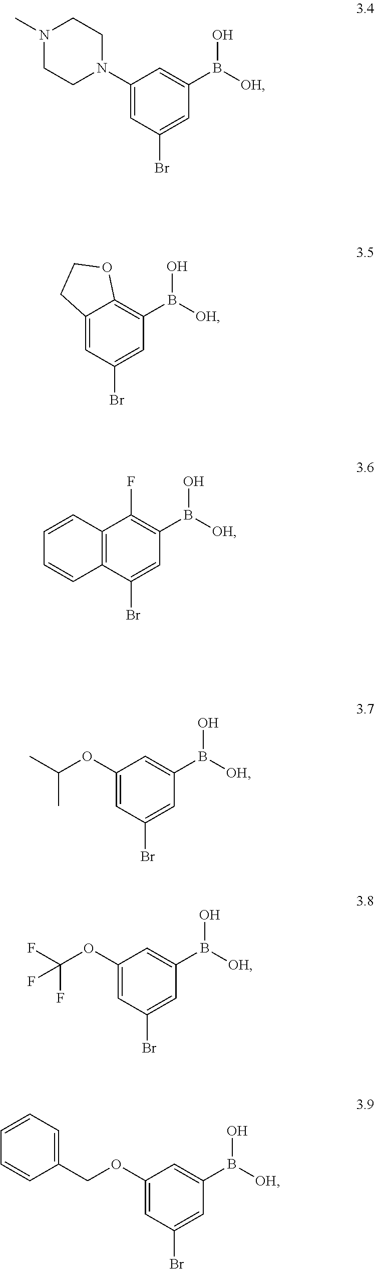 [SMILES: CN1CCN(c2cc(Br)cc(B(O)O)c2)CC1 ; OB(O)c1cc(Br)cc2c1OCC2 ; OB(O)c1cc(Br)c2ccccc2c1F ; CC(C)Oc1cc(Br)cc(B(O)O)c1 ; OB(O)c1cc(Br)cc(OC(F)(F)F)c1 ; OB(O)c1cc(Br)cc(OCc2ccccc2)c1]

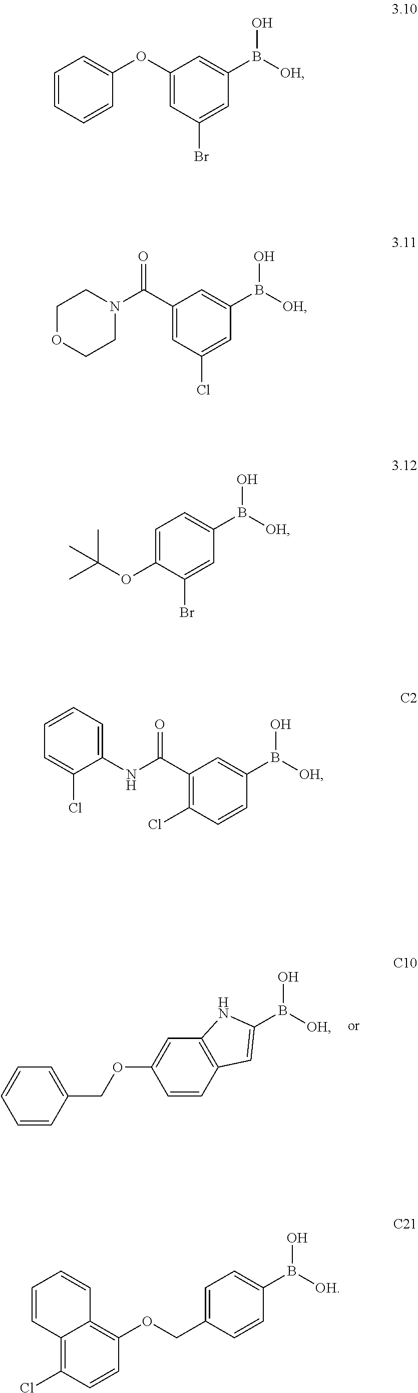

26. The method of claim 13, wherein the method is not toxic to animals and/or humans.

27. The method of claim 13, wherein said pest is OP, CM, and/or SP pesticide resistant.

28. The method of claim 13, wherein the OP is acephate, aspon, azinphos-methyl, azamethiphos, carbofuran carbophenothion, chlorfenvinphos, chlorpyrifos, Chlorpyrifos-ethyl (CPE), coumaphos crotoxyphos, crufomate, demeton, diazinon, dichlorvos, dicrotophos, dimethoate, dioxathion, disulfoton, diethyl-4-methylumbelliferyl phosphate, ethyl 4-nitrophenyl phenylphosphhonothioate, ethio, ethoprop, famphur, fenamiphos, fenitrothion, fensulfothion, fenthion, fonofos, isofenfos, malathion, methamidophos, methidathion, methyl parathion, mevinphos, monocrotophos, naled, oxydemeton-methyl, parathion, phorate, phosalone, phosmet, phosphamidon, temephos, tetraethyl pyrophosphate, terbufos, tetrachlorvinphos, trichlorfon or any combination thereof.

29. The method of claim 13, wherein the OP is diazinon, malathion or Chlorpyrifos-ethyl (CPE).

30. The method of claim 15, wherein the pest is blowfly (e.g., Calliphora stygia, Lucilia cuprina), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof.

31. The method of claim 16, wherein the pest is blowfly (e.g., Calliphora stygia, Lucilia cuprina), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof.

32. The method of claim 21, wherein the pest is blowfly (e.g., Calliphora stygia, Lucilia cuprina), screw-worm fly (e.g., Cochliomyia hominivorax), cockroaches, ticks, mosquitoes (e.g., Aedes aegypti, Anopheles gambiae, Culex quinquefasciatus), crickets, house flies (e.g., Musca domestica), sand flies, stable flies (e.g., Stomoxys calcitrans), ants, termites, fleas, aphids (e.g. green peach aphid), borers (e.g. Ostrinia nubilalis (European corn borer)), beetles (e.g. Leptinotarsa decemlineata (Colorado Beetle)), moths or any combination thereof.

33. The method of claim 13, wherein the boronic acid derivative is an aryl boronic acid or salt thereof, wherein said aryl is optionally substituted by between 1-5 substituents, wherein each substituent is independently: H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), O—CH₂Ph, O—CH₂-aryl, CH₂—O-aryl, —C(O)NH₂, —C(O)N(R)₂, —C(O)NHR, —NHC(O)R, C₁-C₅ linear or branched thioalkoxy, C₁-C₅ linear or branched haloalkoxy (e.g., OCF₃), C₁-C₅ linear or branched alkoxyalkyl, aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH₂, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and wherein
R is C₁-C₅ linear or branched alkyl, C₃-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring (e.g. morpholine).

34. The method of claim 15, wherein the boronic acid derivative is an aryl boronic acid or salt thereof, wherein said aryl is optionally substituted by between 1-5 substituents, wherein each substituent is independently: H, F, Cl, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), O—CH₂Ph, O—CH₂-aryl, CH₂—O-aryl, —C(O)NH₂, —C(O)N(R)₂, —C(O)NHR, —NHC(O)R, C₁-C₅ linear or branched thioalkoxy, C₁-C₅ linear or branched haloalkoxy (e.g., OCF₃), C₁-C₅ linear or branched alkoxyalkyl, aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN, NO₂, —CH₂CN, NH, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₃, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and wherein
R is C₁-C₅ linear or branched alkyl, C₁-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring (e.g. morpholine).

35. The method of claim 21, wherein the boronic acid derivative is an aryl boronic acid or salt thereof, wherein said aryl is optionally substituted by between 1-5 substituents, wherein each substituent is independently: H, F, C, Br, I, C₁-C₅ linear or branched alkyl (e.g., methyl), C₁-C₅ linear or branched haloalkyl, C₁-C₅ linear or branched alkoxy (e.g., —OiPr, —OtBu, —OCH₂-Ph), aryloxy (e.g., OPh), O—CH₂Ph, O—CH₂-aryl, CH₂—O-aryl, —C(O)NH₂, —C(O)N(R)₂, —C(O)NHR, —NHC(O)R, C₁-C₅ linear or branched thioalkoxy, C₁-C₅ linear or branched haloalkoxy (e.g., OCF₃), C₁-C₅ linear or branched alkoxyalkyl, aryl, C₃-C₈ cycloalkyl, C₃-C₈ heterocyclic ring (e.g., pyrrolidine, morpholine, piperidine, piperazine, 4-Me-piperazine); each may be further substituted by F, Cl, Br, I, C₁-C₅ linear or branched alkyl, hydroxyl, alkoxy, N(R)₂, CF₃, CN or NO₂; CF₃, CN NO₂, —CH₂CN, NH₂, NHR, N(R)₂, alkyl-N(R)₂, hydroxyl, —OC(O)CF₃, —O—CH₂-aryl (e.g., —OCH₂Ph, OCH₂-2-fluorophenyl), —NHCO-alkyl, COOH, —C(O)Ph, C(O)O-alkyl, C(O)H, or —C(O)NH₂, —C(O)N(R)₂, —C(O)-morpholine, or two adjacent substituents (i.e., R₂ and R₁, or R₃ and R₁, or R₄ and R₃, or R₅ and R₄) are joint together to form a 5 or 6 membered carbocyclic (e.g., benzene, furane) or heterocyclic ring, which may be further substituted by F, Cl, Br, I, C₁-C₅ linear or branched alkyl, hydroxyl, alkoxy, N(R)₂, CF₃, CN or NO₂; and
wherein
R is C₁-C₅ linear or branched alkyl, C₁-C₅ linear or branched alkoxy, phenyl, aryl or heteroaryl, which may be further substituted by F, Cl, Br, I, C₁-C₅ linear or branched alkyl, hydroxyl, alkoxy, N(R)₂, CF₃, CN or NO₂, or two gem R substituents are joint together to form a 5 or 6 membered heterocyclic ring (e.g. morpholine).
